(19) United States
(12) Patent Application Publication
(10) Pub. No.: US 2024/0415078 A1
(43) Pub. Date: Dec. 19, 2024

(54) A PAYLOAD AND A UAV CARRYING SAID PAYLOAD, A HARVESTING TOOL AND A METHOD

(71) Applicant: AIRFORESTRY AB, Uppsala (SE)

(72) Inventors: Olle GELIN, Alunda (SE); Mauritz ANDERSSON, Uppsala (SE)

(21) Appl. No.: 18/705,041

(22) PCT Filed: Nov. 9, 2022
(86) PCT No.: PCT/SE2022/051042

§ 371 Date: Apr. 26, 2024

(30) Foreign Application Priority Data
Nov. 10, 2021 (SE) 2151379-1

(51) Int. Cl. A01G 23/083; B64D 1/22; B64U 10/13; B64U 101/40

(52) U.S. Cl. CPC A01G 23/083; B64D 1/22; B64U 10/13; B64U 2101/40

(57) ABSTRACT

A device (4200) for an Unmanned Aerial Vehicle, UAV (100), said device (4200) comprising a first pivot point (4212) and a second pivot point (4214) being spaced apart from each other, said first pivot point (4212) is connectable a UAV (100) and said second pivot point (4214) is connectable the UAV (100), said device (4200) is configured to be tilted/rotated around said first pivot point (4212) by adjusting a length of a second cord (4204) and/or tilted/rotated around said second pivot point (4214) by adjusting a length of a first cord (4202), wherein said device (4200) has a first winch motor (4292) and a second winch motor (4294), said first and second winch motors (4292, 4294) are configured for adjusting the length of said first and second cords (4202, 4204) respectively. Also provided is a harvesting tool (105, 110) comprising a base structure (650), said base structure having attached to it at least one cutting means for delimbing a tree (114a, 114b), at least one means for communicating with a UAV and/or a remote base station, at least one cutting means for cutting a tree trunk (116), at least one attaching means to be attachable to the UAV (660), at least one holding means for holding a tree trunk (105,107a, 107b, 114a, 114b). Also provided is a method for controlling the relative rotation between a UAV and a device, where the device is attached to said UAV via at least two cords, said method comprising the steps of: a. determining a reference rotational position of said device relative to said UAV, b. detecting an angular rotation R in a horizontal plane of said device relative to said reference position, c. compensating said angular rotation in said horizontal plane of said device by rotating said UAV in said horizontal plane in the same direction and by the same angular rotation R as said device for prohibiting twisting of said cords.

### TECHNICAL FIELD OF THE INVENTION

The present invention relates in general to a payload attachable to an Unmanned Aerial Vehicle, UAV, in particular it relates to a payload which can be tilted around at least two pivot points.

### BACKGROUND OF THE INVENTION

Traditional tree harvesting or tree falling has long been conducted by persons and equipment based on the ground. In earlier times, from the early twentieth century and going back to the early nineteenth century, little consideration was given to the state of the forest or to the eco-system within the forest. Logging was done on a massive scale to keep up with the demand caused by the industrial revolution and the subsequent expansion of human life at the time. Depending on the terrain, tree harvesting process usually begins with experienced tree fellers cutting down a stand of trees or by using heavy ground based manned harvesting machines. The above-described methods represent a high level of risk, either to the environment or the people performing the work. Damage can also be done to the delicate ecology of the forest, known as the understory or underbrush, where smaller plants bind the soil together and provide a habitat to insects, birds, lichens, and fungus among other things.

Most importantly, many locations are extremely difficult to reach by land, even with the use of heavy equipment such as bulldozers, and removal of trees from such locations is expensive. Sometimes it may be desirable to harvest a single tree amongst a stand of trees, so called tree thinning, without disturbing the surrounding trees.

In U.S. Pat. No. 6,263,932 it is disclosed an aerial tree harvesting apparatus. A first body of said apparatus is suspended from helicopter and a second body is suspended by cables from the first body. The apparatus is capable of delimbing and cutting the tree and thereafter transporting the harvested tree to another location.

The problem with the tree harvesting apparatus in U.S. Pat. No. 6,263,932 is that it is very expensive, slow, noisy and complicated to use. Another problem with U.S. Pat. No. 6,263,932 is that it is rather labor intense and inefficient.

### OBJECT OF THE INVENTION

The present invention aims at obviating the aforementioned problem. A primary object of the present invention is to provide an improved maneuverability of a payload attachable to a UAV via at least two cords.

Another object of the present invention is to provide an improved Unmanned Aerial System comprising a payload connected to an Unmanned Aerial Vehicle via at least two cords.

### SUMMARY OF THE INVENTION

According to the invention at least the primary object is attained by means of the payload having the features defined in the independent claims.

Preferred embodiments of the present invention are further defined in the dependent claims.

According to a first aspect of the present invention it is provided a device for an Unmanned Aerial Vehicle, UAV, said device comprising a first pivot point and a second pivot point being spaced apart from each other, said first pivot point is connectable a UAV and said second pivot point is connectable the UAV, said device is configured to be tilted/rotated around said first pivot point by adjusting a length of a second cord and/or tilted/rotated around said second pivot point by adjusting a length of a first cord, wherein said device has a first winch motor and a second winch motor, said first and second winch motors are configured for adjusting the length of said first and second cords respectively.

In one embodiment the first winch motor is provided at the first pivot point and the second winch motor is provided at the second pivot point, and wherein said first pivot point is connectable a UAV via at least one first cord and said second pivot point is connectable the UAV via at least one second cord.

In one embodiment the first winch motor and the second winch motor are provided at the device, and wherein the first pivot point is provided at a distance from the first winch motor and the second pivot point is provided at a distance from the second winch motor, wherein the first cord connects the first winch motor to the UAV via the first pivot point, and wherein the second cord connects the second winch motor to the UAV via the second pivot point.

The advantage of these embodiments are that a device attached to a UAV via two cords may be tilted, lowered and/or raised into a desired position relative to the UAV and/or to an external object. The cords may be attached to said UAV to the same position or space apart from each other, i.e., there are various alternative embodiments here where the cords may be attached to the UAV spaced apart from each other and the winch motors on the device may be spaced apart from each other. Alternatively the attachment point of said cords to said UAV is to the same position but said winch motors are spaced apart on said device. Alternatively the winch motors are close to each other on said device and said attachments point to said UAV are to the same position. The attachment point of said cords to said UAV is to the same position but said winch motors on said device is spaced apart from each other. At least one winch motor may be arranged on said UAV instead of said device in various example embodiments.

In various example embodiments of the present invention said device further comprising a third pivot point spaced apart from said first and second pivot points, where said third pivot point is spaced apart from a straight line between said first and second pivot points, said third pivot point is connectable to said UAV via at least one third cord, said device is configured to be tilted/rotated around at least said third pivot point by adjusting a length of said first cord and/or said second cord, said device is configured to be tilted/rotated around at least said first pivot point by adjusting a length of said second cord and/or said third cord, said device is configured to be tilted/rotated around at least said second pivot point by adjusting a length of said first cord and/or said third cord, wherein said device has a third winch motor provided at said third pivot point, said third winch motor is configured for adjusting the length of said third cord.

The advantage of these embodiments is that the freedom of positioning the device relative to the UAV and/or an external object is further improved.

In various example embodiments of the present invention said device further comprising a tilt structure, said tilt structure has at least one anchor point connectable to said UAV, said tilt structure and said device are connectable to each other via said at least a first and second cords, wherein at least one winch motor is provided on said tilt structure instead of on said device, the tilt structure is configured to communicate with said UAV and/or said device.

The advantage of these embodiments is that the tilt structure functions as an adapter between the UAV and said device. Another advantage is that any tilting functionality is arranged in the tilting plate meaning that devices lacking such feature may nevertheless be used.

In various example embodiments of the present invention said tilt structure comprising at least one power source for powering at least one winch motor provided on said tilt structure.

The advantage of these embodiments is that said tilt structure is independent from power from said device and/or said UAV.

In various example embodiments of the present invention said device is a harvesting tool configured for holding and/or cutting at least a portion of a tree or a payload carrying device for carrying timber or goods.

The advantage of these embodiments is that the tool or the payload carrying device may be tilted/positioned in a desired way depending on intended action, tree parameters and/or growing condition.

In various example embodiments of the present invention said harvesting tool comprising a base structure, said base structure having attached to it at least one cutting means for delimbing a tree, at least one means for communicating with said UAV and/or a remote base station, at least one cutting means for cutting a tree trunk, at least one attaching means to be attachable to at least one UAV, at least one holding means for holding a tree trunk.

The advantage of these embodiments is that the harvesting tool may be autonomously and/or remotely operated in relation to its positioning and/or its harvesting features.

In various example embodiments said harvesting tool further comprising a plurality of wheels, which wheels are mounted on said base structure spaced apart from each other, said wheels are configured to be positionable into contact with a tree trunk for moving the base structure in motion along the tree trunk, and tension means configured to cause traction of said plurality of wheels against the tree trunk.

The advantage of these embodiments is that said harvesting tool may be configured to be movable autonomously and/or remotely up and/or down on a tree trunk.

In various example embodiments of the present invention said cutting means for cutting a tree trunk is foldable/rotatable with respect to said base structure in at least a resting position, a delimbing position and a tree trunk cutting position.

The advantage of these embodiments is that one and the same cutting means may be used for different purposes and/or be hidden for other features of said harvesting tool.

In various example embodiments of the present invention said cutting means for cutting a tree trunk is arranged below said holding means on said base structure with respect to a direction of use of said tree harvesting tool.

The advantage of these embodiments is that it gives the possibility to reduce or eliminate the pressure on the cutting means by providing a lifting force on said portion of the tree to be removed by said UAV.

In various example embodiments of the present invention said harvesting tool and/or said UAV further comprising at least one means for detecting at least a portion of a tree to be harvested.

The advantage of these embodiments of the present invention is that gripping, positioning of the harvesting tool may be simplified. Another advantage is that identification of relevant trees is simplified.

In various example embodiments of the present invention said at least one cutting means for delimbing a tree is at least one knife configured to delimb the tree by the weight and gravitation speed of the tree harvesting tool when dropped from said UAV.

The advantage of these embodiments is that said harvesting tool and said UAV are connected to each other via cords which in turn may be extended or retracted by winch motors. The tool may in this way be dropped from the UAV from a predetermined position. The gravity and the weight of the harvesting tool may remove limbs when said tool is falling downwards on said tree. Limbs of the tree will automatically be removed from the tree trunk by knives arranged on said harvesting tool. The knives may be resiliently attached to said harvesting tool in such a way that the delimbing may take place at a predetermined distance from the tree trunk irrespective of the diameter of the tree trunk.

In another aspect of the present invention it is provided an Unmanned Aerial System (UAS) comprising an Unmanned Aerial Vehicle UAV and a device according to the invention connected to said UAV.

The advantage of this embodiment is that the UAV and/or the tool may be adapted to each other and for its intended purpose.

In various example embodiments the first, second or third winch motors are remotely and/or autonomously operated via said UAV and/or said tilting structure.

The advantage of these embodiments is that tilting and/or levelling the device with respect to the UAV and/or the ground level may be completely automatic.

In various example embodiments at least one winch motor is provided on said UAV instead of on said device or on said tilting structure.

The advantage of these embodiments is that the arrangement of winch motors is flexible. Depending on the payload to carry it may in some cases be advantageous to provide the winch motors on the payload and in other cases on the tilting structure and/or the UAV.

In various example embodiments said cord is at least one metal wire, kevlar fibre rope, carbon fibre rope or any combination thereof.

Various types of cords may be used differing only in endurance, strength, price and/or flexibility.

In various example embodiments aid UAV is configured for communicating with said at least two winch motors via Bluetooth, WiFi, radio communication, optical fibre and/or electrical wire and/or via a cellular mobile network.

The advantage of these embodiments is that one or a plurality of communication methods may be used depending on availability and/or distance between the UAV and said winch motors. One communication media may be used as a back-up for another communication media.

In another aspect of the present invention it is provided a tilt structure for connecting a UAV with a payload, said tilt structure comprising at least one connection means connectable to said UAV, said tilt structure and said payload are connectable to each other via at least one first and second cords, at least a first and second winch motor are provided on said tilt structure, said at least a first and second winch motor are configured for adjusting the length of said at least a first and second cord respectively, wherein the tilt structure is configured to communicate with said UAV and/or said device.

The advantage of this embodiment is that the tilt structure may function as an adapter between the UAV and the payload. Another advantage of the present invention is that all tilting functionality may be moved from the payload and the UAV to the tilt structure.

In various example embodiments of the present invention the communication between said tilt structure and said UAV 100 and/or payload is autonomously and/or remotely controlled.

The advantage of these embodiments is that the levelling of the tilt structure relative to the payload and/or tilting of the tilt structure relative to the payload can be fully automatic.

In another aspect of the present invention it is provided a use of a tilt structure for connecting a UAV with a payload and for remotely and/or autonomously controlling a tilt position of said payload and/or a levelling position of said payload relative to the ground and/or said tilt structure.

The advantage of this embodiment is that such use may be applicable for connecting various types of UAV with various types of payloads with one and the same tilt structure.

In another aspect of the present invention it is provided a method for controlling the relative rotation between a UAV and a device, where the device is attached to said UAV via at least two cords, said method comprising the steps of:
a. determining a reference rotational position of said device relative to said UAV,
b. detecting an angular rotation R in a horizontal plane of said device relative to said reference position,
c. compensating said angular rotation in said horizontal plane of said device by rotating said UAV in said horizontal plane in the same direction and by the same angular rotation R as said device for prohibiting twisting of said cords.

The advantage of this embodiment is that twist of a plurality of cords between a UAV and a device can be prohibited to twist into each other and thereby disable the individual management of the levelling and/or tilting of the device by adjusting individually the length of said cords.

In various example embodiments of the present invention said compensation of said angular rotation R of said device by said UAV is performed autonomously.

The advantage of these embodiments is that the prohibiting of cord twisting can be controlled and managed without human operation.

In another aspect of the present invention it is provided an Unmanned Aerial System (UAS) comprising an Unmanned Aerial Vehicle UAV and a device where said device is attached to said UAV via at least two cords, said UAS further comprising at least one sensor for detecting angular rotation in a horizontal plane of said device relative to said UAV.

The advantage of this embodiment is that a device hanging from a UAV in at least two cords where their relative rotation to each other can be controlled.

In various example embodiments of the present invention said device may be a harvesting tool configured for holding and/or cutting at least a portion of a tree or a payload carrying device for carrying timber or goods.

The advantage of these embodiments is that the position of the harvesting tool relative to the UAV may be controlled.

In various example embodiments of the present invention, said sensor for detecting angular rotation of said device relative to said UAV is provided on said device and/or said UAV. Said sensor for detecting angular rotation may be at least one of the group of accelerometer, gyro and/or optical sensor.

The advantage of these embodiments is the flexibility of positioning and/or the type of said sensor(s).

In another aspect of the present invention it is provided a kit comprising a base structure, at least one cutting means for delimbing a tree configured to be attached to said base structure, electronics configured for communicating with a UAV and/or a remote base station, at least one cutting means for cutting a tree trunk configured to be attached to said base structure, at least one attaching means to be attachable to at least one UAV, at least one holding means for holding a tree trunk configured to be attached to said base structure.

The advantage of this embodiment is that a harvesting tool may be sold in pieces which may reduce its price and/or flexibility for a customer by combining various components of said harvesting tool.

In yet another aspect of the present invention it is provided at least one non-transitory machine readable medium including instructions, for a UAV with a device attached to said UAV via at least two cords, to avoid said cords to twist using real-time relative rotational information of said UAV and said device in a horizontal plane, the instructions, when executed by a machine, cause the machine to perform operations comprising:
d. determining a reference rotational position of said device relative to said UAV,
e. detecting an angular rotation R in a horizontal plane of said device relative to said reference rotational position,
f. compensating said angular rotation R in said horizontal plane of said device by rotating said UAV in said horizontal plane in the same direction and with essentially the same angular rotation R as said device for prohibiting twisting of said cords.

In still another aspect of the present invention it is provided an arrangement for a UAV with a device attached to said UAV via at least two cords to avoid said cords to twist using real-time relative rotational information of said UAV and said device in a horizontal plane, the arrangement comprising:
g. at least one processing circuitry; and
h. at least one non-transitory machine readable media including instructions that, when executed by the at least one processing circuitry, cause the at least one processing circuitry to:
   i. determine a reference rotational position of said device relative to said UAV,
   ii. detect an angular rotation R in a horizontal plane of said device relative to said reference rotational position,
   iii. compensate said angular rotation R in said horizontal plane of said device by rotating said UAV in said horizontal plane in the same direction and with essentially the same angular rotation R as said device for prohibiting twisting of said cords.

Sensors may be arranged on said device and/or said UAV for detecting height of the device and/or the UAV over ground and/or relative distance between said UAV and said device.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1-5, 7-12 depict schematic pictures of different inventive remote and/or autonomous harvesting steps by using a system according to the present invention.

FIG. 6a-f depict various example embodiments of a unit according to the present invention comprising a remotely and/or autonomously controlled means configured for harvesting at least a portion of a tree and at least one means for gripping said tree trunk.

FIG. 6g-h depict various example embodiments of delimbing a tree trunk according to the present invention.

FIG. 13-41 depict schematic pictures of various means for holding directly and/or indirectly at least a portion of a tree trunk and/or cutting at least a portion of a tree trunk according to the present invention.

FIG. 42a depicts a first example embodiment of a Unmanned Aerial System according to the present invention.

FIG. 42b depicts a second example embodiment of a Unmanned Aerial System according to the present invention.

FIG. 42c depicts a side view of an example embodiment of a harvesting tool according to the present invention.

FIG. 42d depicts a perspective view of the harvesting tool in FIG. 42c.

FIGS. 42e and f depicts a third and fourth example embodiment of a Unmanned Aerial System according to the present invention.

FIG. 43 depict a block diagram illustrating an example of a machine upon which one or more embodiments may be implemented.

### DETAILED DESCRIPTION OF PREFERRED EMBODIMENTS OF THE INVENTION

The word tree used hereinabove and hereinbelow is a generic term for any tree(s) and/or any bush(es).

The word harvesting used hereinabove and hereinbelow is a generic term for removing at least a portion from a tree, i.e., cutting a portion of the tree, cutting the full tree and/or removing the tree with at least a portion of its roots from the ground.

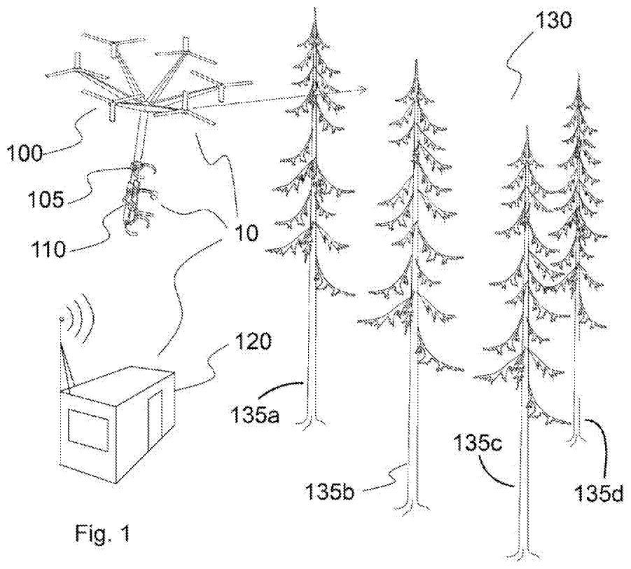

FIG. 1-5, 7-12 depict schematic pictures of different inventive remote and/or autonomous harvesting and/or transporting steps of at least a portion of a tree by using an example embodiment of a system 10 according to the present invention. Said system may comprise a remotely and/or autonomously controlled means configured for harvesting and/or transporting at least a portion of a tree 110, a remotely and/or autonomously controlled Unmanned Aerial Vehicle 100, UAV, comprising, at least one means for holding 105 said tree trunk and being configured for transporting said harvested portion of said tree to another location, wherein said system comprising at least one means for detecting said tree to be harvested and/or transported, and a base station 120 for controlling said means configured for harvesting and/or transporting at least a portion of a tree and said UAV. Said system further comprising means for detecting at least one tree parameter of at least a portion of a tree and/or at least one growing condition of at least a portion of a tree. Said system further comprising means configured for selecting least a portion of a tree to be harvested and/or transported depending on at least one detected tree parameter and/or at least one detected growing condition of said transported/harvested portion of a tree and/or a remaining portion of a tree and/or of at least one tree grown within a predetermined distance from said transported portion of a tree.

In FIG. 1 said UAV 100 is carrying said remotely and/or autonomously controlled means configured for harvesting at least a portion of a tree 110 on its way to harvest a at least a portion of a tree 135a, 135, b, 135c, 135d in a forest 130. The UAV is remotely controlled by said base station 120 and/or autonomously controlled and optionally communicating with base station 120. The base station 120 may be a stationary unit or a mobile unit.

In FIG. 1-4, 7, 9, 10 the UAV 100 can be considered as a forestry forwarder and said means configured for harvesting at least a portion of a tree 110 can be considered to be a forestry harvester.

In an autonomously controlled means configured for harvesting at least a portion of a tree said means is able to operate without being controlled directly by humans whereas in a remotely controlled means configured for harvesting at least a portion of a tree said means is able to be operated from a remote distance controlled directly by humans. In various example embodiment said means configured for harvesting at least a portion of a tree and said UAV are remotely controlled. In various example embodiment said means configured for harvesting at least a portion of a tree and said UAV are autonomously controlled. In various example embodiments said means configured for harvesting at least a portion of a tree is remotely controlled and said UAV is autonomously controlled. In various example embodiments said means configured for harvesting at least a portion of a tree is autonomously controlled and said UAV is remotely controlled.

Said means for detecting a tree may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR. The optical sensor may at least one of a photodetector, pyrometer, proximity detector and/or an infrared sensor.

Said means for detecting a tree may be arranged on said UAV and/or said means configured for harvesting at least a portion of a tree.

Said means for detecting at least one of the group of tree parameters may be the same means as being used for detecting a tree and/or an additional means. The additional means may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR, a spectral camera, a heat sensitive camera, an ultrasonic measurement device, a radar device, a vibration device. The optical sensor may be at least one of a photodetector, pyrometer, proximity detector and/or an infrared sensor. A 3D picture may see through foliage and/or branches. A mean value of multiple 3D images may result in mm precision images. 3D pictures may reveal lots of information about branches, tree trunk and/or tree species. 3D images may be taken from an airborne vehicle such as an UAV. The spectral camera may be used for measuring vegetation index (NDVI), i.e., a measure of the photosynthesis in a particular area. Heat sensitive cameras may be used for measuring the temperature of the surface of the tree trunk which in turn may be a measure of the health of the tree, an insect infestation tree has a higher surface temperature than a non-infested tree. Ultrasonic measurement and/or radar may be used for determining the inner form of the tree, i.e., rotten or hollow inner structure and/or the inner moisture content of the tree. Computer tomography and/or magnetic resonance imaging can give information about a portion of a tree down to a tree cell level.

Said means for detecting at least one of the group of tree parameters may be a camera or optical sensor in combination with Artificial Intelligence, AI. AI may be used for training a model for recognizing one or a plurality of said tree parameters. tree parameters may be recognized visually and/or by measurement and/or by at least on physical sample. Measurement may be made by optical inspection at a distance from the tree and/or by physical measurement, for instance integrated in said means for gripping/holding 105 said tree trunk. Said means for detecting at least one tree parameter may be a laser scanner attached to said UAV and/or said means for holding said tree trunk and/or said means for harvesting said at least a portion of a tree. By laser scanning the tree trunk the tree species may be determined and other surface conditions of the tree trunk such as the presence of any moss and/or any damage. Detected tree parameters may be compared with stored tree parameters in a database for categorization and/or future choice and/or prioritization.

The final destination of said at least a portion of the tree may be determined by at least one of said detected tree parameters and/or at least one detected growing condition. Tree parameters can be considered to be intrinsic features and growing conditions can be considered to be extrinsic features.

tree parameters may for instance be a diameter of said at least a portion of a tree (top diameter, base diameter, mean diameter, median diameter), length of said at least a portion of a tree, tree species of said at least a portion of a tree and/or the weight of said at least a portion of a tree, dry content, age of tree, number of annual rings, distance between annual rings, color of annual rings, width of annual rings, amount of leaves, amount of fir needle, color, chemical composition of the tree, twig-free, deformation(s), cracks (dry cracks (partial or all trough), end crack, ring crack), rootstock, density, rot, discolored, dead tree, insect infested, microorganism infested, weather damage (storm, wind, fire, drought), machine damage (root, tree trunk), amount of fruits, seeds, berries, nuts, cones, flowers on the tree, form of root, root structure, root depth, root volume etc.

The color of the tree may be an indicator of tree species. The color may be the color of the outer surface of the tree trunk or the color of a cut area. The form of the tree may be determined by a 3D camera. Form may comprise total volume of tree, leaves or fir needles, deformations, shape deviations etc. tree parameters may also comprise material properties of the tree such as moisture content (%), tensile strength (MPa), flexural strength (MPa), compressive strength (MPa), shear strength (MPa), impact strength (KJ/m²), hardness (Brinell, Vickers, Rockwell), elasticity module (MPa), thermal conductivity (W/m° C.), heat capacity (J/kg° C.), Calorific value (MJ/kg), etc.

In various example embodiments said tree parameters may be detected manually by human or remote and/or autonomous by a separate unit prior to harvesting. tree parameters may be stored digitally together with GPS position. In various example embodiments a digital marker may be arranged physically on tree prior to cutting the tree or when the tree is laying on ground. The digital marker may have stored information about at least one tree parameter. The input of tree parameters may be made manually prior to harvesting. The digital marker may be configured to communicate with said UAV. The communication may be performed by Bluetooth, wifi, radio communication and/or telecommunication (3G, 4G, 5G). A physical sample for detecting tree parameters such as density, rot and/or dry content may be made manually prior to harvesting and/or automatically by a sample detection means added to the means for holding the tree trunk and/or the means configured for harvesting at least a portion of a tree. Such sample detection means may be a suitable tool for removing a predetermined amount of the tree to be analysed. The removal of said predetermined amount to be analysed may be made by drilling, sawing or cutting. The analysis of said predetermined amount of the tree may be made while the UAV is at or near the tree or said predetermined amount of tree may be brought to an analyzation station at a distance from the tree. A selection of where to remove said predetermined amount of the tree may be made by using said camera. Suspected rotten or insect infested areas may be detected by the camera and thereafter a sample of such areas may be removed and analyzed. Different portions of a single tree and different trees may be categorized differently depending on the outcome of the analysis, i.e., depending on the tree parameters a specific portion of a tree may fall into one or a plurality of different categories. If a specific portion of a tree may fall in a plurality of different categories a selection may be based on the value or the current demand in the market.

Growing conditions may for instance be #tree per unit area and/or growth potential.

Growing conditions may also be biotic environmental factors (interaction of organisms of the same species and/or interaction of organisms of other species) such as mount of dead tree/wood within a predetermined area, interaction and/or competition of other species, gas and fragrance from plants, temperature of other plants etc. Fungal infestation and insect infestation may be spread over a large area. It may be advantageous to harvest non infested trees within a predetermined time after having detected an infested tree in a predetermined area. Fungal and insects may spread over several km. Competition for water, nutrition, and sun hours may be within a distance of 0-50 m. Advantageous interaction/competition situations may be made through sorting out plants in predetermined positions in order to get optimal conditions for the remaining ones.

Growing conditions may also be abiotic environmental factors climate (temperature, precipitation etc), topography, ground temperature, geology, hydrology, vegetation, soil, earth deposit, soil depth, surface blockage, minerals, ground carbon contents, ground nitrogen content, ground carbon nitrogen ratio, PH value, bas kat ions, amount of trace elements, physical or chemical erosion, environmental condition, wind etc. Abiotic environmental factors may also be the type of land such as forest land, arable land, agricultural land, natural pasture, mountain impediment, protected area, power line area, military area, built up land etc.

At least one tree parameter and/or growing condition may be used as a factor for determining the usage, demand, storage, quality of the at least a portion of the tree. This in turn may be used for determining the final destination of a particular portion of a tree.

Gas sensors may be used to detect water quality (carbon oxide content, methane content, oxygen content etc.).

The UAV may have one or a plurality of propellers. In FIG. I-4, said UAV has 6 propellers arranged symmetrically around an origin.

The base station 120 may, when remotely controlled, be operated by at least one human being, whereas, when autonomously controlled, be a base station 120 with programmed software algorithms used for supporting the autonomous UAV and/or the means configured for harvesting at least a portion of a tree. The base station 120 may be a stationary unit or a mobile unit.

Said means for holding the said tree 105 may be at least one movable gripping arm. In various example embodiments said means for holding said tree 105 may be one or a plurality of metal bars which may at least partially penetrate a tree trunk. In various example embodiments, said means for holding said tree 105 may be a unit surrounding said tree trunk and being able to change its holding area and thereby compress around the tree trunk for securing purpose and decompress for releasing a tree trunk or entering a tree to be harvested. Said means for holding said tree 105 may comprise said sample detection means.

In various example embodiments said means configured for harvesting at least a portion of the tree may be arranged with means for attaching itself to said tree trunk. In various example embodiments said means configured for harvesting at least a portion of a tree may also be configured for moving up and down along the trunk of the tree. The movement may be performed by at least one electrically driven wheel travelling on said tree trunk. In various example embodiments at least one wheel may be electrically driven for enabling movement up and down said tree trunk and at least one other wheel is arranged for friction reduction during said movement. In various example embodiments at least to wheels are configured to attach, secure and move said means configured to harvesting at least a portion of a tree.

In various example embodiments said means configured for harvesting at least a portion of the tree is also configured for moving on ground. The movement can be made via a plurality of wheels or legs and/or as a tracked vehicle.

Said UAV 100 and said means configured for harvesting at least a portion of the tree may be communicating with each other via one or more of WiFi, Bluetooth, radio communication, telecommunication (3G, 4G, 5G), optical fibre and/or electrical wire. In various example embodiments said control unit and said UAV and/or said means configured for harvesting at least a portion of the tree may be communicating with each other via one or more of WiFi, Bluetooth, radio communication, telecommunication (3G, 4G, 5G). Depending on the distance and/or communication quality between the control unit and said UAV and/or said means configured for harvesting at least a portion of a tree the communication may change from one type of communication to another.

In various example embodiments said means configured for harvesting at least a portion of the tree is connectable to an underside of said UAV 100. In various example embodiments said means configured for harvesting at least a portion of the tree may be released from said UAV directly onto a tree to be harvested or on the ground at or near the tree to be harvested. In various example embodiments said means configured for harvesting at least a portion of the tree may be provided at a distance from said tree to be harvested from a land vehicle. The means configured for harvesting at least a portion of the tree may of its own motion move from the position on ground to the desired tree to be harvested. Communication between said UAV and said means configured for harvesting at least a portion of a tree may at any desired time result in a pick-up of said means configured for harvesting at least a portion of a tree by said UAV. The pickup of said means configured for harvesting at least a portion of a tree by said UAV 100 may be made on ground if there is enough space or on a trunk of a tree.

In various example embodiments the UAV 100 may comprise a power unit for powering said UAV 100 and said means configured for harvesting at least a portion of said tree 110. The power from said power unit in said UAV 100 may be delivered to said means configured for harvesting at least a portion of a tree 110 via at least one power cable. The power unit may be an electric motor and/or an internal combustion engine.

In various example embodiments said UAV 100 may comprising at least a first power unit for powering said UAV 100 and said means configured for harvesting at least a portion of a tree 110 may comprise at least a second power unit for powering said means configured for harvesting at least a portion of a tree 110. The power unit in said UAV 100 may be electrical and/or an internal combustion engine. The power unit in said means configured for harvesting at least a portion of a tree 110 may be electrical and/or an internal combustion engine.

In various example embodiments said means configured for harvesting at least a portion of a tree 110 is also configured for delimbing a tree. The delimbing may be performed from top to bottom if said means configured for harvesting at least a portion of the tree is initially arranged on said tree to be harvested from above. In various example embodiments said delimbing may be performed from bottom to the top if said means configured for harvesting at least a portion of a tree is moved by its own motion from ground to the tree to be harvested or attached to a lower section of the tree to be harvested from the UAV. The delimbing may be performed by one or a plurality of cutting means, snapping means, and/or shearing means. The cutting means may be by cutting chains and/or by rotary cutting disks. The cutting may be performed by a straight movement along said trunk of said means configured for harvesting at least a portion of a tree and/or by a serpentine movement along the trunk by said means configured for harvesting at least a portion of a tree.

In various example embodiments said means configured for harvesting at least a portion of a tree 110 is configured to be in direct communication with a remote operator and/or a remote base station 120 or indirect communication via said UAV 100 with a remote operator and/or a base station 120. The indirect communication, i.e., the UAV 100 as access point, with said means configured for harvesting at least a portion of a tree 110 may be used if the same information is to be sent to both UAV 100 and said means configured for harvesting at least a portion of a tree 110. The UAV 100 may in various example embodiments work independently from a remote base station 120. The indirect communication may also be used if said UAV 100 is arranged in between said base station 120 and said means configured for harvesting at least a portion of a tree 110.

In various example embodiments said UAV and/or said means configured for harvesting at least a portion of a tree may comprise means configured for automatically locating a tree and/or a predetermined area to be harvested. Said means configured for automatically locating a tree and/or said predetermined area to be harvested may comprise at least a Global Navigation Satellite System, GNSS. Said means configured for automatically locating a tree and/or a predetermined area to be harvested may comprise at least one camera or optical sensor. Said means configured for automatically locating a tree and/or a predetermined area to be harvested may comprise at least a camera in combination with Artificial intelligence or machine learning algorithms for speeding up the detection of a suitable area to arrange said means configured to cut a tree trunk.

Now returning to FIG. 1 where the UAV 100 is on its way to a tree 135 in forest 130 to be harvested. The tree 135 may be preselected, i.e., selected prior to arrival to the tree 135. Alternatively said tree 135 may be selected by the UAV 100 in combination with the base station 120 once the UAV 100 is at or near a position above said tree 135. The selection may be performed by identifying a picture of the tree 135 from above with stored pictures in said control station 120 and by means of a selection algorithm select a tree for tree thinning purpose or other selection criteria.

In FIG. 1 the forest 130 comprises four tree 135a, 135b, 135c, 135d, all of which may have equal or different tree parameters and/or growing conditions. The forest may of course have a larger or smaller amount of tree than the depicted 4 as shown in FIG. 1-4. A tree to be harvested may be determined by at least one of said detected tree parameters and/or growing conditions. In various example embodiments the order of harvesting tree 135a, 135b, 135c, 135d may be selected out of minimizing a total harvesting time. In various example embodiments a particular tree may be selected because there is a demand for such tree parameters from a particular customer. In various example embodiments a particular tree may be selected to be harvested due to a particular tree thinning strategy, e.g., smallest or largest tree in a group of tree, diameter of said at least a portion of a tree, length of said at least a portion of a tree, tree species of said at least a portion of a tree and/or the weight of said at least a portion of a tree, dry content, twig-free, rootstock, density, rot, discolored, dead tree and/or insect infested. tree parameters may be detected prior to arriving with the UAV 100 to the forest 130. This may be made manually and/or automatically. Manual detection may be made by a human being registering at least one tree parameter in a digital database. Automatic tree parameter detection may be made by a separate UAV and/or a land-based vehicle. Detection may be non-destructive and/or destructive.

Non-destructive methods may be made by visual inspection by a human being or by registering the tree by a suitable optical means such as a camera. Destructive detection may be made by removing a predetermined amount of a tree and analyzing it on site or at a remote site. A tree to be harvested may be selected depending on its distance to the final destination, e.g., choosing a tree with a particular set of tree parameters as close to the final destination as possible. A tree to be harvested may be selected in order to maximize the value of the total amount of harvested tree in a particular time frame. A tree to be harvested may be selected in order to maximize the value of the remaining tree in the forest. A decision of how much of a particular tree to be harvested may be made depending on at least one tree parameter.

In various example embodiments the selection of already harvested portions laying on ground may be made depending on at least one tree parameter. In various example embodiments a correct size of UAV may be made depending on at least one tree parameter of said at least a portion of tree laying on the ground. In various example embodiments a correct choice of number of UAV for transportation may be made depending on at least one tree parameter of said at least a portion of tree laying on the ground.

In various example embodiments the system further comprising means configured for determining a certain point in time said at least a portion of a tree should be harvested and/or transported. A tree 135a having a first set of tree parameters may be selected to be harvested and/or transported prior to a tree 135c having a second set of tree parameters.

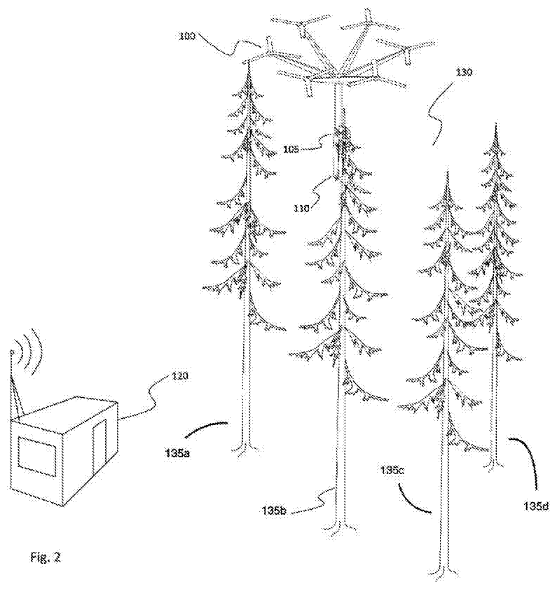

In FIG. 2 the selected tree 135b has been attached on its top portion by at least one means for gripping 105 said tree trunk. A gripping position on said tree 135b may be selected depending on the expected lift weight of the harvested portion of said tree. If the full tree is to be harvested a greater diameter of said trunk of the tree is to be chosen as a gripping position compared to if just a portion of the tree is to be harvested.

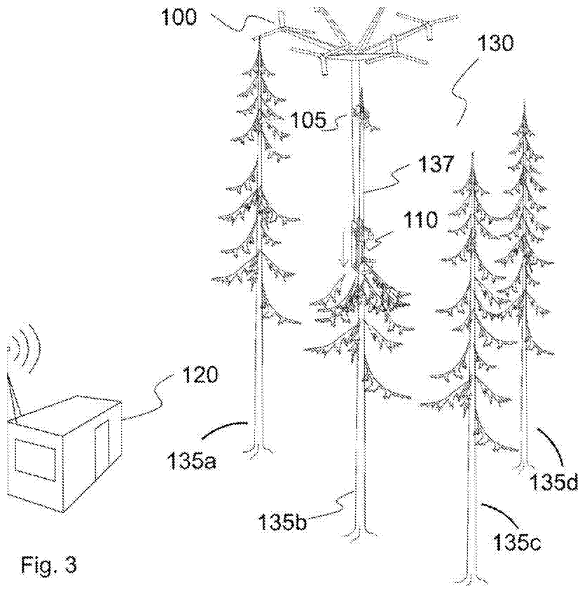

In FIG. 3 the autonomously controlled means configured for harvesting at least a portion of a tree 110 has been moved a distance down from said at least one means for gripping 105 said tree trunk. On its way down said means configured for harvesting at least a portion of a tree 110 also has delimbed the tree 135b leaving a bare tree trunk 137 without twigs and limbs. The powering of said means configured for harvesting at least a portion of a tree 110 may be provided by said UAV 100 or by a power unit in said means configured for harvesting at least a portion of a tree 110. In case of power supplied from said UAV to said means configured for harvesting at least a portion of a tree 110 said power may be delivered via one or a plurality of power cables arranged on between said UAV 100 and said means configured for harvesting at least a portion of a tree 110. A power unit in said means for cutting a tree trunk 110 may be one or a plurality of battery packs. In various example embodiments a first battery pack may be used for communication with the UAV 100 and/or a base station 120. A second battery pack may be used for moving said means for harvesting at least a portion of a tree 110 up/down on a tree trunk and/or for moving said means for harvesting at least a portion of said tree 110 on ground.

Instead of harvesting trees and/or bushes (tree) by means of cutting at least a portion of said tree, said tree may be removed from ground with at least a portion of its root system. This removal may be made by using the UAV as removal means, i.e., gripping a tree and using the upward traction power of the UAV for removing the tree from ground. This technique may only be used for small trees, for instance when invasive arts is to be removed from a particular area at an early stage for not causing damage on the remaining portion of the forest.

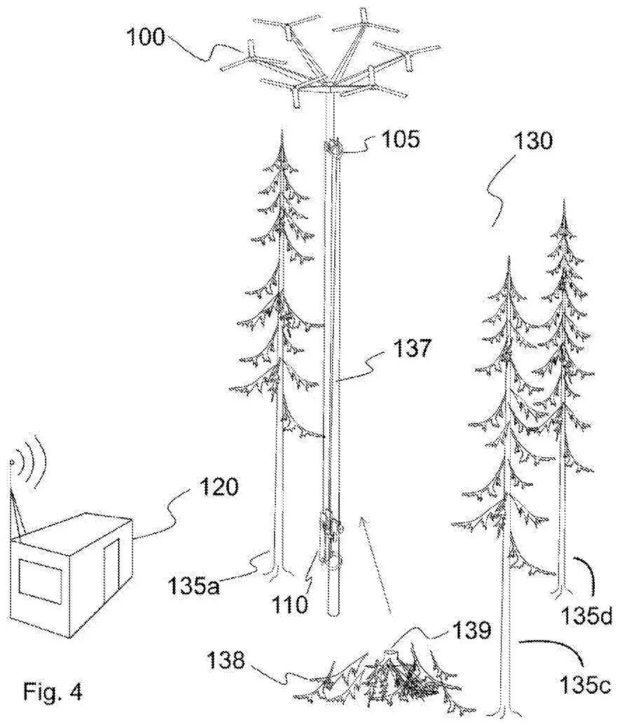

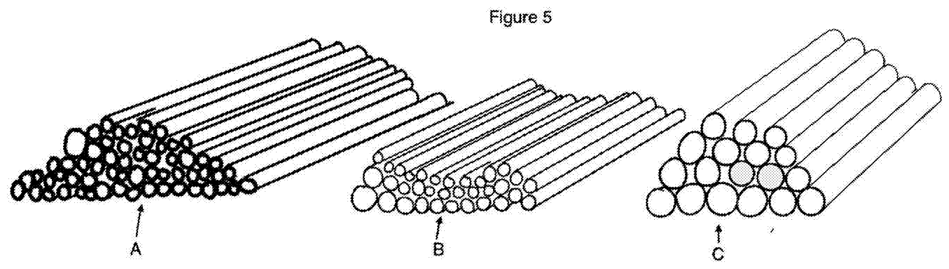

In FIG. 4 the tree 135b has been delimbed into a bare tree trunk 137, harvested and on its way to a location away from the original location of the tree. What is left of the original tree 135 at its original location is a pile of limbs 138 and a tree stump 139. In the depicted example embodiment said means configured for harvesting at least a portion of a tree 110 is still arranged on said tree trunk when the tree is transported away from the original location of the tree. In various example embodiments it is provided means configured for directing said remotely and/autonomously UAV 100 with said at least a portion of a tree to a final destination where said final destination is depending on said detected tree parameters. In various example embodiments a first type of tree species may be transported to a first final destination whereas a second type of tree species may be transported to a second final destination. FIG. 5 illustrates 3 different final destinations A, B and C respectively. The final destination may have a first set of tree parameters, final destination B may have a second set of tree parameters and final destination C may have a third set of tree parameters. Said first, second and third set of tree parameters may be different. tree parameters may for instance be a diameter of said at least a portion of a tree, length of said at least a portion of a tree, tree species of said at least a portion of a tree and/or the weight of said at least a portion of a tree, dry content, twig-free, rootstock, density, rot, discolored, dead tree, insect infested. At least one of said final destinations A, B or C may be an intermediate storage on ground. At least one of said final destinations A, B or C may be a mobile storage, for instance a timber truck.

In various example embodiments said final destination A, B or C may as in FIG. 5 be close to each other. In various example embodiments said final destination A, B or C may be remote to each other. In various example embodiments, more or less final destinations than 3 as depicted in FIG. 5 may be present.

In various example embodiments the final destination A may be for timber having a length within a predetermined interval. The final destination B may be for timber having a predetermined weight per unit of timber. The final destination C may be for rotten tree, discolored tree, dead tree and/or insect infested tree.

In various example embodiments the final destination A may be allocated with timber having a first set of tree parameters and a requirement to be filled with timber prior to a final destination B which may have the same tree parameters but will be filled with timber later in the tree harvesting process. It may be that the final destination A is close to a road or at a timber truck, whereas final destination B may be an intermediate storage closer to the harvesting area compared to final destination A and far away from any available road.

In various example embodiments the first final destination A may be for timber to be used as pulp. The second final destination B may be for building material, such as plank. The third final destination C may be for biomass material.

Depending on the location of said first, second and third final destination, A, B and C respectively, and the location of the tree to be harvested an optimization may be performed prior to harvesting in order to minimize the time required to harvest and transport a given number of trees in various categories. A forest having numerous trees, such optimization may result in harvesting a first set of tree parameters first and a second set of tree parameters later in time for a first harvesting area whereas in a second harvesting area a third set of tree parameters, different to said first and second may be chosen to be harvested first. The optimization may be depending on the density of tree per unit area, the topography of the nature where the trees are located, the type of tree present in a predetermined area and/or the purpose of the harvesting technique, sorting out or complete disforestation.

At least one tree parameter and/or growing condition may steer the final destination. Coordinates for different final destinations may be pre stored in the UAV and/or base station. Different sets of tree parameter and/or growing condition may be linked to different final destinations, i.e., coordinates.

A plurality of portions of tree may be transported simultaneously by at least one UAV. The choice of portions of tree to be transported may depend on the distance between the portions of tree and/or the distance between the plurality of portions of tree to be transported and the final destination. The choice of portions of tree to be transported may also depend on the total remaining battery power and/or remaining fuel of the UAV(s).

Said means configured for directing said remotely and/autonomously UAV with said at least a portion of a tree to a final destination depending on said detected tree parameters may also be configured for determining a certain point in time said at least a portion of a tree should be arrived at said final destination. Not only the destination may be determined depending on one or a plurality of tree parameters, also the certain point in time a particular at least a portion of a tree should arrive at a predetermined location may depend on one or a plurality of tree parameters. In a first example embodiment, a particular tree parameter is to be picked up by a timber truck and transported away days or weeks from a particular harvesting time. This may be a trigger factor for either just harvesting the particular tree and letting them lay on the ground or simply postpone the actual harvesting said days or weeks until said pickup by timber truck is to take place. In a second example embodiment timber at a particular final destination A, B, or C may be sorted so that a particular set of tree parameters arrives first, time A, at a particular final destination, i.e., furthest down in a pile of timer. A second set of tree parameters arrives later, time B and will be arranged in the middle of the pile of timber. A third set of tree parameters arrives latest, time C, and will be arranged on a top portion of the pile of timber. Having sorted different sets of tree parameters at one and the same location may make transport logistics more effective in picking up the correct type of timber.

The predetermined distance of at least one tree grown from said transported portion of a tree may depend on topography and/or invasive species. An insect infested and/or fungal infested tree in a predetermined area may result in harvesting relatively far away from the infested tree, i.e., a large predetermined distance up to several hundred of meters, whereas in a healthy environment said predetermined distance may be less than 50 meters and in some cases may be less than 20 meters. The predetermined distance from said at least a portion of a tree may be at least one final destination of said at least a portion of a tree. The holding position of said tree trunk to be transported may be chosen with respect to how tree trunks are stored at said final destination. A final destination may be chosen during transporting and/or harvesting. A final destination may be determined before a tree trunk is harvested. A final destination may be chosen depending on at least one tree parameter and/or growing condition. The system may be configured to detect at least one final destination by use of a camera, map and/or database with information of the forest. The final destination may be chosen with respect to the particular characteristics of the tree trunk to be transported, the power capacity of the UAV, the terrain and/or actual position of timber trucks.

The system may further comprise means for determining the number of UAV to be used together for transporting at least one portion of a tree depending on said at least one tree parameter and/or the distance between an original location of said at least a portion of a tree to and said final destination. Long and/or heavy portions of tree and/or a transport of a plurality of portions of tree may require more than one UAV for transporting said portion of the tree(s) from its original location to its final destination. At least one tree parameter may be used to allocate the correct number of UAV to be used in synchronism for transporting said portions of tree(s). The plurality of UAV may either attach to the portion of tree to be transported or attach to another UAV for synchronously transporting said portion of tree away from its original location to its final destination. The attachment of one UAV to another UAV may be made directly via a connection arrangement or via a wire or bar in between said two UAV. A plurality of UAV may also be necessary if the distance between the original location and the final destination is very long. If the distance between the original location and the final destination is long, an intermediate storage location in between said original location and the final destination may be necessary for later pick up and transport to the final destination. By using a plurality of UAV in synchronism may be advantageous since smaller UAVs may be used which is easier to handle and easier to use in a dense forest. Synchronization of a plurality of UAV for working together in transporting at least a portion of a tree may be made through a base station and/or a master UAV. When it is determined that more than one UAV is needed, one of said UAV may be assigned a master role and the other UAV a servant role. The master role may be assigned to the UAV first approaching the portion of tree to be transported or to a specific type of UAV. Alternatively, the plurality of UAV may be attached together for transport and the base station assigned one of them as a master and the other as servant UAV. Each and every UAV may communicate with each other and to the base station. In yet an alternative embodiment the base station is the synchronization unit, i.e., all UAV are assigned as servant UAV and follow one and the same instructions sent out from said base station.

In various example embodiments single UAV transportation may be prioritized before plurality of UAV transportation. This may be the case in an early stage of harvesting when the forest is still dense and there are lots of UAV available.

In various example embodiments transportation is based on total lift capacity of the UAV(s). A transportation optimization may in such a case be based on the order the tree should be picked up in order to minimize the clearing of a particular area. In various example embodiments only trees having a predetermined tree parameter should be prioritized before all other tree parameters and/or growing conditions.

In various example embodiments a particular type of UAV, size and/or capacity may be used depending on at least one tree parameter. In various example embodiments tree parameters sent to said base station may allocate a particular type of UAV out of a UAV fleet which may make the transportation as effective as possible.

Tree parameters may be detected by non-destructive evaluation, such as camera or optical sensors. Tree parameters may also be detected by removing physical sample from the tree and analyzing said sample. The removal may be in the form of cutting, drilling and/or sawing a predetermined amount of the tree at a predetermined position. The analyzing may take place directly in the UAV or means attached to said UAV. Alternatively said analyzing may be made at a remote location from the tree. tree parameter(s) may be detected by means attached to the same UAV which is used for transporting/harvesting the portion of tree and/or by a human being prior to harvesting/transportation and/or by a land based remotely and/or autonomously controlled Unmanned Vehicle (100) and/or by means attached to a separate UAV only used for detecting tree parameters and/or growing conditions. In various example embodiments detection of tree parameters and/or growing conditions may be made simultaneously and by separate means (UAV, human being, remotely and/or autonomously controlled Unmanned Vehicle) as harvesting and/or transportation in a particular area.

Instead of as in FIG. 4 delimbing and cutting the full tree, said tree may be harvested in sections starting from above and going down the trunk of the tree. When a section of the tree has been harvested, said means configured for harvesting at least a portion of a tree 110 may be left on the still uncut portion, the stump, of the tree while the UAV is transporting away the harvested portion from the original location of the tree. A cutting position on a tree trunk may be determined before arriving with means for cutting to a particular tree, i.e., it may have been detected by a human or information may be taken from data storage. The cutting position may be determined during harvesting and/or transporting. In such case the determination of a cutting position may be made by means of at least one camera attached to the UAV. The cutting position may also be determined by a previous cutting position, i.e., when a tree is first cut for producing a first harvested tree trunk the second cut on said remaining tree may be determined with respect to said first cut for producing a tree trunk with a predetermined length. The remaining tree may be a transported tree, un unharvested tree or a tree laying on ground. A cutting position may also be selected to be within a predetermined interval of the tree trunk. Said means for cutting a tree may also be capable of debarking and/or delimbing a tree trunk.

Delimbing means may be arranged on a top portion and on a bottom portion of said means configured for harvesting at least a portion of a tree 110. By arranging said delimbing means on both sides of said means configured for harvesting at least a portion of a tree 110 makes it possible to provide said means configured for harvesting at least a portion of a tree 110 from above on the tree or from root of said tree. The delimbing means is provided at the front position with respect of the direction of movement of said means configured for harvesting at least a portion of a tree 110.

In various example embodiments said means configured for harvesting at least a portion of a tree 110 may be provided by said UAV directly on a portion of the tree to be harvested where there are no limbs.

In various example embodiments said means configured for harvesting at least a portion of a tree 110 may be dropped on the ground at or near the tree to be harvested.

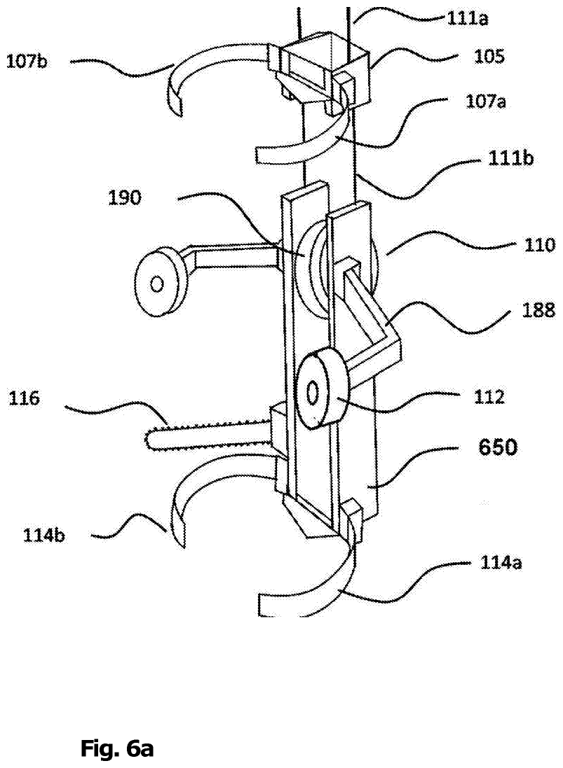

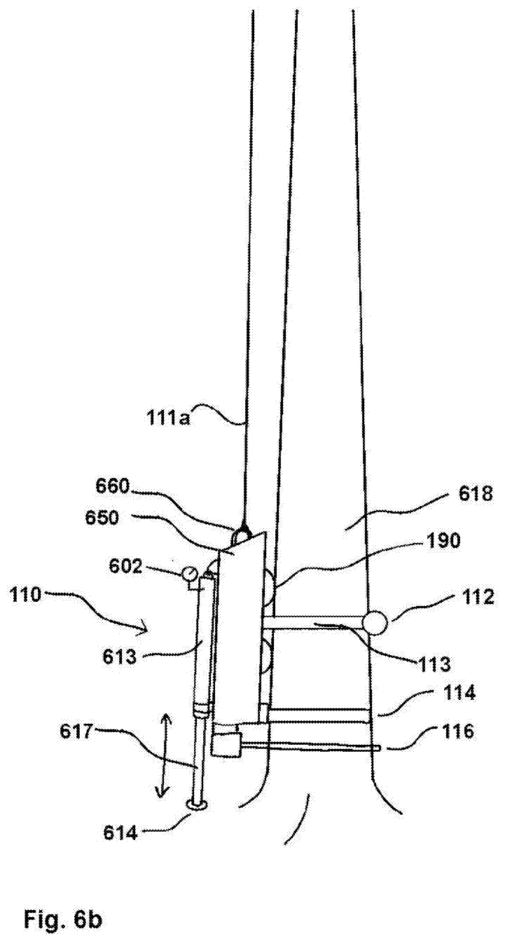

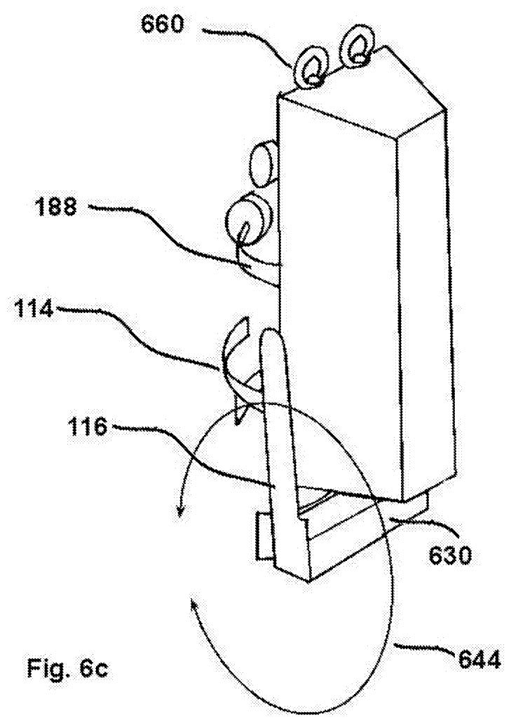

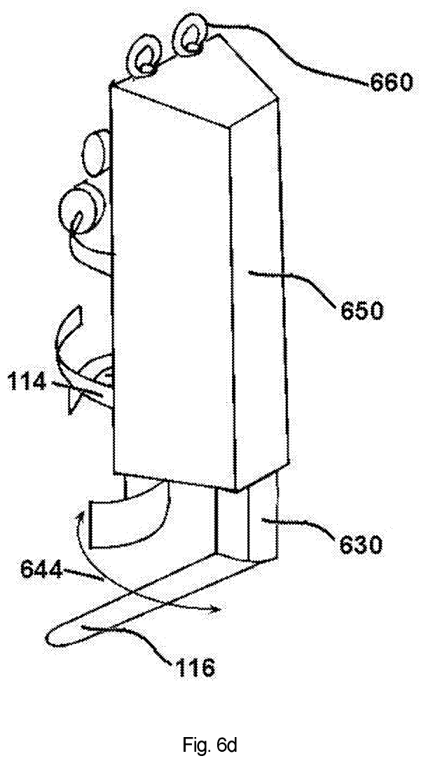

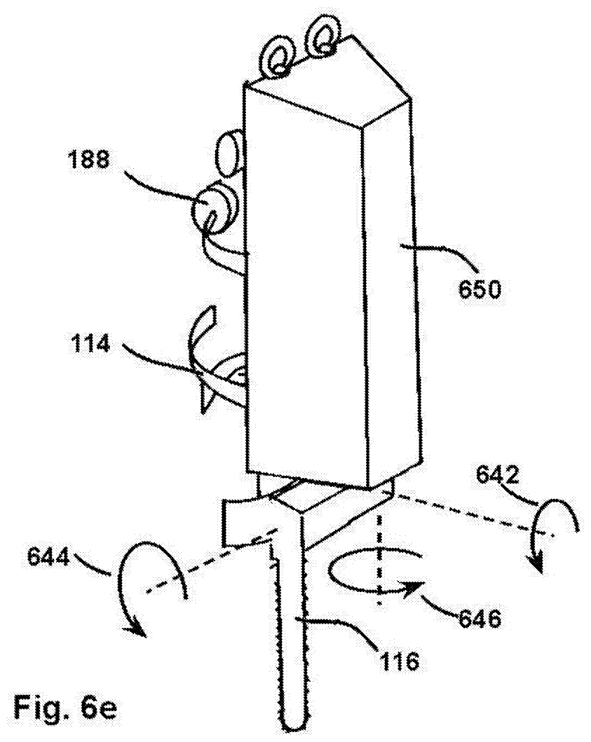

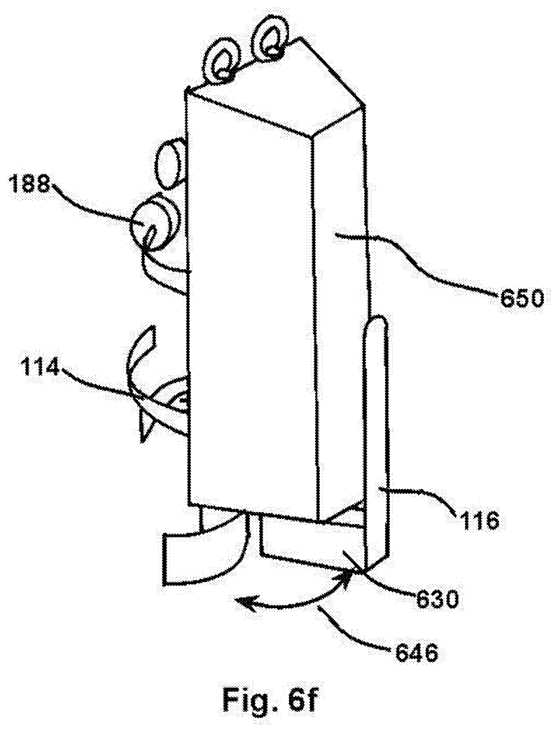

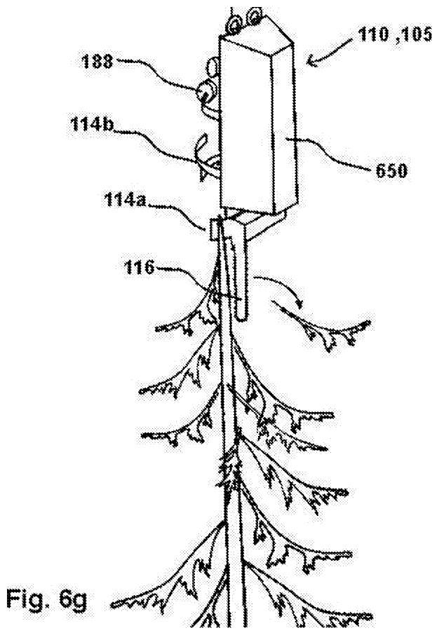

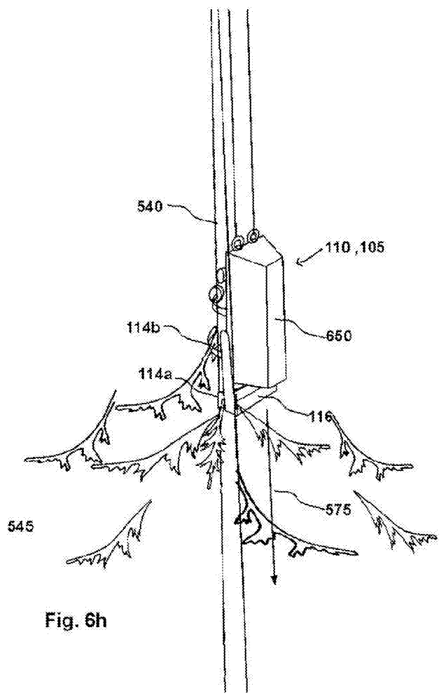

In FIG. 6a it depicts a schematic picture of an example embodiment of said means configured for harvesting at least a portion of a tree 110 and said means for holding said tree 105. Said holding means 105 may be provided at a distance from said UAV 100, for instance via one or a plurality of wires 111a. The holding means 105 is in this example embodiment in the form of a first movable curved arm 107a and a second movable curved arm 107b. Said arms 107a, 107b can be set to any position between a fully open position and fully closed position in order to allow to embrace a tree trunk and also to grip and release the same. The arms 107a, 107b may be configured to be disposed around the tree trunk and locked around said tree trunk. The arms 107a, 107b may fix onto the tree trunk at a predetermined position. Said means configured for harvesting at least a portion of a tree 110 comprises in FIG. 6 a first movable curved fixing/delimbing arm 114a and a second movable curved fixing/delimbing arm 114b. Said first and second movable curved fixing/delimbing arms 114a, 114b may be set to any position between a fully open position and fully closed position on order to allow to embrace a tree trunk and also to fixing the same. Said fixing/delimbing arms 114a, 114b may have a sharp edge on its top portion and/or its bottom portion for delimbing the tree as the means configured for harvesting at least a portion of the tree 110 moves along the trunk of said tree. Said means configured for harvesting at least a portion of a tree 110 may also comprise at least one cutter 116. The at least one cutter 116 may be in the form of an electrically driven or internal combustion engine driven chain saw. The chain saw may be arranged movable in said means configured for harvesting at least a portion of a tree 110 in order to cut a tree while said means configured for harvesting at least a portion of a tree 110 is in a fixed position on said trunk of the tree.

The delimbing means 114a, 114b may be optional. The holding means 105 may be provided at a distance from said means configured for harvesting at least a portion of a tree 110. Said holding means 105 may be attached at said means configured for harvesting at least a portion of a tree 110 with at least one wire 111b or at least one metal bar or other suitable attaching means. In various example embodiments said holding means 105 may be mechanically separable from said means configured for harvesting at least a portion of a tree 110 meaning that the holding means may attached at a fixed position at the tree while the means configured for harvesting at least a portion of the tree 110 may of its own motion move along the trunk of the tree with no mechanical attachment to the holding means 105. The means for harvesting at least a portion of a tree 110 may cut a portion of a tree and stay on the still not harvested portion of the tree while said UAV is moving away with the harvested portion to another location. Delimbing may take place by said means configured for harvesting at least a portion of a tree 110 while said UAV is moving away said harvested portion of the tree. The UAV may return to the same tree and remove yet another portion of it and said means configured for harvesting at least a portion of a tree 110 may stay on the not yet harvested portion or be attached to the harvested portion or the UAV and move together with the UAV to another location. The holding means 105 and the means configured for harvesting at least a portion of a tree 110 may communicate with each other and/or independently of each other communicate with the UAV and/or the base station 120. A camera may be used, attached either on said UAV, said holding means 105 and/or said means configured for harvesting at least a portion of a tree 110, in order to simplify attachment of said UAV with said means configured for harvesting at least a portion of a tree 110. The attachment of said UAV and said means configured for harvesting at least a portion of a tree 110 and/or said holding means may be a fully automatic process. Said means configured for harvesting at least a portion of a tree 110 may have at least one electrically driven wheel 190, a traction wheel, for allowing movement of said means configured for harvesting at least a portion of a tree 110 along a trunk of a tree. One or a plurality of supporting wheels 112 may be used for securing said means configured for harvesting at least a portion of a tree 110 onto said trunk of said tree and for reducing friction while moving along said trunk of said tree. Said supporting wheel(s) may be arranged on arms 188 which may be movable in order to secure said means configured for harvesting at least a portion of a tree 110 on said trunk of said tree.

In various example embodiments said means configured for harvesting at least a portion of a tree 110 and said holding means 105 may be a single unit or two separable units. The means configured for harvesting at least a portion of a tree 110 may be capable of its own motion to moving up and down along the trunk of the tree, which can delimb and/or cut the tree. The movement may be made by at least one wheel 190 arranged on a base structure 650.

Said means for holding 105 may change its position onto said tree trunk during cutting, delimbing, harvesting, transporting and/or debarking said tree trunk.

FIG. 6b depicts another example embodiment of a means configured for harvesting and/or delimbing a tree 110. A tree trunk is denoted 618. At least one wire 111a is connectable between a UAV (not shown) and said means configured for harvesting and/or delimbing a tree 110. Said means configured for harvesting and/or delimbing a tree 110 comprises a base structure 650. Attached to a bottom portion said base structure in FIG. 6b is a cutter 116 configured for at least cutting a tree trunk. The cutter may be a chain saw or the like. Said base structure 650 may be provided with at least one wheel 190 allowing said base structure to freely move up and down along a tree trunk. Said wheel 190 may be motorized traction wheel. At least one arm 113 may be provided in the upper portion of said base structure 650. Said arm 113 may at its end be provided with a roller 112 adapted to roll against the tree trunk 618. The roller 112 may be motorized. The arm 113 may be movably attached to said support structure 650. The arm may be straight or curved. The arm may be foldable and configured to press a tree in between said arm and an inner side of said support structure 650. At least one cutting means for delimbing a tree 114 may also be provided in a bottom portion of said base structure 650. The cutting means 114 may be a knife. The knife may be one side blade knife of a double-sided blade knife. A one-sided blade knife may have its sharp edge towards the bottom portion of the base structure for allowing delimbing of a tree when said means configured or harvesting and/or delimbing 110 is moving from a top portion of a tree trunk 618 to a bottom portion of a tree trunk 618. In various example embodiments said cutting means 116 may be provided above said means for delimbing a tree 114. Said support structure 650 may be provided at least one attaching means 660 to be attachable to at least one UAV. In FIG. 6a said attaching means 660 is a hook and in between said hook and said UAV is at least one wire 111a. In alternative embodiments said UAV may be directly attachable to said base structure 650. Said base structure 650 may further comprise at least one shock absorber 613. Said shock absorber is provided on said base structure 650 so that a free foot end 614 is protruding from a bottom portion of said base structure 650. The free foot end 614 is arranged on a free end of a piston which may be telescopically movable in and out of said shock absorber 613. The shock absorber 613 is arranged on said base structure so that said piston 617 is essentially in parallel with the tree trunk when said means configured for harvesting and/or delimbing a tree 110 is attached to a tree trunk 618, in other words may said piston be in parallel with said base structure 650 to which it is attached. The shock absorber may be provided with a pressure measuring device 602 for estimating the weight of the cut tree trunk. The cut tree trunk may be weighing by balancing the total weight of the cut tree trunk on said free foot 614. The balancing may be made with the UAV which may be attached to said base structure 650 with said at least one wire 111a during cutting the tree trunk. Weight information may be sent to said UAV only, to said UAV which may send it further to a base station or said weight information may be sent directly from said means configured for harvesting and/or delimbing a tree 110 to a base station. The information about weight may be used for transporting purpose and/or for determining a final destination of said cut tree trunk. The information about weight and information about remaining battery capacity of the UAV may determine the final destination of said tree trunk. If too heavy and/or of too less battery capacity the tree trunk may be picked up at a later time or said tree trunk may be transported to an intermediate storage position.

The shock absorber 613 may assist in cutting a tree trunk. The base structure 650 may be secured onto a tree trunk with holding means 114a, 114b, 107a, 107b in the form of arms pressing the tree trunk towards said inner side of base structure 650. Said base structure 650 and/or said arms may be provided with friction means in form of rubber plates and/or sharp protruding metal objects which will penetrate the tree trunk when pressing said arm towards said base structure 650. With a secured base 650 structure onto said tree trunk in the vicinity of the ground, said shock absorber may be remotely actuated and its piston 617 may be extended towards ground and provide a pressure upwards along the tree trunk 618. The holding means 114a, 114b, 107a, 107b may be attached above the intended cutting position. When cutting the tree trunk said cutting tool 116 will not get stuck if the shock absorber is lifting the tree trunk to be cut with a sufficient lifting force. The lifting force may be estimated by using tree parameters and/or growing conditions.

In various example embodiments said base structure 650 may have at least one additional holding means for holding an additional weight during delimbing. Said additional holding means may be provided on an outside i.e., opposite side with respect to said traction wheel 190, i.e., on a surface pointing away from said tree trunk when said means configured for harvesting and/or delimbing a tree 110 is attached to a tree trunk 618. The additional holding means may be configured to hold at least one portion of a tree trunk. The additional weight of said tree trunk held by said additional holding means or any other weight, may be suitable in a delimbing process. Delimbing may be performed by so-called gravity delimbing. The means configured for harvesting and/or delimbing a tree 110 held by an UAV may select a tree to delimb. The means configured for harvesting and/or delimbing a tree 110 may be provided by said UAV from above of said tree. When the means configured for harvesting and/or delimbing a tree 110 has been provided on a top portion of a tree trunk, said means configured for harvesting and/or delimbing a tree 110 may be dropped from said UAV towards ground. The at least one cutting means for delimbing a tree 114 in the form of a knife will due to the weight and speed of the means configured for harvesting and/or delimbing a tree 110 delimb the tree. If not all limbs are cut the process may start all over, i.e., the means configured for harvesting and/or delimbing a tree 110 may be picked up by the UAV and further dropped. This may continue until all or a predetermined amount of limbs are removed from the tree trunk. The additional weight may greatly assist in this delimbing process. The base structure 650 may comprise one or a plurality of batteries for powering the movable holding means 105, the traction wheel 190, movable arms 188 with rollers 112, movable cutting means for delimbing a tree 114a, 114b and/or an electrified cutting means 116. The movable holding means 105, the traction wheel 190, movable arms 188 with rollers 112, movable cutting means for delimbing a tree 114a, 114b and/or an electrified cutting means 116 may be autonomously controlled via said UAV or directly from a remote location. The base structure may be an elongated structure onto which the movable holding means 105, the traction wheel 190, movable arms 188 with rollers 112, movable cutting means for delimbing a tree 114a, 114b and/or an electrified cutting means 116 may be attached. In an example embodiment the movable holding means 105, movable arms 188 with rollers 112, movable cutting means for delimbing a tree 114a, 114b and/or an electrified cutting means 116 are all extending from said base structure in essentially the same general direction in order to embrace, cut or to delimb a tree trunk. The movable holding means 105, the traction wheel 190, movable arms 188 with rollers 112, movable cutting means for delimbing a tree 114a, 114b and/or an electrified cutting means 116 together with motorized units for them, battery pack and means for communication with UAV and/or a remote control unit may be grouped in one single unit. The movable holding means 105, the traction wheel 190, movable arms 188 with rollers 112, movable cutting means for delimbing a tree 114a, 114b and/or an electrified cutting means 116 may be operated autonomously independent from each other.

FIG. 6c-f depict said cutting means 116 for cutting a tree trunk in three different modes. Said cutting means 116 may be in a resting mode, a pruning mode or a tree trunk cutting mode. In FIG. 6c a resting mode is when a chain saw or a cutting disk 116 is having its surface in parallel with the tree trunk and said surface is essentially in vertical direction. A chain saw 116 may have a tip of its blade point in a direction towards a top of the tree to be cut. In the resting mode, said cutting means 116 is in a fixed position and the chain saw may be switched off. The cutting means 116 may be provided on a motorized moving support 630 for rotating and/or tilting the cutting means in various directions. In the resting mode the cutting means 116 is folded aside to not interfere with the cutting means for delimbing a tree 114 in a free fall. The cutting means 116 may change its resting mode to a pruning mode by switching on the rotation of the cutting disk or chain saw and rotate the cutting disk or chain saw blade 116 around a rotational axes perpendicular to a surface of a cutting disc or a blade of the chain saw, as indicated by arrow 644 in FIG. 6c. Said rotational axes is within said moving support 630 and in parallel with its elongated structure in FIG. 6c. By rotating said cutting means 116 around said rotational axes the cutting means may be positioned so as to prune a tree as the support structure is moving up and/or down the tree trunk. The moving support may also be rotated as depicted by arrow 646 in FIG. 6f. i.e., around a rotational axes which is in parallel with the vertical direction or the chain saw blade. By rotating the chain saw as indicated by arrow 646, limbs may be cut at various positions around the tree trunk.

By tilting the cutting means 116 as depicted in FIG. 6d, said cutting disc or blade of the chainsaw is positioned with its surface essentially in horizontal direction. A tilting direction is denoted with arrow 642 in FIG. 6e. By rotating the cutting means 116 as indicated by arrow 644 in FIG. 6d, said cutting means 116 is capable of cutting a tree trunk. The cutting means 116 may be movable in three degrees of freedom as depicted in FIG. 6e. FIG. 6e depicts the three different rotational/tilting directions 642, 644, 646 respectively which is positioning and rotating the cutting means in various directions.

FIG. 6g depicts a means configured for harvesting and/or delimbing a tree 110 attached to an UAV where said means configured for harvesting and/or delimbing a tree 110 is in a pruning mode where limbs or branches are cut by rotating said cutting means 116 round the tree trunk while said means configured for harvesting and/or delimbing a tree 110 is moving downwards along the tree trunk.

FIG. 6h depicts the cutting means in a resting position while gravity delimbing the tree with said means configured for harvesting and/or delimbing a tree 110. Here the delimbing knives 114a, 114b cut the branches 545 when the means configured for harvesting and/or delimbing a tree 110 is falling down along the tree trunk 540. The cutting means 116 is folded away in order not to interfere with the gravity delimbing.

In various example embodiments said base means configured for harvesting and/or delimbing a tree 110 may comprise a plurality of attaching means arranged spaced apart from each other. Said UAV may be attached to said attaching means via wires 111a. A distance between said means configured for harvesting and/or delimbing a tree 110 and said UAV may be varied by adjusting the length of said wires 111a. By attaching the wires at spaced apart position on for instance said base structure 650, said base structure 650 may be tilted in predetermined positions by shortening or extending a first wire differently compared to a second wire. Each wire may be shortened or extended by providing said first and second wires on a first and second wheel or rotational axes respectively. By rotating said first and second wheel in clockwise or anti-clockwise direction the wires may be extended or shortened respectively. Each wheel or rotational axes having these first and second wires respectively may be autonomously and/or remotely operated independent of each other so that said means configured for harvesting and/or delimbing a tree 110 can be set in a predetermined position.

In various example embodiments said means configured for harvesting and/or delimbing a tree 110 maybe attached to a tree trunk. Said remotely and/or autonomously actuated telescopic piston element in said shock absorber may at its end having at least one cutting means for cutting a branch. A branch may be cut by providing said cutting element at the end of said remotely and/or autonomously actuated telescopic piston element in vicinity of a branch and thereafter extending said remotely and/or autonomously actuated telescopic piston element towards said branch so that it will be removed from said tree trunk.

In various example embodiments said means configured for harvesting at least a portion of a tree 110 may be provided at or near the tree to be harvested either by the UAV or by a land vehicle. Said means configured for harvesting at least a portion of a tree 110 may of its own motion move towards a predetermined tree to be harvested and arrange itself at a predetermined position on the trunk. An UAV may, before said tree is cut, be arranged at a top position of said tree and grip the trunk of the tree in a position safe to lift the portion to be cut. Said means configured for harvesting at least a portion of a tree 110 may cut the tree and the UAV may move the harvested tree away from the original location of the tree. The harvested tree may have all of its limbs left on the tree. Said means configured for harvesting at least a portion of a tree 110 may follow the harvested tree from the original location of the tree or stay at the tree stump.

In various example embodiments said means configured for harvesting at least a portion of a tree 110 may be provided at or near the tree to be harvested either by the UAV or by a land vehicle. Said means configured for harvesting at least a portion of a tree 110 may of its own motion move towards a predetermined tree to be harvested and arrange itself at a predetermined position on the trunk. An UAV may, before said tree is cut, be arranged at a top position of said tree and hold/grip the trunk of the tree in a position safe to lift the portion to be cut. Said means configured for harvesting at least a portion of a tree 110 may first move upwards the trunk of the tree in order to delimb the same. Thereafter said means configured for harvesting at least a portion of a tree 110 may move to a predetermined position and there cut the tree trunk. The UAV may move the harvested tree from the original location of the tree. The harvested tree may be delimbed. Said means configured for harvesting at least a portion of a tree 110 may follow the harvested tree from the original location of the tree or stay at the tree stump.

The system may comprise a plurality of UAV and a plurality of means configured for harvesting at least a portion of a tree all of which may work together for efficiently harvesting a tree in a forest.

A plurality of UAV may work together synchronously for transporting a harvested portion of a tree or a plurality of harvested tree. This may be arranged so that a first UAV is a master UAV and at least a second UAV is a slave UAV. The master UAV may grip the tree to be harvested at a predetermined position on its trunk. Said at least one slave UAV may be attached to said master UAV via wires. Said at least one slave UAV may be arranged at an elevated position with respect to the master UAV. A synchronisation unit makes sure the master UAV and the at least one slave UAV works in synchronisation with respect to movement and distance to each other. The synchronisation unit may be arranged in the master UAV or arranged in the control unit controlling said master UAV and said at least one slave UAV.

Instead of a single UAV gripping said portion of the tree to be harvested a plurality of UAVs may grip the same tree to be harvested.

In various example embodiments of the present invention said UAV is designed to be capable of flying as to control position, velocity, orientation and rotational speed and via a rigid connection impart its motion to the means for cutting/delimbing said tree. In this embodiment the UAV controls the movement of the means for cutting/delimbing said tree. The means for harvesting 110 may be rigidly connectable to said UAV. Said rigid connection may be released and the UAV and said means for harvesting 110 may be separated from each other. When releasing said rigid connection between said UAV and said means for harvesting 110 the UAV and means for harvesting 110 may still be connected to each other by at least one wire. Said at least one wire may be used for pulling said means for harvesting 110 towards said UAV. Said at least one wire may be extended or shortened by rolling up or rolling out said at least one wire. The roll up/roll out mechanism may be arranged in said means for harvesting 110 or said UAV. A first wire may be connected to a first position on said means for harvesting 110 and a second wire may be connected to a second position on said means for harvesting 110, said first and second position may be laterally separated from each other allowing said means for harvesting 110 to be rotated/tilted by shorten/extending said first and second wires independently from each other. The rigid connection between said UAV and said means for harvesting 110 may be opened or closed autonomously and/or remotely. Said first and second wires may be shortened and/or extended autonomously and/or remotely allowing an autonomously and/or remotely rotation/tilting of said means for harvesting 110. At least one holding means 105 may be connectable to said means for harvesting 110. Said holding means may be arranged between said UAV and said means for harvesting 110. Said holding means 105 may be rigidly connectable to said means for harvesting 110 and said UAV. Said holding means 105 may be provided with at least one first wire mechanism connectable to said means for harvesting 110 and at least one second wire mechanism connectable to said UAV. At least one wire from said first and/or said second wire mechanism may connect said means for harvesting 110 and/or said UAV when they are separated from each other, i.e., when the rigid connection is released between said UAV and said holding means 105 and/or said holding means and said means for harvesting 110. Said first and second laterally separated positions on said means for harvesting 110 may rotate/tilt said means for harvesting 110 around a first rotational axes. By arranging a third wire to a third position on said means for harvesting 110, where said third position is laterally separated from both said first and second position will provide for two new rotational axes, it total three rotational axes, by adjusting the length of said first, second and third wires respectively independently from each other. Note, in combination control may be realised in the two possible independent orthogonal axes By providing a fourth wire to a fourth position on said means for harvesting 110, where said fourth position is laterally separated from said first, second and third position will provide for yet another 3 rotational axes, now in total 6 rotational axes, by adjusting the length of said first, second, third and/or fourth wires respectively independently of each other. In addition, using 6 wires in a suitable arrangement, e.g. Steward platform arrangement, may allow for full independent control of all 6 degrees of freedom of a rigid body.

In various example embodiments of the present invention the UAV may be used to reduce load on said cutting means 116 during cutting. This may be performed by first holding a predetermined portion of the tree by said holding means 105 and thereafter apply a lift force by said UAV while cutting the tree by the means for harvesting at least a portion of the tree 110. This may be advantageous since a reduced load on the cutting means 116 from the weight of the tree may increase the efficiency of the cutting procedure and/or require less power compared to cutting a tree with the full load onto said cutting means 116.

In various example embodiments a separate land vehicle may be used with means for harvesting at least a portion of said tree while the UAV is lifting the tree. This may be advantageous since there is no load on the cutting means from the weight of the tree which may increase the efficiency of the cutting procedure and/or require less power compared to cutting a tree with the full load of the portion to be cut on said cutting means.

FIG. 7 depicts an UAV 100 with means for harvesting 110 or cutting at least a portion of a tree. In FIG. 7 a tree 135m is only cut with means for cutting 116. In various example embodiments the cut tree may be with or without delimbing. The decision which tree to cut may depend on several factors. It may depend on tree parameters and/or growing conditions for tree 135k and/or 1351. Those trees may have a specific quality which may have been detected by tree parameters and/or growing condition, which specific quality one wants to improve. The improvement may be achieved by cutting a tree 135m with means for cutting 116. With tree 135 removed the economical growth value and/or growth potential of tree 135k and/or 135l may be increased. tree 135k and/or 135l may have an increased growth potential after tree 135m has been removed just because tree 135m was too close to tree 135k and/or 1351.

In another example embodiment tree 135m is cut because tree 135m has at least one tree parameter and/or growing condition which may be inferior, for instance tree 135 may be storm damaged and is cut for fertilizing and/or give more sunlight, water and nutrition to the remaining trees 135k and/or 1351. In the depicted example embodiment in FIG. 7 the tree is cut without being taken care of. It may be economically advantageous to fertilize remaining trees with trees of low value. Cutting trees without taking care of them may also depend on nature conservation goals or to fulfil environmental certification where some trees must be left on ground for favouring other living species.

FIG. 8 depicts tree, whereof one 135n is not harvested while the other two has been cut down and cut in portions. The three trees may have different tree parameters and/or growing conditions, which may have determined which of the trees to be cut down and how the tree is cut in portions. tree 1350, 135p, 135q and remaining tree 135r are portions of a first harvested tree. tree 135s, 135t, 135u and remaining tree 135v are portions of a second harvested tree. The different portions of said first and second harvested tree may have different tree parameters, i.e., different portions of a single tree may have varying tree parameters. Said first and second harvested tree may have been harvested by a UAV and/or by a land-going harvesting equipment. If said first and second harvested tree has been harvested by an UAV, it may be advantageous to leave said first and second harvested tree on the ground as an intermediate storage location for later transportation to another location when it is more logistically advantageous. The reason for not transporting away a tree from its original location immediately after having cut it down may depend on limited storage capacity at a nearby forest road. Harvesting can either be made with UAV and/or land-based harvesting machines. tree parameters may be detected during harvesting by means attached to the UAV and/or the land-based harvesting machine. For instance, when tree 135p is harvested it may give indirect information about weight and other tree parameters of tree 1350 and/or tree 135q. tree parameters of for instance a top scrap portion of a tree may determine if the remaining portion of the tree should be transported when harvested or be cut and stored at its original location for transportation at later point in time. Annual rings in 135r may be detected with a camera and give information about tree parameters for the other portions 1350, 135p, 135q.

In various example embodiments tree parameters and/or growing condition for tree 135n may give indication of the quality of tree 1350, 135p, 135q, 135s, 135t, 135u. tree parameters and/or growing condition from tree 135n may determine the priority of harvesting and/or the order of transportation and/or the final destination for tree 1350, 135p, 135q, 135s, 135t, 135u.

In various example embodiments information about tree parameters and/or growing condition for tree 1350, 135p, 135q, 135s, 135t, 135u may be stored digitally during harvesting. Such digitally stored information may not be visible on the harvested portions 1350, 135p, 135q, 135s, 135t, 135u, but may be stored together with coordinates in three dimensions. The digitally stored information may determine which quality the different portion may have and when, in time, said different portion shall be transported. In various example embodiments harvesting and transportation may be made at different times due to ground condition, wet, snow etc or other temporary weather conditions.

Information about tree parameters and/or growing condition which is detected during harvesting may be performed by a land-based machine and/or a UAV, may be used for determining the number of UAV needed for lifting the tree portions 1350, 135p, 135q, 135s, 135t, 135u.

FIG. 9 depicts transportation of a tree with at least one UAV to different storage locations 201a, 201b. Storage location 201a has a first tree quality (first set of tree parameters and/or growing conditions) and storage location 201b has a second tree quality (second set of tree parameters and/or growing conditions). A weight of a specific portion of a tree may be estimated based on information about an average diameter length and volume of a tree.

The UAV 100a may have harvested a tree in pile 135i at location 201a. A tree in pile 135i at location 201b may have lower weight than a tree in pile 135w. Ligno in pile 135w may require two UAV, 110b, 110c, for transportation of each individual tree due to its weight.

The UAV 100b has a first means 105 for holding the tree 135j and said UAV 100c has a second means 105 for holding the same tree 135j. As indicated in FIG. 9, attachment point for holding means 105 for UAV 100b is different from attachment point for holding means 105 for UAV 100c.

Based on tree parameters and/or growing condition a location for storage of different portions of tree is determined. Different number of UAV may be necessary for lifting different trees depending on tree weight, max lifting capacity for UAV may determine the number of UAV necessary for transportation.

Two or more UAV 100b, 100c may, as depicted in FIG. 10, use a common means for holding 105 the tree 135x and transporting said tree 135x in synchronism to a final destination. Using a common means for holding the tree may increase the load capacity.

FIG. 11 depicts trees of different quality stored at a common destination. Tree 135e and tree 135f have different tree parameters, in this case diameter, volume and weight are different, meaning that tree 135e has a lower value than tree 135f. In FIG. 11 tree 135e is on top of tree 135f, meaning that tree 135e arrived earlier to the common destination than tree 135e. tree parameters have in this case determined that higher value tree 135f has arrived earlier to the common destination than the lower value tree 135e. Although a common destination is used for different value tree and no marking has been made further transportation of the different tree types 135e, 135f may be easily separated due to its evident difference in size and shape. The common destination may not only be tagged with longitude and latitude but also its spatial location, height, in the pile. Transportation from the common destination may be made in different time slots so that different transportation means may select the correct tree for further transportation. Storing different types of tree spatially differently at a common destination may be advantageous logistically due to the fact that different quality trees may have different final destinations.

FIG. 12 depicts that different classes of tree quality may be transported to the same location but at different points in time during a day. tree 135h of a first mix of tree parameters and/or growing condition is transported to common destination 201 at a first time 202b. tree 135h is picked up for further transportation before trees of a second mix of tree parameters and/or growing condition arrives at said common destination 201. tree 135g arrives at time 202a, which is later than 202b. Using a common destination may be necessary when space is limited.

A certain point in time may be a specific time, a specific time range, between time A and time B, after time B or before time A. A certain point in time may be before or after a specific occasion or that specific requirements are fulfilled. It can also mean that a specific tree, based on tree parameters and/or growing condition may be transported, cut, harvested and/or left at a final destination when specific requirements are fulfilled. It may also mean that specific command, functions or the like is activated and when such commands or functions are activated, transportation, cutting, harvesting and/or drop of tree at a final destination is started based on tree parameters and/or growing condition in a specific order. It may also mean when specific requirements are fulfilled transportation is always or never started for a specific tree parameter and/or growing condition. tree may mean at least a portion of a tree, bush, or other wood-like species such as bamboo. A tree may be cut with or without delimbing.

A certain point in time may be the moment when directing a UAV to a predetermined destination for harvesting, transportation and/or cutting and/or delivery of trees at a predetermined location. Harvesting, transportation, cutting and/or leaving functions as a trigger for setting a speed and/or acceleration of a UAV with or without load in a predetermined direction to a predetermined destination. A certain point in time may be when a predetermined capacity per hour is reached, e.g., a predetermined harvested amount per hour is reached, a predetermined amount of tree per hour is transported and/or a predetermined amount of tree per hour is cut. Said capacity and/or speed may be controlled or optimized based on weather condition, detected tree parameter, detected growing condition, transporting distance, power consumption and/or logistic prerequisites.

A certain point in time may be, for both selection of a tree and selection of a final destination, at which time different portions of a tree is to be transported, harvested, cut and/or delivered.

A certain point in time may be a targeted point in time and/or an estimated/predicted (based on simulations) point in time. A targeted point in time may mean that transportation, harvesting, cutting and/or delivering is intended to happen at a certain point in time. An estimated/predicted point in time may mean that transportation, harvesting, cutting and/or delivering is expected to happen at a certain point in time.

A final destination may be a place or position where the tree is expected to be delivered. The final destination may be a position in air where the tree is dropped from the UAV to the ground.

In various example embodiments the UAV is configured with aerodynamic means, comprising rotors, fans, wings, or equivalent combination, interacting with the air so as to be capable to precisely control the UAV position, velocity, orientation and/or angular velocity.

A tree trunk may have a length above 2 m and/or a diameter larger than 10 cm and/or a weight larger than 10 kg. I various example embodiments the weight of the tree trunk is larger than 50 kg. In various example embodiments the weight of the tree trunk is larger than 100 kg. In various example embodiments the length of the tree trunk is larger than 3 m. In various example embodiments the diameter of the tree trunk is larger than 20 cm. In various example embodiments the diameter of the tree trunk is larger than 30 cm.

FIG. 13 depicts an example embodiment of a means for holding 105 directly and/or indirectly onto at least a portion of a tree trunk 135. In FIG. 13 a plurality of tree trunks 135 are held by said means for holding 105. tree trunks 135 denoted with A are directly in contact with the means for holding 105 whereas tree trunks 135 denoted with B are only indirectly in contact with the means for holding 105. tree trunks B are held by tree trunks A. tree trunks B are only touching tree trunks A whereas tree trunks A are touching the means for holding 105 and tree trunks B. Heterogenous tree trunks may be arranged for optimizing, weight distribution and/or load capacity. Stacking of tree trunks in the means of holding 105 in FIG. 13 may be based on tree parameters and/or growing condition. The stacking of tree trunks 135 in means for holding 105 may also be based on the final destination of the individual tree trunks 135, i.e., tree trunks 135 to be delivered first on top of the stack and tree trunks 135 to be delivered later further down in the stack of tree trunks 135. Said means for holding may have a first type of tree trunks and/or tree trunks to be delivered a first point in time to the left in said means for holding 105 and a second type of tree trunks and/or tree trunks to be delivered a second point in time to the right in said means for holding. The means for holding may together with stacked tree trunks form a new type of means for holding.

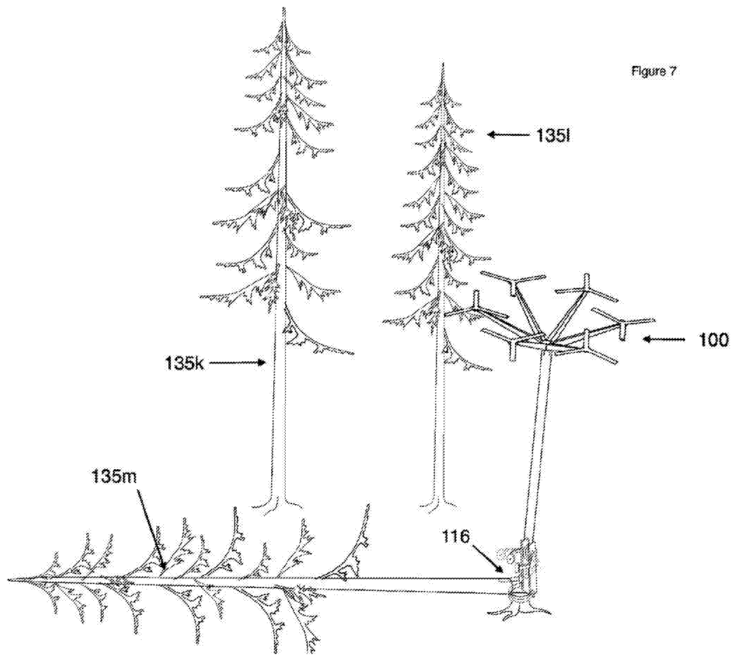

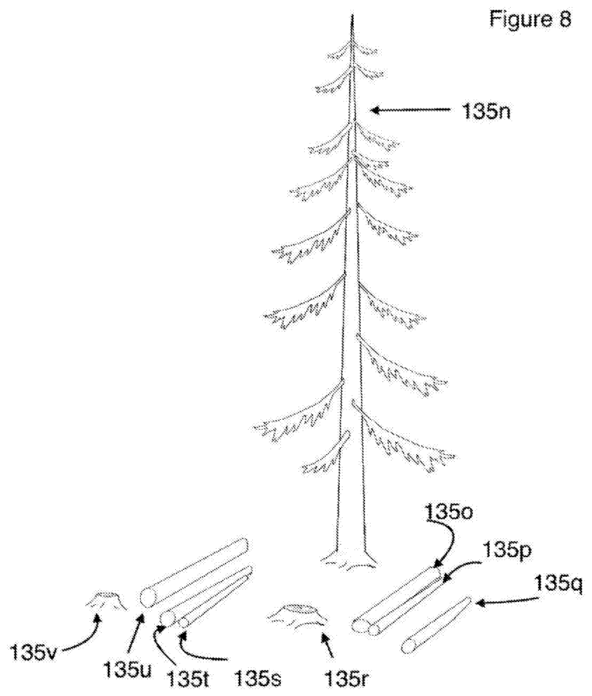

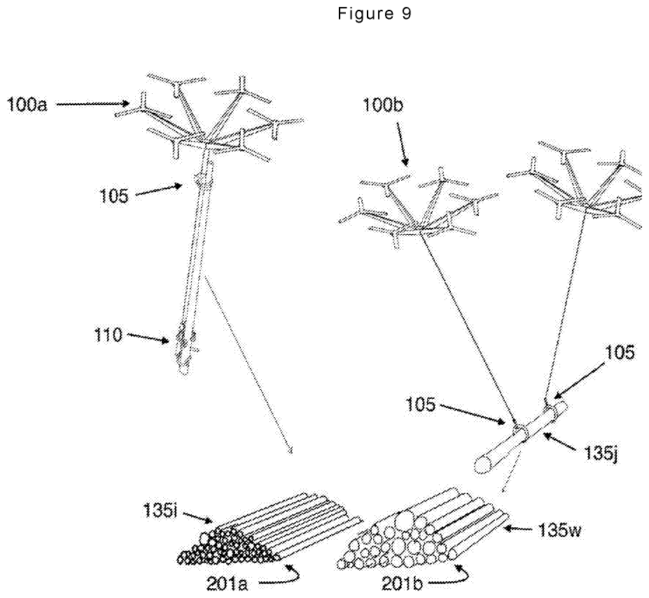

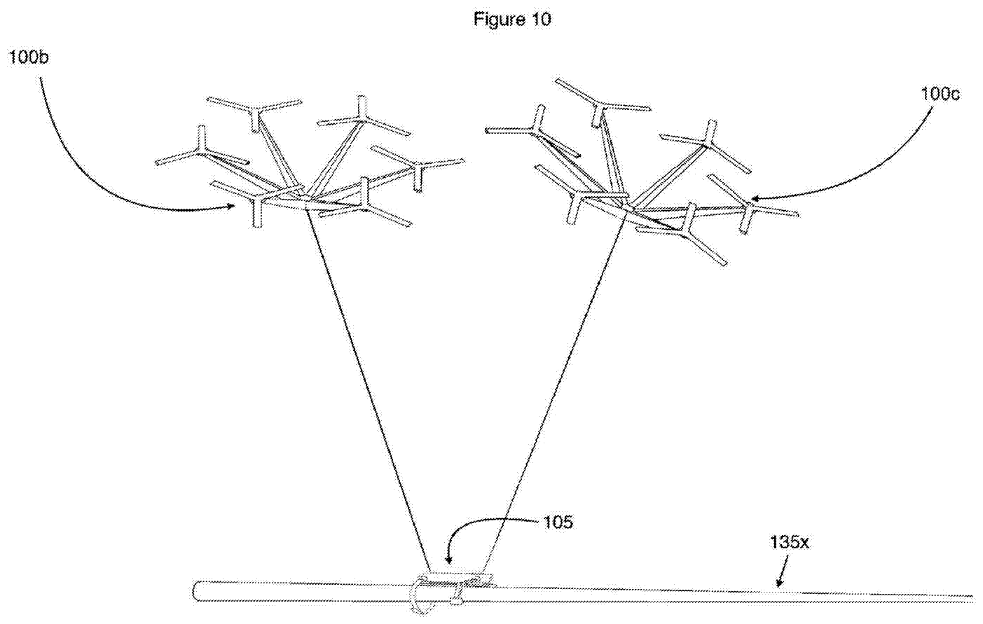

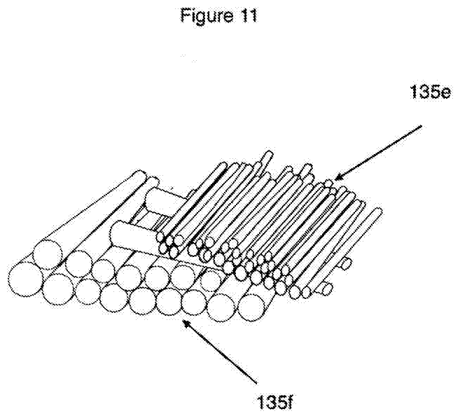

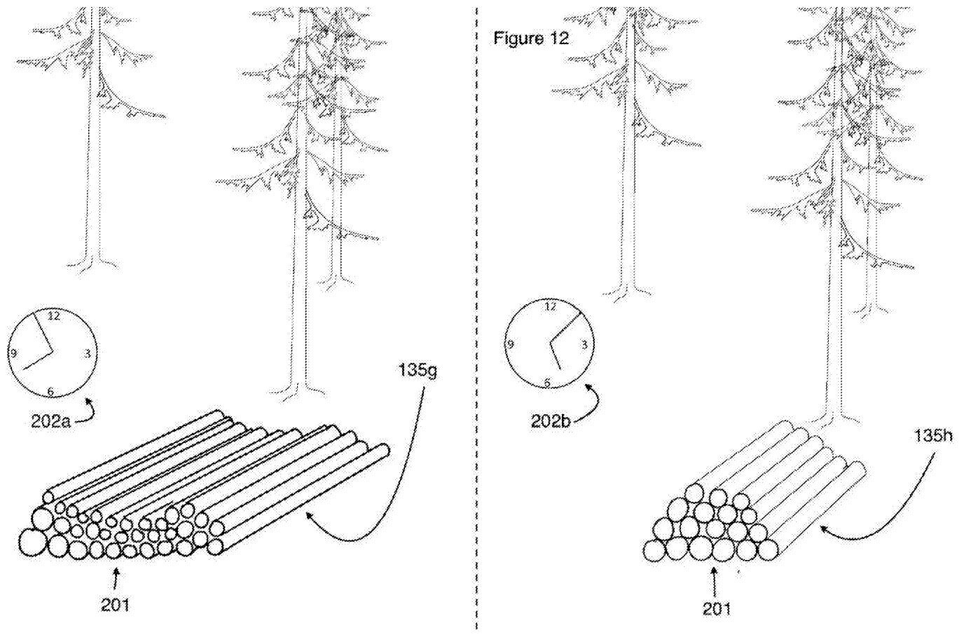

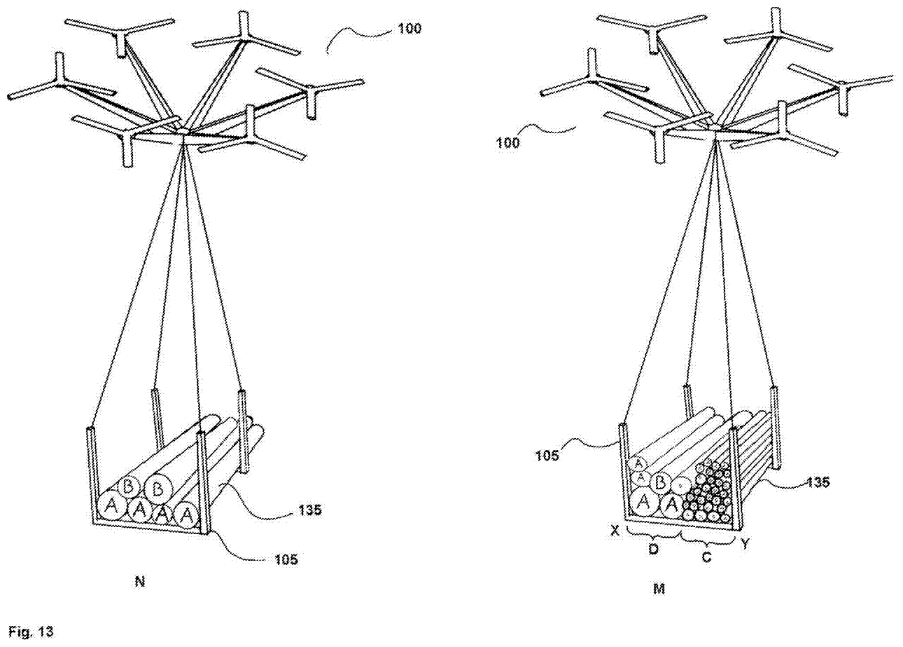

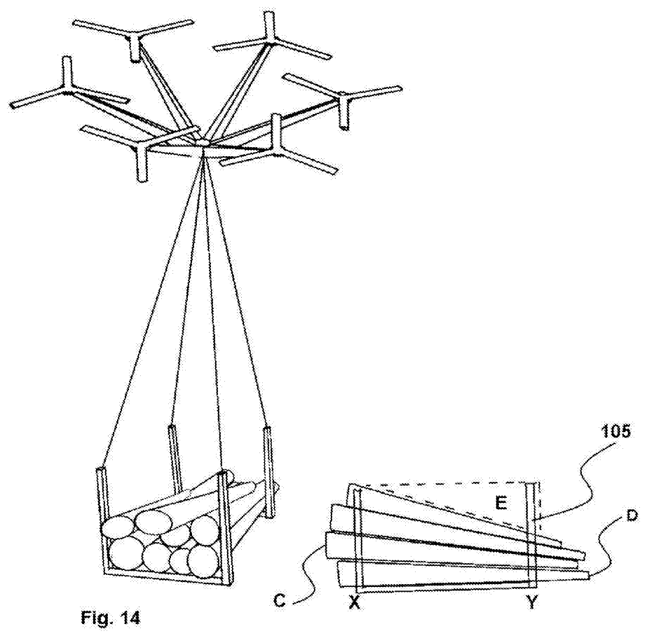

FIG. 14 depicts an example embodiment of a non-optimal stacking of tree trunks. In FIG. 14 the load of tree trunks is heavily skewed. Tree trunks with a large diameter C are all arranged to the same end X of the means for holding 105 whereas the smaller diameter D are arranged to the other end Y. This skewed stacking may not only result in a non-optimal weight distribution but also in a non-used load capacity volume E.

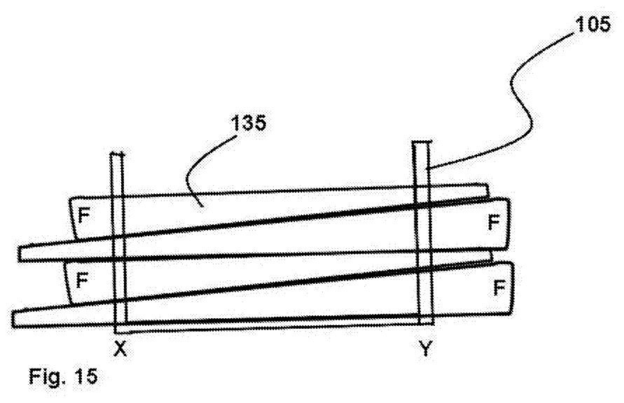

FIG. 15 depicts a more efficient stacking of tree trunks 135. Here every other tree trunk is having the large end F to a first end X and second end Y of the holding means 105. tree parameters and/or growing conditions may be used for optimizing the stacking for achieving a desired weight distribution and/or load of tree trunks 135.

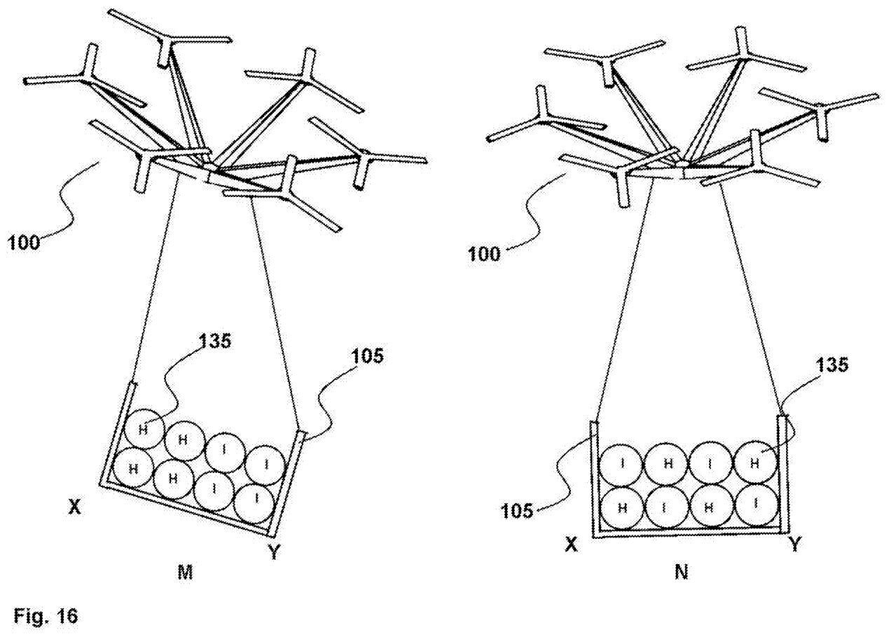

FIG. 16 depicts an example embodiment of stacking of tree trunks 135 having essentially homogeneous shape but of different density. In case of stacking the means for holding 105 with high density tree trunks I towards Y and low density tree trunks H towards X, said means for holding 105 will tilt in a clockwise direction due to the uneven weight distribution, see FIG. 16M. Taking into account tree parameters and/or growing condition a more efficient stacking may be achieved with a desired weight distribution by mixing the position of high and low density trees 135 in the means for holding 135, see FIG. 16N.

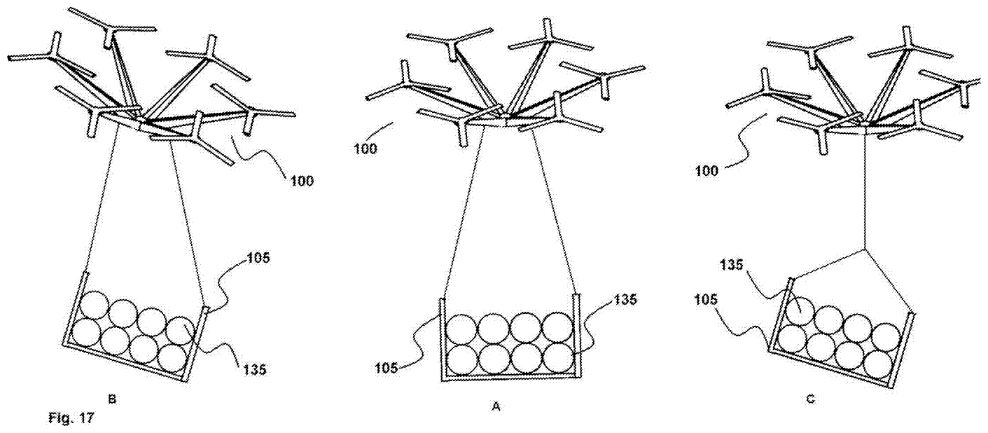

FIG. 17a-c depicts three different load scenarios. In FIG. 17a there is an even weight distribution of tree trunks 135 resulting in a means for holding 105 in an essentially horizontal direction with respect to ground. In FIG. 17b there is an uneven weight distribution of tree trunks 135 and due to the type of attachment of the UAV 100 to the means for holding 105, both UAV and the means for holding 105 are tilted out of a horizontal plane. In FIG. 17b the attachment means between the UAV 100 and means for holding 105 are provided on the outskirts of the means for holding 105 and out of a centre of gravity of said UAV. The attachment means may be in the form of metal wires, metal rods, ropes or similar means. In FIG. 17c the weight distribution of tree trunks 135 is uneven and due to the attachment of the means for holding 105 to a centre of gravity of said UAV 100, the UAV 100 may remain untilted while the means for holding 105 may be tilted.

FIG. 18 depicts a possible scenario with a tilted means for holding 105 where tree trunks 135 in said means for holding 105 risking to drop from the means for holding 105 due to its tilted position. tree trunks 135 may drop from the means of holding 105 in windy transportation conditions or slippery tree trunks 135.

The load capacity may be alterable due to the weight of the tree trunks. A first support member and a second support member may be rotatable with respect to each other around a rotation point. The first support member may be attached with its top end to the UAV 100 and the second support member may be attached with its top end to the UAV 100. When the volume of the load and/or the weight of the load in said means for holding varies the load capacity may vary within a predetermined load range.

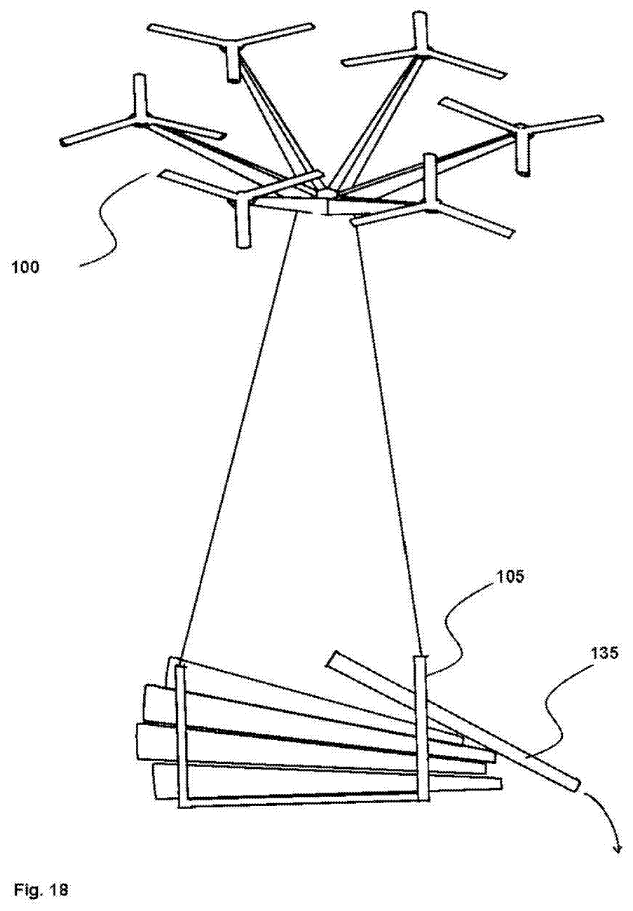

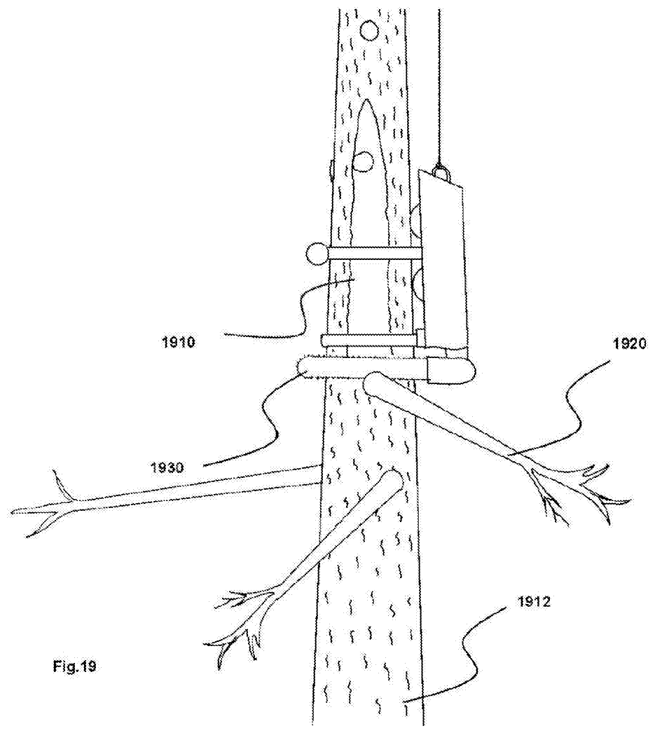

FIG. 19 depicts a means for cutting 1930 delimbing and debarking a tree which has a hollow inner portion 1910 which may be caused by insect infestation, fungus, age or similar. By debarking a tree not only the tree will die but also most likely the insects causing the insect infestation. Means for delimbing and means for debarking may be one and the same tool or different tools.

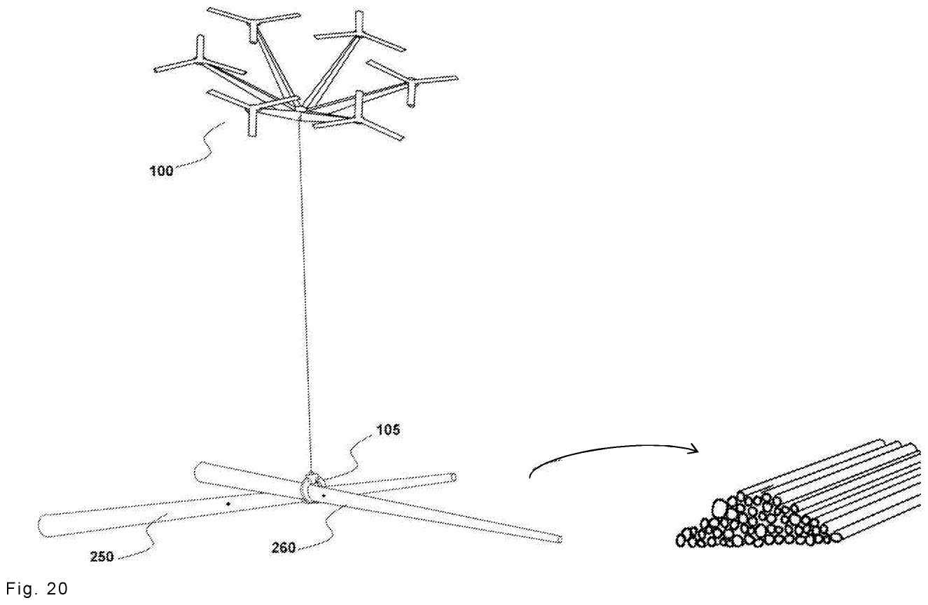

FIG. 20 depicts a possible scenario with a single holding means 105 holding two tree trunks 250, 260. Here the tree trunks are non-parallel with each other causing a relatively high air resistance. The relatively sprawling load of tree trunks 150, 260 may be a result of a single holding position of said means for holding in combination with a lifting said tree trunks 150, 260 out of their own and/or combined centre of gravity.

FIG. 21 depicts a possible scenario with a fixed volume holding means 105 and a plurality of tree trunks 135 as a load. With tree trunks 135 arranged irregularly in the means for holding 105 may cause transportation difficulties due to a risk of irregularly tree trunks being jammed in other trees in the forest. Another problem with an irregular arranged load of tree trunks is the larger air resistance it may create which may increase the risk of drop of tree trunk(s) in heavy winds and/or unstable transportation. In FIG. 21 tree trunks A and B are provided in said means for holding 105 in such a way that any tree trunks protruding from said means of holding 105 is taking place in a predetermined direction. However, tree trunks M and N are provided in said means for holding 105 in an irregular manner with respect to tree trunks A and B and any protruding of tree trunks M and N may take place in any direction. Tree trunks M and N may risk dropping said means of holding 105 in case of said means of holding and/or said tree trunks M and/or N are touching any object during its transportation or if there is a windy condition during transportation.

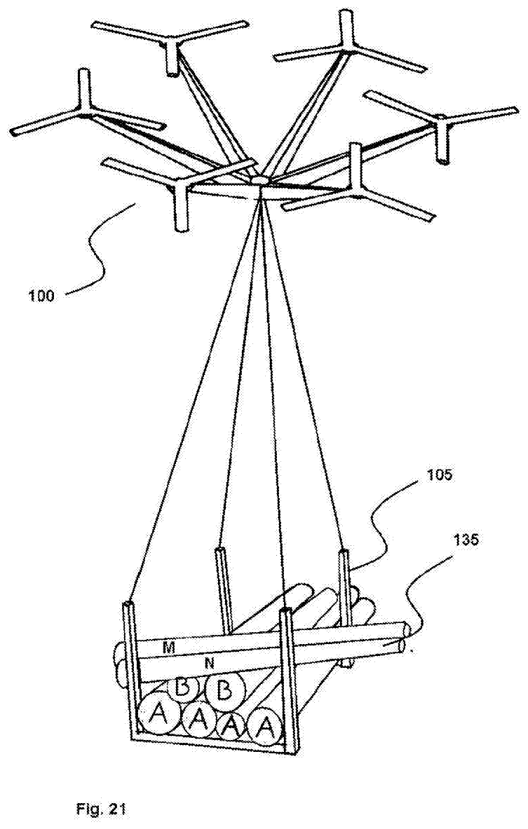

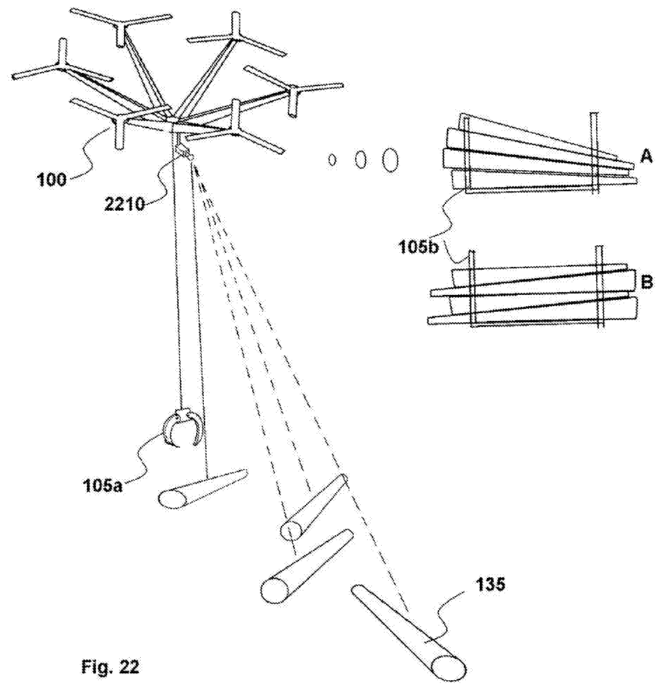

FIG. 22A depicts a load of tree trunks with an uneven weight distribution. This may be created by arranging all of the tree trunks with its large end diameter in the same direction in said means of holding 105. FIG. 22B depicts a load of tree trunks with an even weight distribution. This may be created by arranging some of the tree trunks with its large end diameter in the first direction and the remaining tree trunks with its smaller diameter in the same direction. The arrangement of tree trunks may be planned by using tree parameters and/or growing conditions of the tree trunk(s). A camera 2210 provided on said UAV 100 may for instance be used for determining how to grip a first tree trunk 135 so that its geometry is known already before the gripping moment. Any information of how said first tree trunk is held by holding means 105 attached to said UAB 100 may later be used for providing said tree trunks another holding means and or gripping a second tree trunk with the same holding means as holding said first tree trunk for creating an even weight distribution of a combined load of said first and second tree trunks.

FIG. 23 depicts a single tree trunk C 135 in a means of holding 105. Due to the size of the means for holding 105 and the size of the tree trunk C 135, said tree trunk C 135 may during transportation vary its position and cause an unstable transportation. This problem may be remedied by transporting a plurality of tree trunks which may secure each other in the means for holding 105.

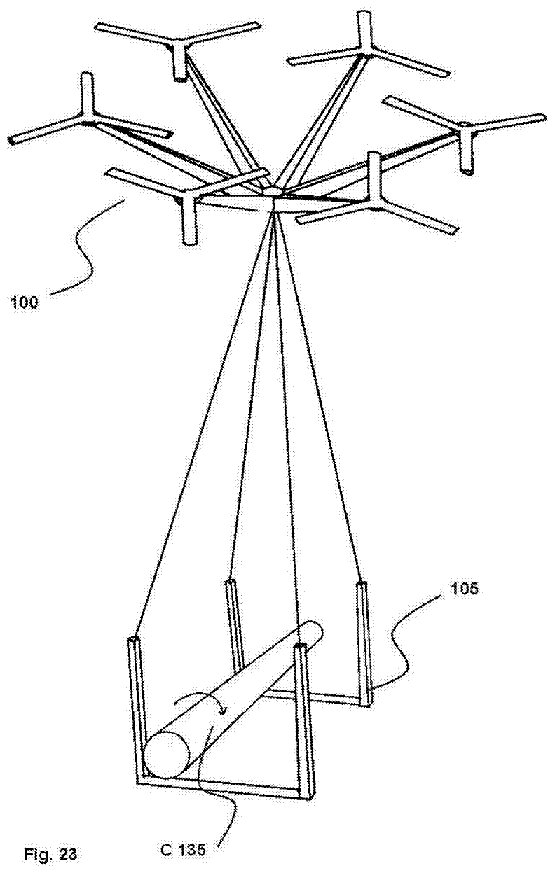

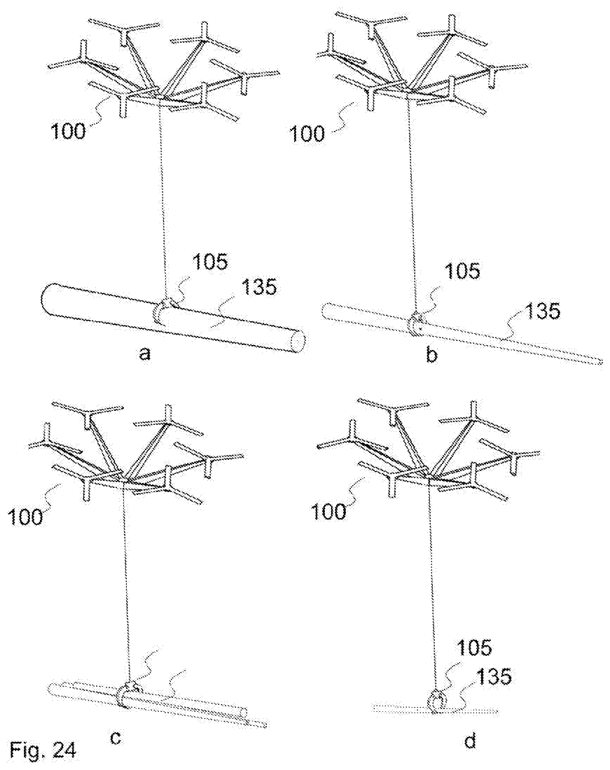

FIG. 24a depicts a means for holding 105 being too small for the diameter of the tree trunk 135. The means for holding 105 does not enfold the full diameter of the tree trunk 135 which may increase the risk of drop of tree trunk 135 in a windy condition. In FIG. 24b the full diameter of the tree trunk 135 is enfolded by the means for holding 105. In FIG. 24c a plurality of tree trunks 135 are completely enfolded by the means for holding 105. In FIG. 24d the means for holding 105 is holding a tree trunk 135 having a much smaller diameter than the load capacity of said holding means 105. Said holding means may cut itself into the tree trunk 135 in FIG. 24a for increasing the lift capacity of said means for holding 105 and/or for further securing its load.

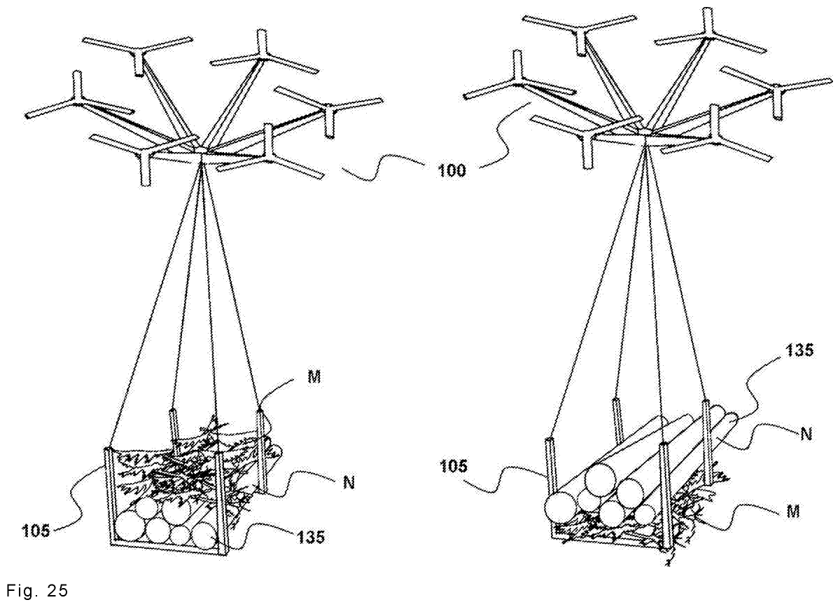

FIG. 25a depicts a means for holding 105 having tree trunks 135 N at the bottom and twigs M on top of said tree trunks 135 N. Here the twigs M may risk falling out of said means for holding 105 whereas the tree trunks 135 N are relatively secured at the bottom of said means for holding 105. FIG. 25b depicts a means for holding 105 having the twigs M in the bottom and the tree trunks 135 N on top of said twigs M. Here the tree trunks 135 N may risk rolling out of the means for holding 105 whereas the twigs M is secured at the bottom of the means for holding 105 by the weight of the tree trunks 135 N.

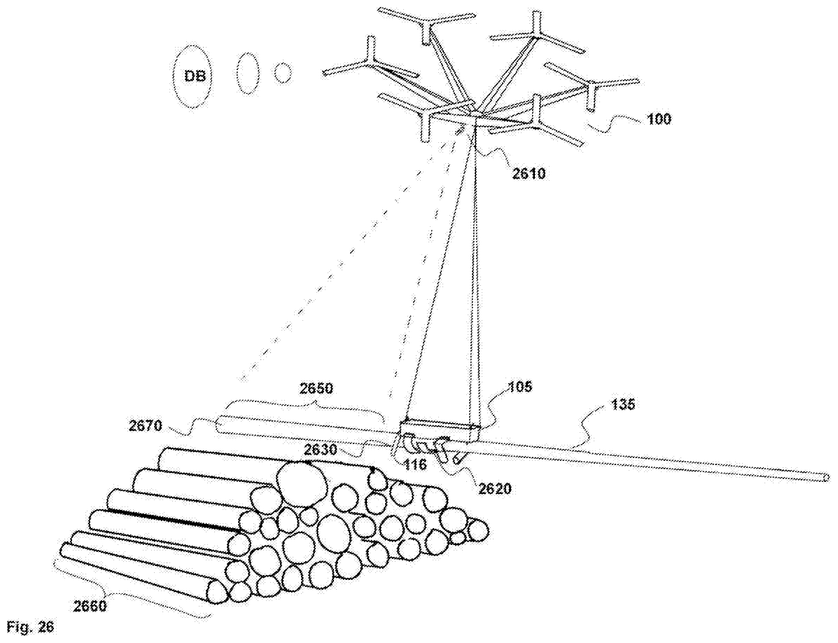

FIG. 26 depicts a UAV 100 having attached to it a means for holding a tree trunk 105 and a means for cutting a tree trunk 2670. In FIG. 26 a holding position is denoted by 2620 and a cutting position is denoted by 2630. A tree trunk may be cut with a means for cutting 116 based on at least one tree parameter of at least one tree trunk in the pile of tree trunks 2660. One such tree parameter may be the length of the tree trunk. A tree trunk held by holding means 105 may be cut for producing a new tree trunk 2650 having the same length as the tree trunks in the pile of tree trunks 2660. A remaining tree trunk 2640 may further be cut by said means for cutting 116 for producing yet another tree trunk to said pile of tree trunks 2660 or being too short to be cut and maybe transported to another storage position. A camera 2610 provided on said UAV 100 may detect the length of the tree trunks in said pile of tree trunks 2660 and the length of the new tree trunk 2650. The cutting position may be determined by said camera 2610 and/or from a database.

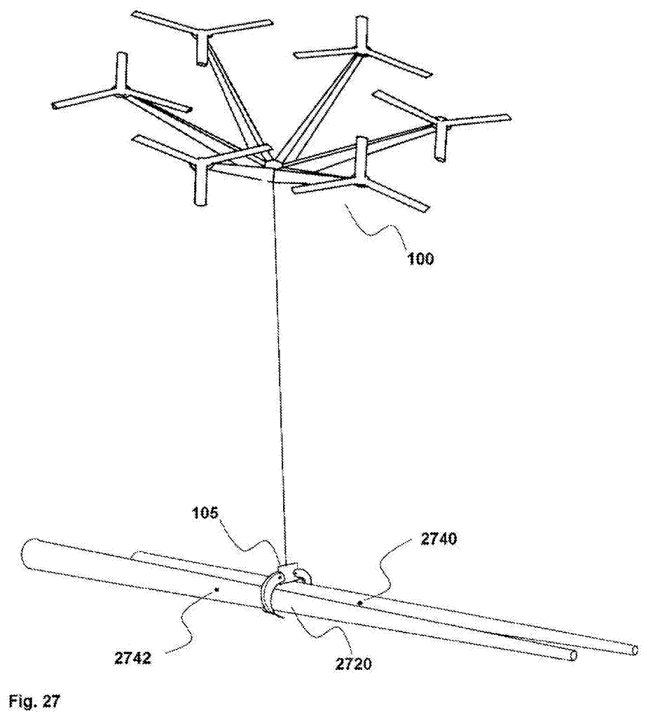

In FIG. 27 a UAV is provided with a means for holding 105. Said means for holding is here holding a first tree trunk 2740 and a second tree trunk 2742. The first tree trunk 2740 is having a centre of gravity at a first position whereas the second tree trunk 2742 is having a centre of gravity at a second position. A combined centre of gravity of said first and second tree trunks may result in a holding position 2720 being positioned at a distance from the larger diameter of said second tree trunk 2742 and at a distance b from the smaller diameter of said second tree trunk 2742. The combined centre of gravity position of said two tree trunks may when being held there result in a horizontal transport of said first and second tree trunks 2740 and 2742 respectively.

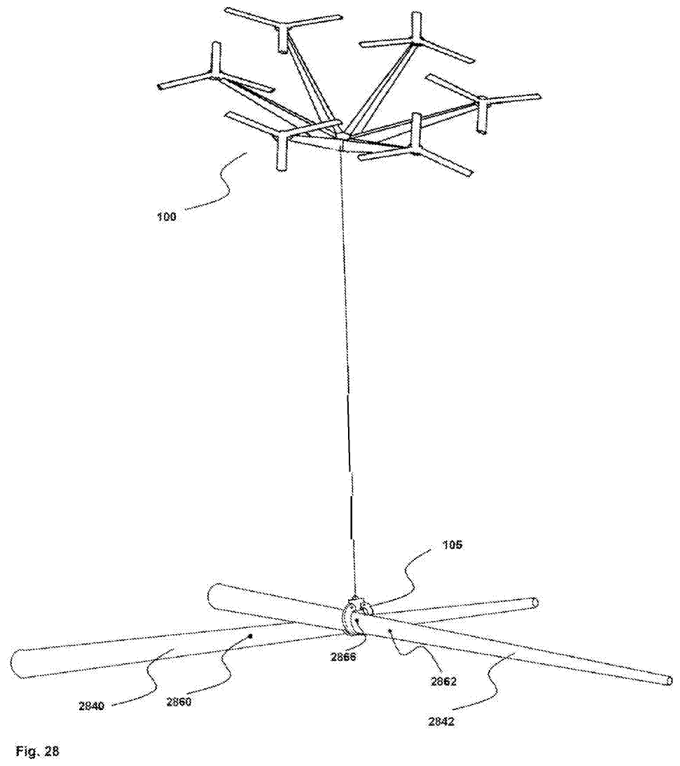

FIG. 28 depicts a first tree trunk 2840 having a first centre of gravity 2860 and a second tree trunk 2842 having a second centre of gravity 2862. A combined centre of gravity 2866 may result in a sprawled tree trunk transportation which in most cases may not be optimal due to inter alia that the time for deposition of the tree trunks may be increased. However, the tree trunks may nevertheless be transported relatively safely using the depicted position.

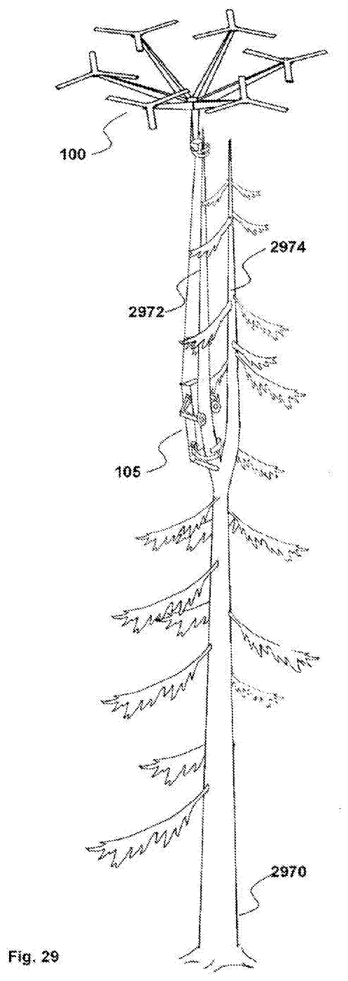

FIG. 29 depicts a tree 2970 with a first tree top 2972 and a second tree top 2974. An UAV 100 with means for holding and/or means for cutting may cut off said first tree top 2972, said second tree top 2974 or both of them.

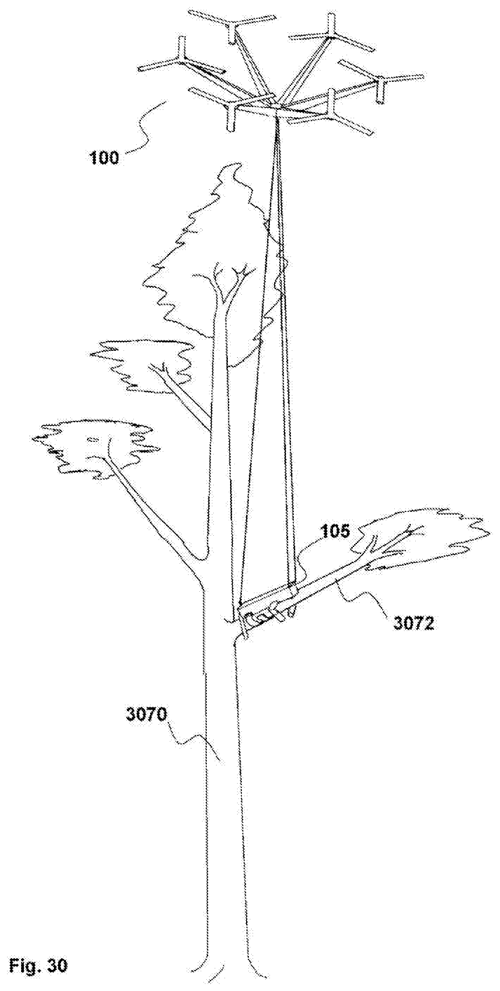

FIG. 30 depicts an UAV 100 with means for holding 105 and/or means for cutting. Said means for cutting may cut off one or a plurality of twigs/branches 3072 from a tree 3070.

FIG. 31 depicts an UAV 100 with holding means 105. Due to a different strength of a tree trunk at a top portion and a bottom portion a holding position may be selected for prohibiting any cracking of the tree trunk during transportation. A holding position too close to the top of the tree trunk may result in breaking the tree trunk in two pieces as shown when holding at a first position 3110 too close to the tree trunk top. A safe holding position 3120 may be provided from detected tree parameters and/or camera detection and/or indirectly from one or a plurality of growing conditions for said tree trunk for prohibiting any damage to the tree trunk during transportation.

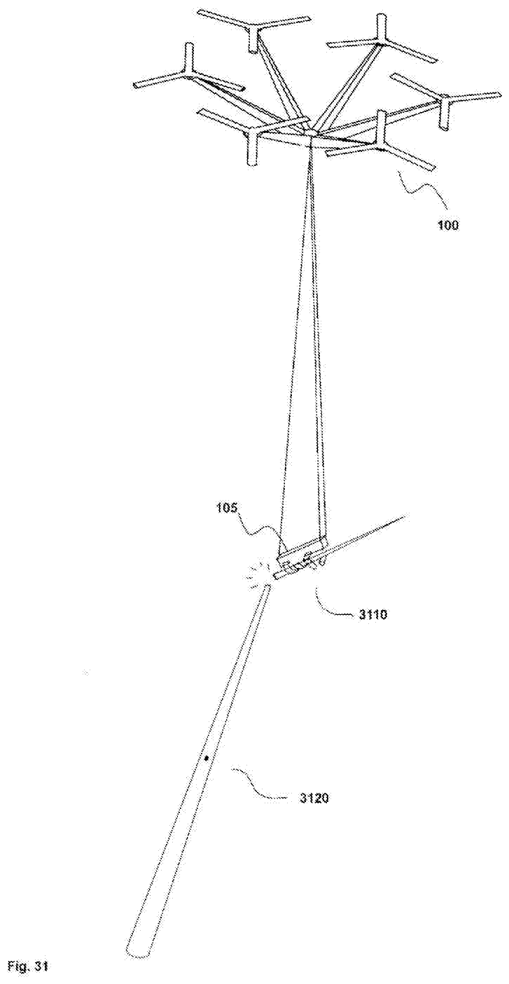

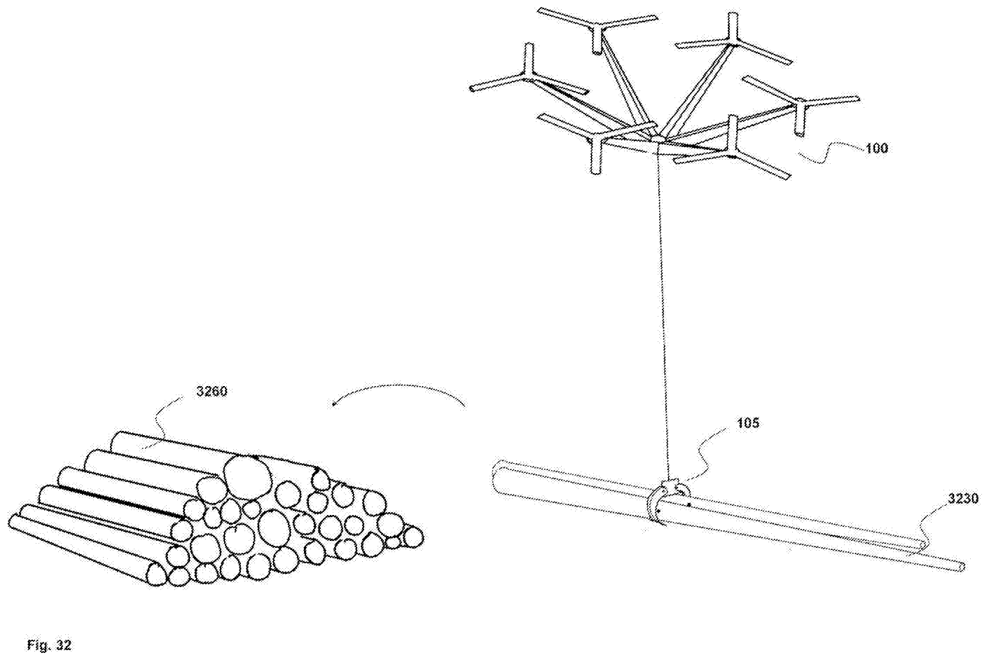

FIG. 32 depicts an UAV 100 provided with a holding means 105. A tree trunk 3230 is held in a horizontal direction. Any deposition of tree trunks starting from a horizontal holding is more efficient than a tree trunk arriving at a final destination having any other direction. This may minimize the time it may take to deposit the tree trunk 3230 in the same manner as the previously deposited tree trunks 3260.

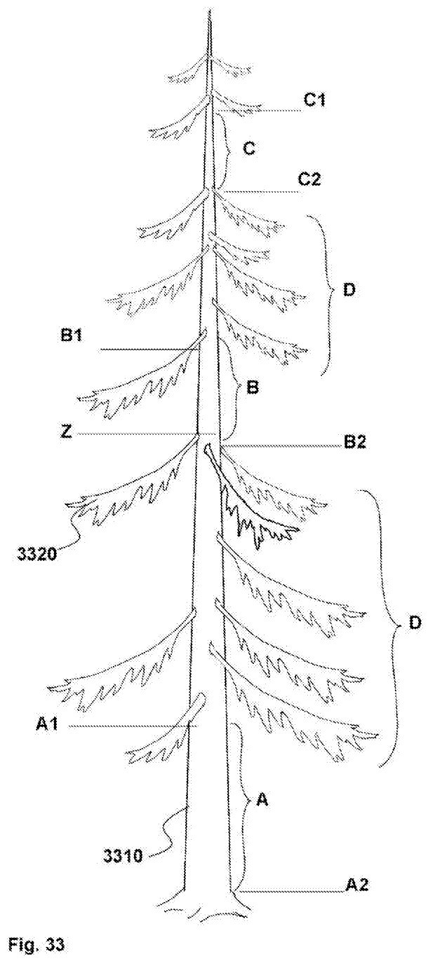

FIG. 33 depicts a tree 3310 with numerous twigs/branches 3320. A suitable holding position for a means for holding may be where sufficient space between twigs/branches is present. In FIG. 33 3 suitable holding positions are denoted by A, Band C. At A, B and C the tree trunk is free from twigs/branches between A1-A2, B1-B2 and C1-C2 respectively. Non-suitable holding positions are denoted by D where they are difficult to reach the tree trunk because of twigs/branches.

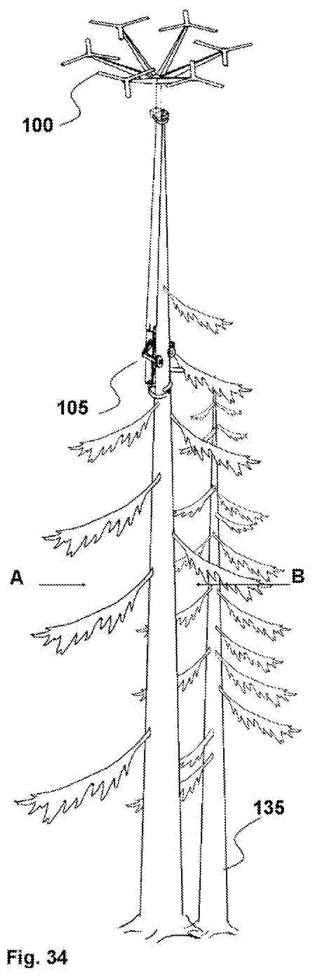

FIG. 34 depicts a first and a second tree close to each other. Possible holding positions in such a case are not only limited by the location of twigs/branches of the tree to be held but also the position of the nearby tree and its twigs/branches.

FIG. 35 depicts a scenario where a tree 3510 is positioned close to a relatively large stone 3520. In such a case the holding position is not only limited by the position of the twigs/branches of the tree but also the location of the stone in relation to the tree. Suitable holding positions are denoted by A and B. At A the tree trunk is free from twigs/branches between A1-A2. At B the tree trunk is free from twigs/branches between B1-B2. At B2 and further down to the ground the stone 3520 is the limiting factor for any holding position.

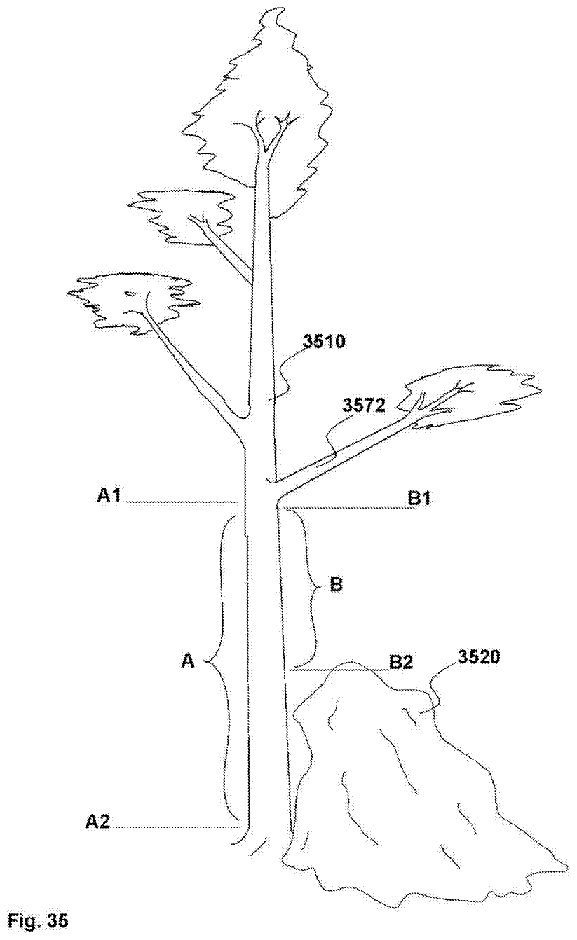

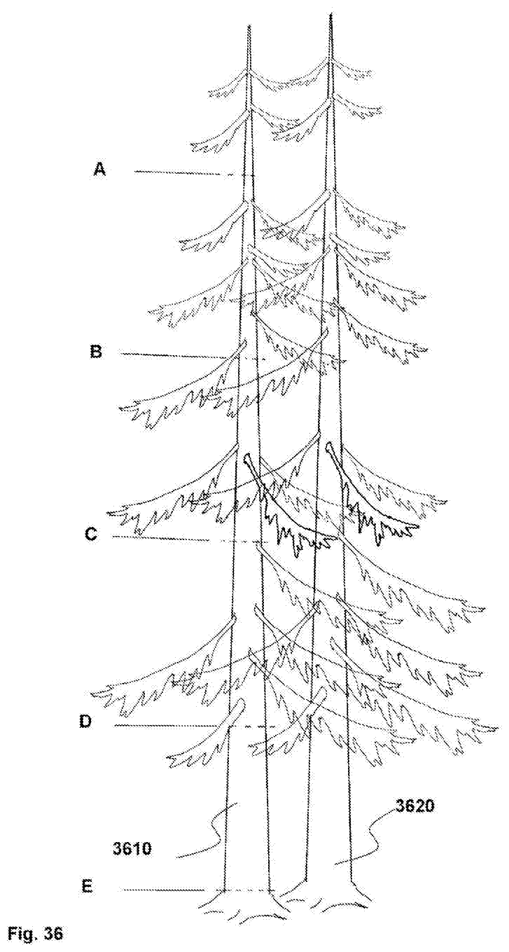

FIG. 36 depicts a first tree 3610 and a second tree 3620. The second tree shall remain unharvested. The first tree 3610 shall be harvested in small portions with cutting positions A-E. The second tree shall remain unharvested due to its higher value/quality whereas the first tree 3610 shall be removed for further increasing the value of said second tree. The first tree may be cut in portions for minimizing the risk of damaging the second tree during harvesting. This may be the case in windy conditions and during particular points of time of the year.

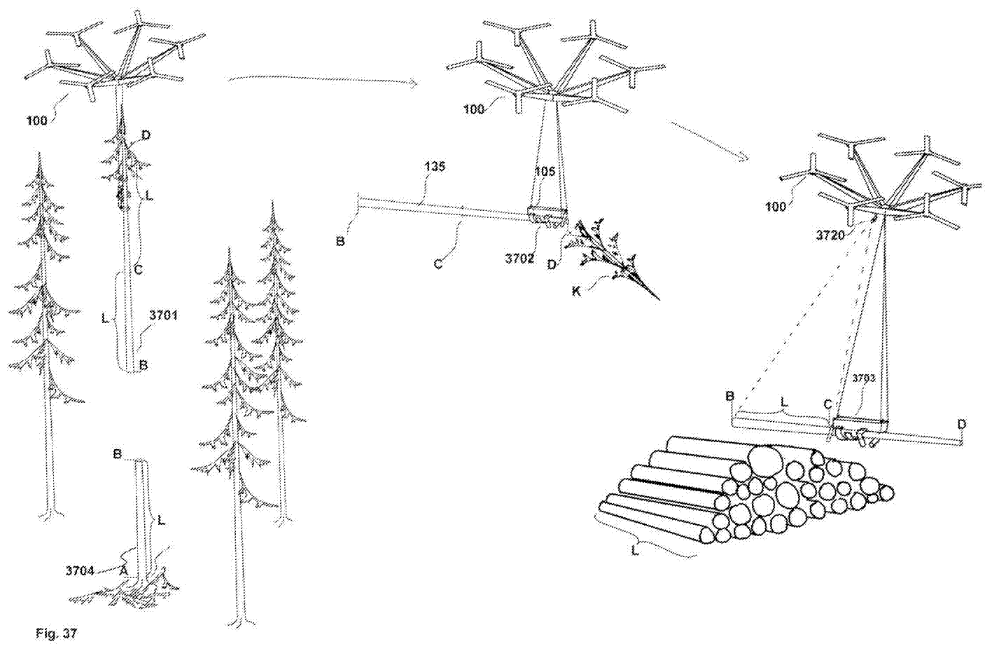

FIG. 37 depicts different cutting scenarios during harvesting. A tree may be cut before transportation, during transportation or after transportation as shown in the top portion in the figure. A top portion of a tree may be harvested first. The top portion may be harvested at a position determined by the remaining length of the tree. In an example embodiment the remaining length of the tree after the top portion has been taken off may be twice the length of tree trunks provided at a final destination. The length may be detected by a camera or being provided from a database. Any holding position of the tree may be altered during transportation or at the final destination enabling cutting the tree at predetermined positions. In FIG. 37A-D denoted different cutting positions resulting in tree trunks having the same length L. 3701-3704 denoted different holding positions of different portions of the tree trunk.

FIG. 38 depicts different cutting scenarios. tree trunk 3801 is illustrated to be cut at different angles with respect to the tree trunk. A catting may be essentially perpendicular to the tree trunk as illustrated with B. A cutting may be angled with respect to the tree trunk as illustrated with A and C. tree trunk 3802 illustrates that a cutting position may be at specific locations D, E or with in an interval D-E, or above a certain point D, or below a certain point E. tree trunk 3803A illustrates a means for cutting and holding 3850 a tree trunk attached to said tree trunk 3803A. A cutting position is determined to be at F. tree trunk 3803B is cut and has created a cutting area H. A wire attached to the UAV, may force the cut portion of the tree trunk to rotate in a predetermined direction illustrated by G by reducing the length of said wire from said UAV to said cutting and holding means 3850. tree trunk 3804A illustrates that a first partial cut I may be made at a first position and a second partial cut J may be made at a second position. Said first and second position may be positioned essentially at the same height of said tree trunk 3804A. Said first and second partial cut I and J respectively may be essentially opposite to each other. In various example embodiments more than 2 partial cuts may be made in order to destabilize a tree trunk, for instance 3, 4, 5 or more. A tree trunk 3804B may be separated by providing at least one means for holding 105 to said tree trunk. Said at least one means for holding is attached via a wire to at least one UAV. The UAV may crack the tree trunk 3804B by its drag force in horizontal and/or vertical direction. The partial cuts I, J may be made at a first point in time whereas the cracking by said UAV and said holding means 105 may be made at a second point in time. Said first and second point in time may be simultaneous or said second point in time may be second, minutes or days after said first point in time. tree trunk 3805A illustrates an example embodiment of partial cuts with an intention to crack the tree in a predetermined direction by wind R or other external forces S. A first partial cut is denoted by P. A plurality of cuts may be made in order to remove a volume O of the tree trunk. Volume O may be removed by a first cut between Land N and a second cut between M and N. Alternatively volume O may be removed by a number of cuts M-N stopping at imaginary line N-L. tree trunk 3805B is broken at Q by wind R or other external forces such as gravity, machine force and/or human or animal force.

A cutting position may be direct or indirect. A direct cutting position is determined by cutting the tree trunk by a means for cutting. An indirect cutting position may be determined by first cutting a tree and the part being cut off is further divided by its own weight during transportation or said cut off portion of the tree trunk may be divided into pieces when falling to ground.

A cutting position may be selected taking into account tree parameters and/or growing conditions. A number of possible cutting positions may be determined out of which a few may actually be used. A cutting position may be for removing a portion of a tree trunk. Alternatively, a cutting position may be a partial cutting where no part of the tree is removed, e.g., a cut less than half a diameter of the tree. A partial cut may be less than 1 cm into the tree trunk. A partial cut may be less than 3 cm into the tree trunk. A partial cut may be less than 10 cm into the tree trunk.

FIG. 39A depicts a road 3910, a river 3920, trees laying on ground 3942 and stumps or remaining portions of the tree 3940. As can be seen from FIG. 39A the trees laying on ground 3942 are not crossing the road 3910 and/or the river 3920. trees laying on ground 3942 are also provided in essentially the same direction to the right of the road and essentially in the same direction to the left of the road, here a large diameter of the tree trunk is pointing in the direction towards the road 3910.

In FIG. 39B trees are provided in random directions and/or positions. In FIG. 39B tree 3922 is crossing the river 3920 and tree 3912 is crossing the road 3910. trees provided as in FIG. 39B will take more time and are more difficult to remove from its location compared to trees arranged as in FIG. 39A.

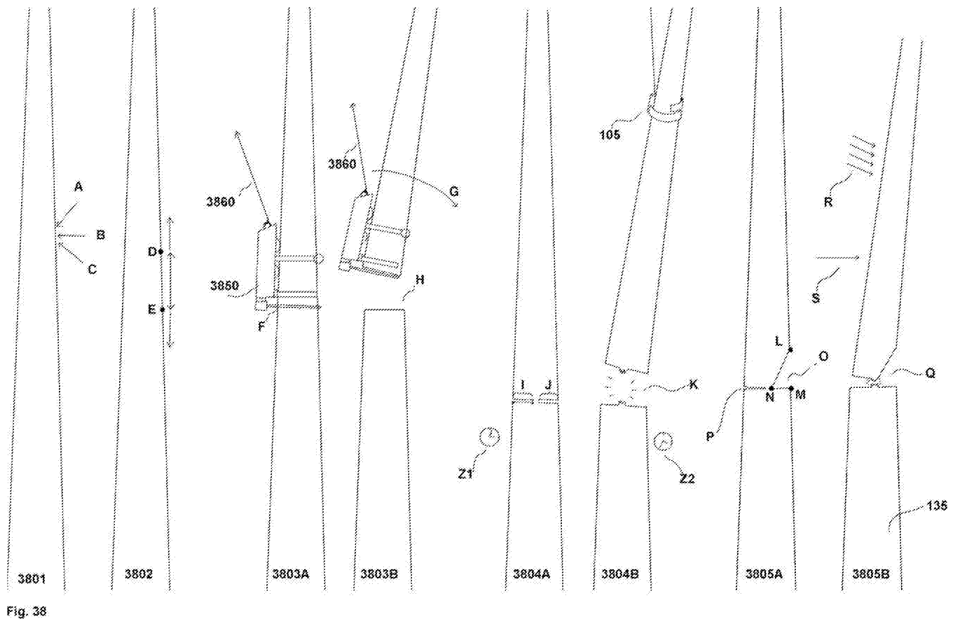

FIG. 40A illustrates a first tree 4020 which is cut and hits another nearby tree 4030 in its fall to ground. Said another tree 4030 may risk to be broken by the hit of said first tree 4020. This may be remedied by harvesting using at least one UAV which will hold the tree during cutting and prohibiting said tree to damage other trees. Using a UAV holding a tree during a cut may also reduce the pressure on the cutting tool during cutting. By providing a force by said UAV in an upward direction of the tree during cutting the weight of the tree onto the cutting tool may be reduced or eliminated reducing or eliminating said cutting tool to be stuck while cutting said tree.

FIG. 40B illustrates a first tree 4022 which has been cut intentionally or unintentionally and has been stuck during its fall a second tree 4032. The second tree 4032 is shown to be bent by the weight of the inclined first tree 4022. Leaving this first tree resting on said second tree for a prolonged time, months, years, may reduce the value of the second tree. Said second tree may start to grow in a vertical direction 4034 inclined from the remainder of the tree 4032.

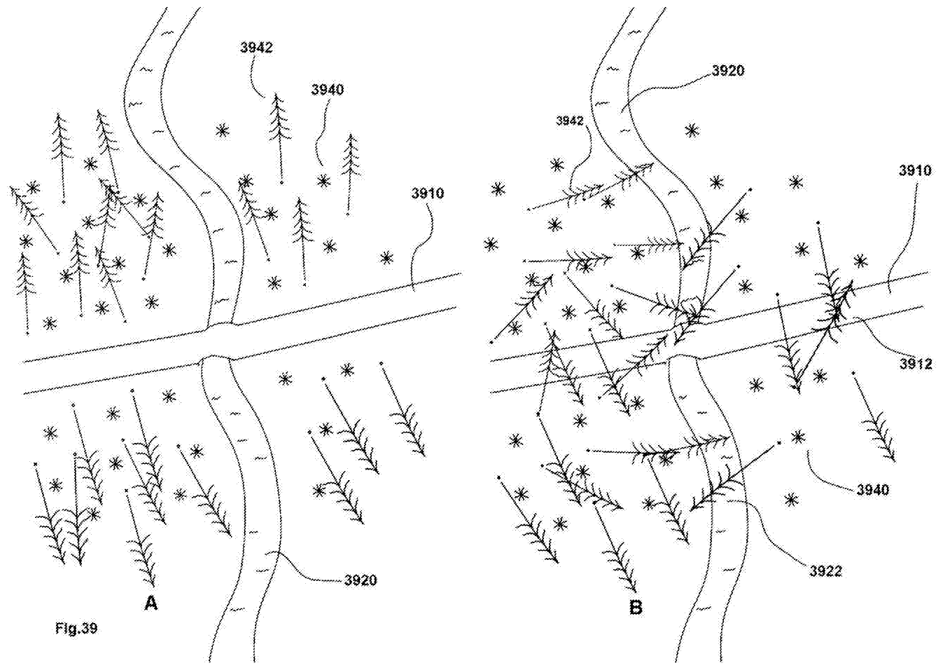

FIG. 41A illustrates a tree 4130 which is cut with a non-perpendicular cutting area with respect to an axes parallel with the tree trunk. By cutting in direction F, tree 4130 may start to glide in direction G and fall in direction E. The cutting area of tree 4130 may follow hatched lined H during its fall and land at a distance I from the stump/remaining portion of the tree 4140. The height J of the stump/remaining portion of the tree 4010 is one determining factor for said distance I.

FIG. 41 B illustrates a first tree 4134 and a second tree 4132, 4142. By cutting the second tree 4132 in sections M, M/2 it may be possible to reduce its length and prohibiting branches of said first tree 4134 to stuck in branches of said second tree 4132. By cutting said second tree 4132 in sections of M it may be possible to reduce its top position to be below the lowest branch of said first tree 4134 thereby allowing to fell said second tree 4132 in direction N without risking to get stuck in branches of said first tree 4134.

FIG. 41C illustrates a method of cutting a tree using an UAV 100 and a means for cutting 4110. By accelerating the cutting in direction X during cutting it may be possible to throw/move a tree 4136 a distance Z from its stump 4144. This may be useful when trying to avoid any tree in a sensitive area in the Z region.

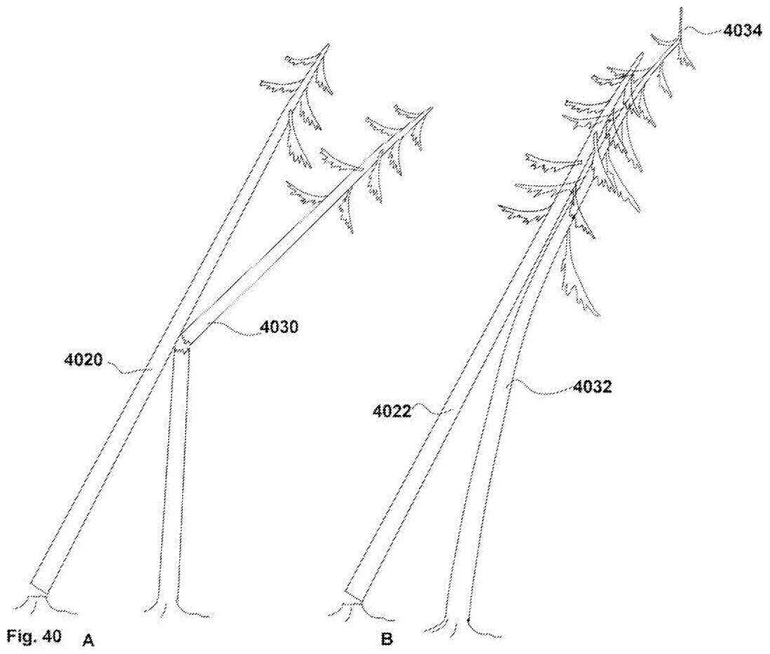

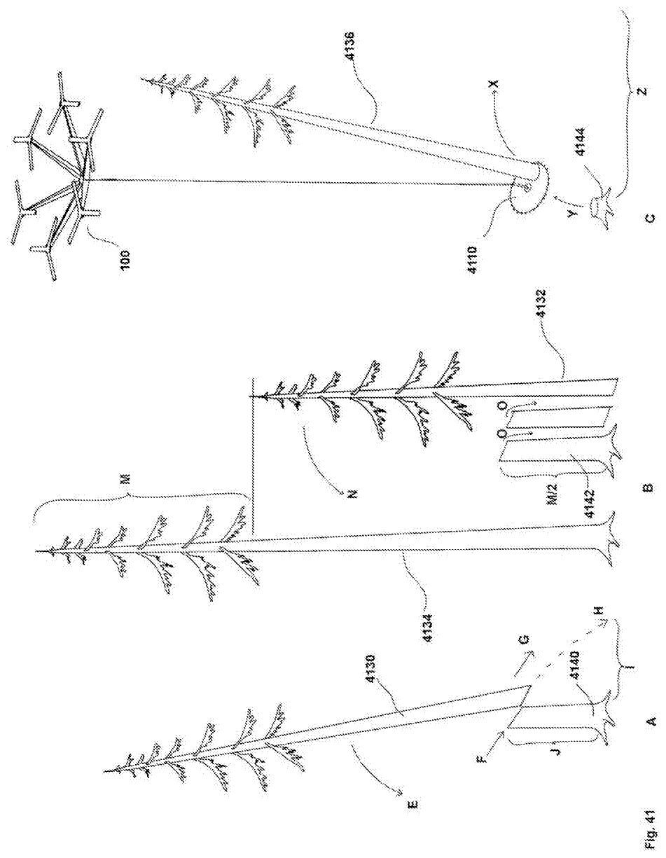

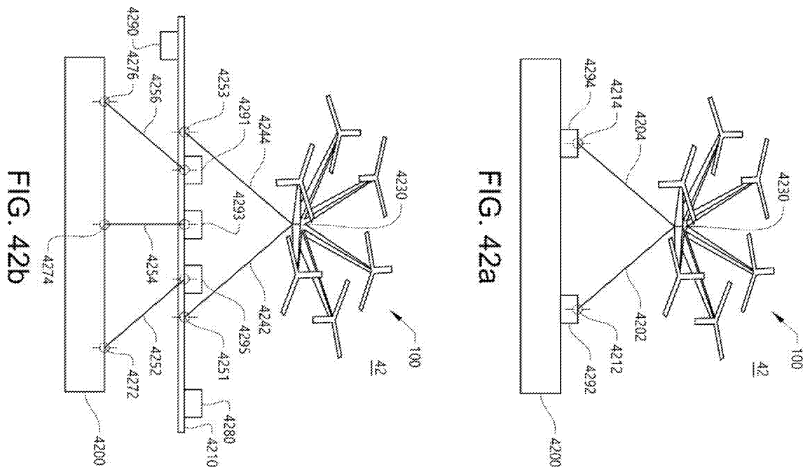

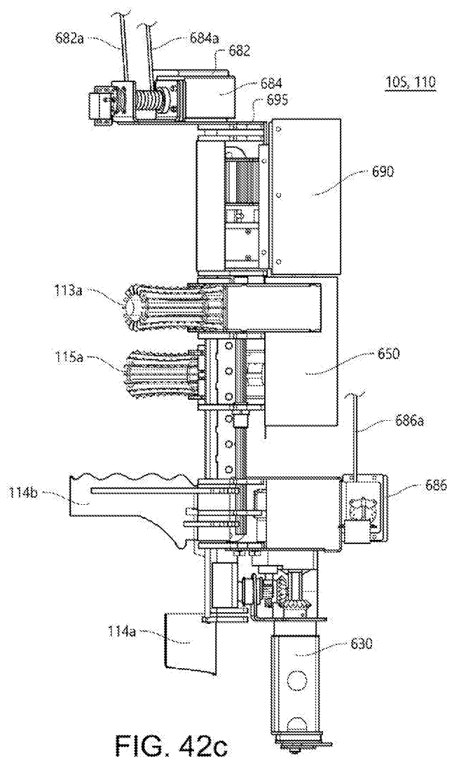

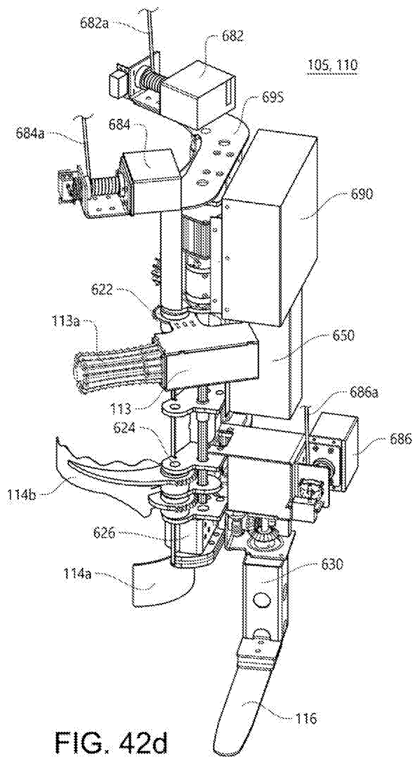

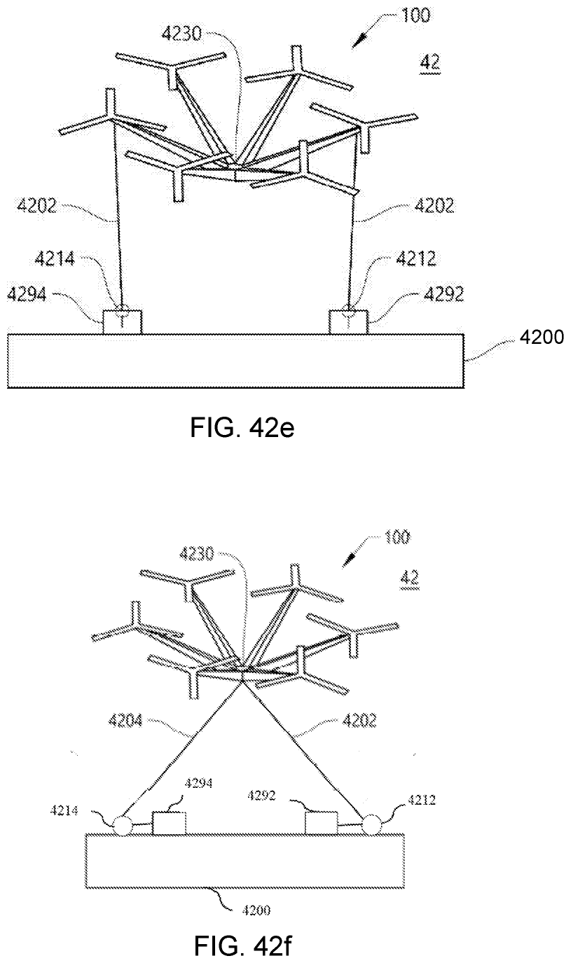

FIG. 42a illustrates a first example embodiment of an Unmanned Aerial System (UAS) comprising a device 4200 connectable to an UAV 100 according to the present invention. An UAS is a UAV together with equipment to control it remotely and a command and control data system/link connecting the UAV and controller so that they can communicate. Said device 4200 comprising a first pivot point 4212 and a second pivot point 4214 being spaced apart from each other, said first pivot point 4212 is connectable a UAV 100 via at least one first cord 4202 and said second pivot point 4214 is connectable the UAV 100 via at least one second cord 4204. Said device 4200 is configured to be tilted/rotated around said first pivot point 4212 by adjusting a length of said second cord 4204 and/or tilted/rotated around said second pivot point 4214 by adjusting a length of said first cord 4202, wherein said device 4200 has a first winch motor 4292 provided at said first pivot point 4212 and a second winch motor 4294 provided at said second pivot point 4214, said first and second winch motor 4292, 4294 are configured for adjusting the length of said first and second cord 4202, 4204 respectively.

In one embodiment of the invention there is a device 4200 for an Unmanned Aerial Vehicle, UAV 100. The device 4200 comprises a first pivot point 4212 and a second pivot point 4214 being spaced apart from each other, the first pivot point 4212 and the second pivot point 4214 are connectable to a UAV 100. In one embodiment they are connected via a first 4202 respective second 4204 cord. The device 4200 is configured to be tilted/rotated around the first pivot point 4212 by adjusting a length of the second cord 4204, and/or tilted/rotated around the second pivot point 4214 by adjusting a length of the first cord 4202. The device 4200 further has a first winch motor 4292 and a second winch motor 4294. The winch motors are configured to adjust the length of the first and second cords 4202; 4204. In one embodiment the winch motors 4292; 4294 are provided at respective pivot point 4212; 4214.

In one embodiment, schematically illustrated in FIG. 42f the first winch motor 4929 and the second winch motor 4212 are provided at the device 4200. The first pivot points are 4212 is provided at a distance from the first winch motor 4292 and the second pivot point 4214 is provided at a distance from the second winch motor 4294. In one embodiment the first 4212 and second 4214 are provided at the device 4200. The first cord 4202 connects the first winch motor 4292 to the UAV 100 via the first pivot point 4212. The second cord 4204 connects the second winch motor 4294 to the UAV via the second pivot point 4214.

In various example embodiments, rods may be used instead of cords in between said UAV 100 and said device 4200.

Said device 4200 may be a harvesting tool 105, 110 configured for holding and/or cutting at least a portion of a tree or a payload carrying device for carrying timber or goods as depicted in relation to the figures hereinabove and hereinbelow.

Said harvesting tool 110 may comprise a base structure 650, said base structure may have attached to it at least one cutting means for delimbing a tree 114a, 114b, at least one means for communicating with said UAV 100 and/or a remote base station, at least one cutting means for cutting a tree trunk 116, at least one attaching means to be attachable to at least one UAV 660, at least one holding means for holding a tree trunk 105, 107a, 107b, 114a, 114b.

Said cutting means for cutting a tree trunk 116 may be foldable/rotatable with respect to said base structure 650 in at least a resting position, a delimbing position and a tree trunk cutting position.

In various example embodiments said device 4200 may further comprise a third pivot point spaced apart from said first and second pivot points. Said third pivot point may be spaced apart from a straight line between said first and second pivot points. Said third pivot point is connectable to said UAV 100 via at least one third cord. Said device 4200 is configured to be tilted/rotated around at least said third pivot point by adjusting a length of said first cord and/or said second cord. Said device 4200 is configured to be tilted/rotated around at least said first pivot point by adjusting a length of said second cord and/or said third cord. Said device is configured to be tilted/rotated around at least said second pivot point by adjusting a length of said first cord and/or said third cord. Said device may have a third winch motor provided at said third pivot point, said third winch motor is configured for adjusting the length of said third cord. The first and second winch motors 4292, 4294 may be operated one at a time or simultaneously. For instance may a predetermined tilt clockwise around second pivot point 4214 be made by increasing the length of the first cord 4202 only. In an alternative embodiment a clockwise tilt around pivot point 4214 may be made by increasing the length of the first cord 4202 while the length of the second cord 4204 may be decreased. The same applies for the first pivot point 4212 mutatis mutandis. In FIG. 42a, 42b the UAV 100 is exemplified as one UAV 100 having 4 rotors, the invention applies to various types of UAV, one or plurality of UAV and UAV having 4 or more rotors.

FIG. 42b illustrates another example embodiment of a UAS according to the present invention. Here a tilt structure 4210 is provided in between the UAV 100 and the device 4200. Said tilt structure 4210 has at least one anchor point 4251, 4253 connectable to said UAV 100. The UAV 100 and said tilt structure 4210 may be connected to each other via at least one cord 4242, 4244, at least one rigid pipe and/or at least one telescopic structure. In various example embodiments, said tilt structure 4210 may be directly and rigidly attached to said UAV 100. Said tilt structure 4210 and said device 4200 are connectable to each other via at least a first cord and a second cord. In FIG. 42b the tilt structure 4210 is connected to said device 4200 via a first cord 4252, a second cord 4254 and a third cord 4256. Said first cord 4252 is attached to said device 4200 at a first pivot point 4272, said second cord 4254 is attached to said device 4200 at a second pivot point 4274 and said third cord is attached to said device 4200 at a third pivot point 4276. Said third pivot point may be spaced apart from a straight line between said first and second pivot point. Said first, second and third cords 4252, 4254, 4256 may be removably attached to said device 4200. Said first cord 4252 may be attached to said tilting structure 4210 at a first winch motor 4295. Said second cord 4254 may be attached to said tilting structure 4210 at a second winch motor 4293. Said third cord 4256 may be attached to said tilting structure 4210 at a third winch motor 4291.

Said tilting structure 4210 may be provided with at least one battery pack 4280 for at least powering the winch motors 4291, 4293, 4295. Said tilting structure 4210 may further be provided with a control unit configured for communicating with said UAV 100 and/or said device 4200.

In various example embodiments at least one winch motor may be provided on said tilt structure 4210 instead of on said device 4200. In various example embodiments the UAV may have a first winch motor having a cord connecting said UAV and said tilt structure together. The tilt structure 4210 may have at least one winch motor having a cord connecting said tilt structure 4210 and said device 4200. The device 4200 may have at least one winch motor having a cord connecting said tilt structure 4210 and said device 4200 together.

The tilt structure 4210 may be plate-like or in the form of a network structure. The plate may be made of metal, polymer, carbon fibre, kevlar or ceramic material. The tilt structure 4210 may be an adapter for a UAV 100 of various types with devices 4200 of various types. The distance between the tilt structure 4210 and said device 4200 may be varied by means of said winch motors provided on said tilt structure 4210 and/or said device 4200. The distance between said UAV 100 and said device 4200 and/or said tilt structure 4210 may be varied by means of said winch motors provided on said UAV 100, tilt structure 4210 and/or said device 4200.

FIGS. 42c and 42d illustrates another example embodiment of a means configured for harvesting at least a portion of a tree 110 and said means for holding said tree 105. Said means configured for harvesting at least a portion of a tree 110 and said means for holding said tree 105 may be provided at a distance from said UAV 100, here via a plurality of wires 682a, 684am 686a.

The holding means is in this example embodiment in the form of a first wheel 113a and a second wheel 115a. Said first wheel 113a is provided on a first movable arm 113 and said second wheel 115a is provided on a second movable arm 115 (not shown). said first and second arms 113, 115 can be set to any position between a fully open position and fully closed position in order to allow to embrace a tree trunk and also to grip and release the same. The first arm 113 may rotate around a rotational axes 622.

The wheels 113a, 115a may be configured to roll on the surface of a tree trunk. The wheels may be made of metal and be provided with friction increasing ribs in order to increase traction of said wheel against the surface of the tree trunk and avoid or minimize the risk of slipping. The wheels 113a, 115a may be motorized. The wheels 113a, 115a may roll against a surface of a tree trunk and thereby move the means configured for harvesting at least a portion of a tree 110 and said means for holding said tree 105 from one position to another on said tree trunk. The wheels 113a, 115a may be pressed against the surface of a tree trunk with a predetermined pressure by movement of said first and second arms 113, 115 respectively. The wheels may lock onto a predetermined position of said tree trunk and thereby allow safe movement/transport of said tree trunk away from its original position. The first and second arms 113, 115 may be movable attached to said base structure 650. The means configured for harvesting at least a portion of a tree 110 and said means for holding said tree 105 further comprising the above mentioned first movable curved fixing/delimbing arm 114a and a second movable curved fixing/delimbing arm 114b. The first delimbing arm may move around a rotational axes 626. The second delimbing arm 114b may move around a rotational axes 624.

Said first and second movable curved fixing/delimbing arms 114a, 114b may be set to any position between a fully open position and fully closed position on order to allow to embrace a tree trunk and also to fixing the same. Said fixing/delimbing arms may have a sharp edge on its top portion and/or its bottom portion for delimbing the tree as the means configured for harvesting at least a portion of the tree moves along the trunk of said tree. Said means configured for harvesting at least a portion of a tree 110 also comprises a cutter 116. The cutter may be in the form of an electrically driven or internal combustion engine driven chain saw. The chain saw may be arranged movable in said means 110 in order to cut a tree while said means is in a fixed position on said trunk of the tree.

The delimbing means 114a, 114b may be optional. The holding means 105 may be provided at a distance from said means configured for harvesting at least a portion of a tree 110. Said holding means 105 may be attached at said means configured for harvesting at least a portion of a tree 110 with at least one wire or at least one metal bar or other suitable attaching means.

The holding means 105 and the means configured for harvesting at least a portion of a tree 110 may communicate with each other and/or independently of each other communicate with the UAV and/or the base station 120. A camera may be used, attached either on said UAV or said may be used for means configured for harvesting at least a portion of a tree 110, in order to simplify attachment of said UAV with said means configured for harvesting at least a portion of a tree 110.

In various example embodiments said means configured for harvesting at least a portion of a tree 110 may be made of two separable parts, a first part that is mainly configured for holding the tree and a second part, capable of moving up and down along the trunk of the tree, which can delimb and/or cut the tree.

Said means for holding 105 may change its position onto said tree trunk during cutting, delimbing, harvesting, transporting and/or debarking said tree trunk.

The base structure 650 further comprising a first winch motor 682, a second winch motor 684 and a third winch motor 686. Said first winch motor 682 and second winch motor 684 may as depicted in FIGS. 42c and 42d be provided at a distance from each other in a top portion 695 of said means configured for harvesting at least a portion of a tree 110 and said means for holding said tree 105. The third winch 686 motor may be provided at a distance from said first and second winch motors 682, 684. Said first winch motor is provided with said first wire or cable 682a, said second winch motor 684 is provided with said second wire or cable 684a and said third winch motor is provided with said third wire or cable 686a. Said first, second and/or third cables or wires may be extended or retracted individually and independently of each other by said respective winch motors. By changing the length of one or a plurality of wires or cables 682a, 684a, 686a said means configured for harvesting at least a portion of a tree 110 and said means for holding said tree 105 may be tilted in a desired orientation and/or its distance relative to the UAV may change, increase or decrease. Said means configured for harvesting at least a portion of a tree 110 and said means for holding said tree 105 may further comprise a control unit 690. Said control unit 690 may be provided with battery power for powering the first, second and third winch motors 682, 684, 686, said first and second arms 113, 115 and said first and second wheels 113a, 115a, said chain saw 116 and the relative movement of said chain saw with respect to said base structure 650 as described hereinabove.

FIG. 42e illustrates another example embodiment of a UAS according to the present invention. The difference between this embodiment and the one in FIG. 42a is the attachment of the cord to the UAV. In FIG. 42a the cords are attached to the centre of the UAV. In FIG. 42e the cords are attached away from the centre of the UAV. In FIG. 42e the cords are attached to the arms carrying the propeller motors, here illustrated to be attached under the propeller motors. It is evident that the attachment point of the cords can be anywhere on the arms from the centre position to its distal end. By attaching the cords away from the centre the device 4200 can be tilted by tilting the UAV 100. In various example embodiments the at least two winch motors may be provided next to each other on the device or harvesting tool.

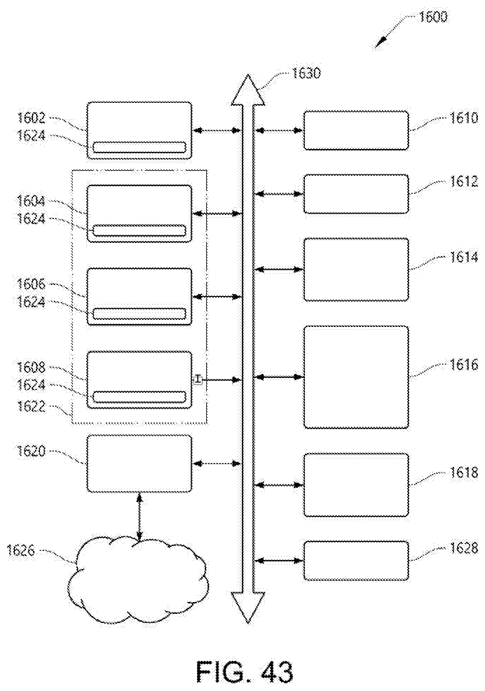

FIG. 43 illustrates a block diagram of an example machine 1600 upon which any one or more of the techniques (e.g., methodologies) discussed herein may perform. Examples, as described herein, may include, or may operate by, logic or a number of components, or mechanisms in the machine 1600. Circuitry (e.g., processing circuitry) is a collection of circuits implemented in tangible entities of the machine 1600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1600 follow.

In alternative embodiments, the machine 1600 may operate as a standalone device or may be connected (e.g., networked) to other machines. In a networked deployment, the machine 600 may operate in the capacity of a server machine, a client machine, or both in server-client network environments. In an example, the machine 1600 may act as a peer machine in peer-to-peer (P2P) (or other distributed) network environment. The machine 1600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1600 may include a hardware processor 1602 (e.g., a central processing unit (CPU), a graphics processing unit (GPU), a hardware processor core, or any combination thereof), a main memory 1604, a static memory (e.g., memory or storage for firmware, microcode, a basic-input-output (BIOS), unified extensible firmware interface (UEFI), etc.) 1606, and mass storage 1608 (e.g., hard drive, tape drive, flash storage, or other block devices) some or all of which may communicate with each other via an interlink (e.g., bus) 1630. The machine 1600 may further include a display unit 1610, an alphanumeric input device 1612 (e.g., a keyboard), and a user interface (UI) navigation device 1614 (e.g., a mouse). In an example, the display unit 1610, input device 1612 and UI navigation device 1614 may be a touch screen display. The machine 1600 may additionally include a storage device (e.g., drive unit) 1608, a signal generation device 1618 (e.g., a speaker), a network interface device 1620, and one or more sensors 1616, such as a global positioning system (GPS) sensor, compass, accelerometer, gyro, optical sensors or other sensor. The machine 1600 may include an output controller 1628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1602, the main memory 1604, the static memory 1606, or the mass storage 1608 may be, or include, a machine readable medium 1622 on which is stored one or more sets of data structures or instructions 1624 (e.g., software) embodying or utilized by any one or more of the techniques or functions described herein. The instructions 1624 may also reside, completely or at least partially, within any of registers of the processor 1602, the main memory 1604, the static memory 1606, or the mass storage 1608 during execution thereof by the machine 1600. In an example, one or any combination of the hardware processor 1602, the main memory 1604, the static memory 1606, or the mass storage 1608 may constitute the machine readable media 1622. While the machine readable medium 1622 is illustrated as a single medium, the term “machine readable medium” may include a single medium or multiple media (e.g., a centralized or distributed database, and/or associated caches and servers) configured to store the one or more instructions 1624.

The term “machine readable medium” may include any medium that is capable of storing, encoding, or carrying instructions for execution by the machine 1600 and that cause the machine 1600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1624 may be further transmitted or received over a communications network 1626 using a transmission medium via the network interface device 1620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi (R), IEEE 802.16 family of standards known as WiMax (R)), IEEE 802.15.4 family of standards, peer-to-peer (P2P) networks, among others. In an example, the network interface device 1620 may include one or more physical jacks (e.g., Ethernet, coaxial, or phone jacks) or one or more antennas to connect to the communications network 1626. In an example, the network interface device 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1600, and includes digital or analog communications signals or other intangible medium to facilitate communication of such software. A transmission medium is a machine readable medium.

In various example embodiments of the present invention it is provided a method for controlling the relative rotation between a UAV and a device. The device is attached to said UAV via at least two cords according to any one of the example embodiments disclosed hereinabove. Said method for controlling the relative rotation between the UAV and the device comprising the steps of determining a reference rotational position of said device relative to said UAV, detecting an angular rotation R in a horizontal plane of said device relative to said reference position, and compensating said angular rotation in said horizontal plane of said device by rotating said UAV in said horizontal plane in the same direction and by the same angular rotation R as said device for prohibiting twisting of said cords.

The reference rotational position of said UAV relative to said device may for instance be a position where the at least two cords are perfectly straight between said UAV and said device. In various example embodiments said reference position may be a position where said device and said UAV are rotated relative to each other at a predetermined angle, which angle is less than 30 degrees out of the state where said cords are perfectly straight. The relative movement of the UAV and the device may be constantly monitored. Any deviation from the reference position, or any angular rotation above a predetermined angle may trigger the UAV to rotate in the horizontal plane in the same direction as the rotation of the device in order to prohibit any twisting of said at least two cords attaching said UAV with said device.

A sensor for detecting angular rotation may be at least one of the group of accelerometer, gyro and/or optical sensor. Said sensor(s) are configured to detect the rotational position of the device relative to the UAV. Angular compensation rotation of said UAV may be performed autonomously. The compensation rotation of the UAV may be with essentially the same angular rotation and in the same direction as the rotation R of the device relative to the UAV from a reference position. The measurement of the relative rotation between the device and said UAV may be continuously or with a predetermined time interval. Said predetermined time interval may be in the range of micro or nano seconds. The cords between said UAV and said device may be coupled to at least one winch motor for allowing extension and/or retraction of said cord. The idea of not twisting the cords is that the extension and/or retraction of said cords should be independent of each other which will not be the case if said cords are twisted into each other. The attachment of said cords to said UAV may be to the centre of said UAV or provided to any one of said arms carrying said propeller motors. By providing the attachment point displaced from the center position of said drone opens up for the possibility to tilt the UAV in any direction for tilting the device in the same direction.

In various example embodiments said UAV and said means configured for harvesting at least a portion of a tree may be separated from each other and reconnected with each other. One or a plurality of cameras or other suitable position sensors may be used for the reconnection procedure.

In various example embodiments a plurality of UAV is used for transporting a plurality of tree.

The means configured for harvesting at least a portion of a tree may optionally be capable for moving on ground. The movement may be with legs, wheels or other suitable moving means.

In various example embodiments of the present invention a digital transmitter may be attached to a tree for communication with a control unit and/or at least one UAV and/or at least one means for harvesting at least a portion of a tree. Said digital transmitter may not only send out the position of said tree it is attached to but also send out information about distance to neighbour tree, the terrain, the diameter of the tree, the final destination of a non-harvested tree and/or other quality parameters of the tree such as type and/or curved trunk. The digital transmitter may be attached to the tree by a UAV, land vehicle, robot or by a human. The digital transmitter function may also be implemented as a pure software digital recognition function by unique features of the tree such as tree rings, limb pattern or tree bark.

The harvesting tool 105, 110 may be sold disassembled in a kit form. Said kit may comprise a base structure 650, at least one cutting means for delimbing a tree 114a, 114b configured to be attached to said base structure, electronics configured for communicating with a UAV and/or a remote base station, at least one cutting means for cutting a tree trunk 116 configured to be attached to said base structure, at least one attaching means 660 to be attachable to at least one UAV, at least one holding means for holding a tree trunk 105, 107a, 107b, 114a, 114b configured to be attached to said base structure. Optionally said kit may comprise one or a plurality of power units in the form of one or a plurality of battery packs.

The digital transmitter may be used to determine which tree to be harvested, where to move the harvested tree in order to simplify transportation logistics. A digital transmitter may be used to move tree/timber of different quality to different locations by said UAV. A digital marking may be used to determine which UAV and/or means for harvesting at least a portion of a tree trunk to be used. The digital information may be used for using one or a plurality of UAV depending on the size of the tree to be harvested. The digital marking may be used for tree thinning. The digital marking may be used in combination with a remote harvesting planning and/or tree thinning process prior to the actual harvesting. With digital marking a map of trees in a predetermined area may be used for guiding the UAV to the correct tree to be harvested. The digital marking may also determine in which order the tree shall be harvested in order to reduce the harvesting time. The digital marking may be used to estimate a future harvesting time. The digital marking may be used to determine which type of tree there are in a particular area, the distance between tree in a particular area, the topography of the land where tree are to be harvested, the height of the tree, the quality of the tree, the form of the tree, the diameter of the tree. The digital marking may determine prior to harvesting that the tree shall be cut in portions. The digital marking may be used to mark the different portion of the harvested tree weight.

In various example embodiments of the present invention the quality of a harvested tree may be predicted by studying at least one intrinsic parameter i.e., tree parameter and/or at least one extrinsic parameter i.e., growing condition.

In various example embodiments of the present invention detected spectral properties and/or spatial structures of a portion of a tree may be used as input for detecting tree parameters and/or growing conditions of at least a portion of said tree. Spectral properties and spatial structures may be detected on a microscopic and/or macroscopic level.

In various example embodiments of the present invention detected spectral properties and/or spatial structures of a tree's surrounding environment within a pre-determined distance may be used as input for detecting tree parameters and/or growing conditions of a portion of a tree. Spectral properties and spatial structures may be detected on a microscopic and/or macroscopic level.

Shape of leaves or fir needles may be used as a tree parameter.

Spectral properties and/or spatial structures may be from a cut surface of a tree, a tree trunk, a tree branch, tree leaves/fir needles and/or a tree leaves/fir needles. It may also be the spectral properties and/or spatial structures of vegetation, species and/or the ground within a pre-determined distance from said tree. Spectral and/or spatial properties may be evaluated on pixel level.

In various example embodiments of the present invention spatial properties of the tree to be harvested and/or transported and/or the spectral properties and/or the spatial structure of the ground and/or surrounding may be used as input for determining the final destination of at least a portion of a tree and/or for determining if a portion of a tree is to be harvested. Spatial properties may be detected on a microscopic and/or macroscopic level. Spatial properties may be from a cut surface of a tree, a tree trunk, a tree branch and/or a tree leaves/fir needles. Spatial properties may be evaluated on pixel level.

The spatial properties of a tree may be used as an intrinsic parameter of a tree for predicting its quality. Various sensors may be used for determining temperature and/or humidity which in turn may be used for predicting the quality of the tree.

The length of a tree may be the cut portion laying on ground waiting for transportation. The length may be the total length above sea level. The length may be the total length above ground. The length may be the length of a particular tree in comparison with at least one other tree.

In various example embodiments a tree parameter may vary within a single tree (tree, bush). A tree parameter may also vary between tree of the same species. A tree parameter may also vary between tree of different species. A tree parameter may be the temperature of the tree. The temperature of the tree may be an indication about the health and thereby the quality of the tree.

A tree parameter may for instance be a chest height diameter of the tree trunk or a branch.

A tree parameter may be various types of tree deformations.

A tree parameter may be the number of branches and its location on a tree. A tree parameter may be the shape of the branches. A tree parameter may be the number of dry branches or a dry branch.

A tree parameter may be defects generated by weather, e.g., storm, fire, torrential rain, dry periods etc. In various example embodiments, a particular type of tree may not be harvested within a predetermined time period after a rainy season such as birch.

A tree parameter may be a tree gene or a set of genes. tree genes may be detected in a lab. tree genes may also be present together with the position of the tree when sowing the tree.

A tree parameter may be the number of leaves or fir needles. The number of leaves or fir needles may be estimated by detecting a spectral density per unit area.

A growing condition may be hydrology of a predetermined area. Hydrology may be the presence of running water and/or soil moisture.

A growing condition may be climate and/or meteorological variables such as wind, humidity, air pressure, radiation etc. A growing condition may be the weather during a particular season, a depth of snow, average wind speed, sensitivity to storm damage. A temperature, fire and/or snow depth etc. during a particular time-period may be a determining factor to harvest or not and/or if special equipment is needed.

Abiotic factors such as soil quality may be a growing condition and a determining factor for tree parameter. Abiotic factors in combination with a detection of annual rings, the shape of the tree, and/or surrounding vegetation may give a good indicator of the quality of a tree. Visual inspection of a tree in combination with historical weather data may give a strong indication of the quality/value of a tree.

A final destination of a tree may not only be determined in longitude and latitude but also in height above ground level or sea level. The height and/or spatial position in relation to other portions of trees, ground or other objects variables may be useful if different types of tree parameters are to be stored on the same location but being transported to yet another location at different times. The final destination may be a fixed position, a vehicle, but also a position in relation to another object, portion of the landscape and/or a predetermined area or volume. The knowledge about the spatial location of a particular tree parameter in a pile of tree trunks may be logistically advantageous.

A growing condition and/or a tree parameter may determine the final quality of wood such as flat bend, edge bend and/or skew.

In various example embodiments a tree may be cut in several portions and said portions may be laid on ground. One of the smallest portions may be transported first and based on at least one of its tree parameters the weight of the remaining portions may be estimated.

Cutting a portion of a tree or a number of full trees may be performed for increasing the value of the remaining portion of the forest.

A cutting position may be chosen in order to damage the tree but not remove any parts from the tree, i.e., one or several cuts may be applied onto said tree so that said tree may die within a predetermined time period. A cutting position may be chosen in order not to harvest the tree but in order to destabilize the tree so that the tree in a future windy condition may fall by itself.

The cutting position may be chosen in order to remove a particular portion of a tree such as a portion of a tree trunk. The cutting position may be chosen in order to maximize the value of the harvested tree trunk. The cutting position may be chosen in order to increase the value of the remaining unharvested portion of the tree. The cutting position of a tree trunk may depend on at least one detected tree parameter and/or at least one detected growing condition of at least a portion of a tree. The cutting position may depend on the final customer and/or the specific use of the harvested trunk. The cutting position may depend on the lifting capacity of one or a plurality of UAV. The cutting position may depend on the distance from the original cutting location and the final destination of the harvested tree trunk. The cutting position may depend on the time of the year the tree is harvested. The cutting position may depend on the weather condition during harvesting. The cutting position may depend on a specific load capacity of a timber truck. The cutting position may depend on specific defects in a tree such as fungal infestation and insect infestation. The cutting position may be chosen in order to maximize the value of the trees in the vicinity of the cut tree.

In various example embodiments at least one remotely and/or autonomously controlled means for holding (105) at least a portion of a tree trunk is attachable to said UAV. The means for holding (105) may be used for holding onto the tree trunk while transporting said tree trunk and/or holding onto the tree trunk while harvesting the tree and/or holding onto the tree while delimbing and/or debarking the tree. Holding may mean gripping the tree trunk or resting the tree trunk against said means for holding. In various example embodiments means configured for directing said means for holding at least a portion of a tree trunk to a particular position of said tree trunk depending on said at least one detected tree parameter and/or said at least one detected growing condition. The holding position may be dependent on the location of branches on said tree trunk, the balancing of the tree trunk while transporting it, the positioning of the tree trunk in sad means for holding for prohibiting damaging of surrounding trees/tree trunks, prohibiting movement of the tree trunk while debarking and/or delimbing and/or cutting and/or for a more efficient placement of said tree trunk at its final destination. The holding position may vary depending on the number of tree trunk that are held by said means for holding (105). If holding a first tree trunk the holding position may be a first position, if gripping a second tree trunk, the first position of said first tree trunk may be altered due to the simultaneous holding of said first and second tree trunk in order to achieve a desired balance. The holding position may also be depending on the weather condition, if wind still a first tree trunk may have a first gripping position but in a windy condition said first tree trunk may have s second gripping position. A holding position may be determined by a future operation such as debarking, cutting, delimbing and/or transportation etc.

The holding position may be altered during the handling of the tree trunk. A first holding position may be during delimbing, a second holding position during debarking, a third holding position during cutting and a fourth holding position during transportation.

The holding position may also be chosen in order to minimize the damage to said tree trunk or other tree trunks.

The holding position may also be dependent on surrounding parameters such as surrounding trees, terrain etc.

The holding position may also be dependent on its forthcoming position in a pile of tree trunks. The holding position may also depend on removing a tree trunk from a pile of tree trunks onto a truck.

The holding position may also be real time adaptable by means of a camera. The holding position may take into account the movement of a tree due to weather conditions such as snow, wind etc.

The holding means (105) may be configured to move on ground and/or move up and/or down on a tree trunk. The holding means is attachable to said UAV. The holding means may reach a predetermined tree from ground or from air by a UAV. The holding means may be configured to climb the tree trunk. The holding means may be attachable to a delimbing tool. The delimbing tool may have delimbed the tree independently of the movement of said holding means. The holding means may be attachable to the UAV for transporting said at least a portion of the tree trunk away from its original location.

The holding means may be one or a plurality of holding means. A plurality of holding means may be attachable to each other. A plurality of holding means may achieve a plurality of holding positions on one and the same tree trunk or different tree trunks. The plurality of holding means maybe connected to each other with a wire.

A coarse holding position may be made before reaching a predetermined tree. The coarse holding position may be updated with a more accurate holding position while at or near the predetermined tree by using a camera equipment. The more accurate holding position may be determined by a remote operator using the information from the camera equipment and/or automatically by using a library of prestored pictures of trees together with holding positions using artificial intelligence (AI).

Holding may include any form of gripping, resting, loading and/or carrying at least a portion of a tree trunk. Harvesting may be one or a plurality of sub-elements in a process of extracting at least a portion of a tree from a particular land area or the full process chain of extracting at least a portion of a tree from a particular area. Sub-elements may be delimbing, debarking, cutting, holding, detecting, transporting, reloading, storing, etc. Said sub-elements may take place at different points in time. A tree trunk may be directly held by a means for holding by holding directly at said tree trunk. A tree trunk may be in-directly held by a means for holding by holding a twig and/or a branch of said tree trunk. At least a portion of a tree trunk may indirectly or directly be held by a UAV at least once before, during and/or after harvesting.

A system and/or method for system (10) for remote and/or autonomous cutting, holding, harvesting, transporting etc., may be one or a plurality of systems and/or subsystems working together by sharing information and/or preparing a tree for each other. A first system and a second system may be synchronized with each other. Said systems may perform different steps on different locations, in different manners and/or at different points in time. At least one system may perform at least one step with a land based (stationary or movable) device. Said land-based device may be a land-based vehicle or a robot. A first system may at a first point in time detect at least one tree parameter and/or growing condition for at least one tree. A second system may use at least one of said tree parameter(s) and/or growing condition(s) detected by said first system at a second point in time. Said second point in time may be seconds, hours, days, months or years later. A first system may select at least a tree to cut. A second system may use a selection data about trees to be cut from said first system and perform said cutting with at least one means for cutting. Said cutting may be performed at a later time compared to said selection. A first system may select one or a plurality of trees to be transported at a certain point in time. A second system may perform said transport by at least one means for transporting by using the information from said first system. A first system may select and/or detect a holding position of at least a portion of a tree trunk and/or at least one cutting position of at least one tree trunk. A second system performs said holding and/or cutting at said selected and/or detected cutting position by means of at least one means for holding at least a portion of a tree trunk and/or at least one means for cutting at least a portion of a tree trunk respectively. A first system may generate information at a first point in time to be used in another system at a second point in time.

Systems that work together may have several system owners and/or system manufacturers. One or several systems can contribute to a step. For instance, one system may detect a tree and/or tree parameters and another system may detect growing conditions. A system may have detected tree parameters and/or growing conditions a number of years ago and saved the position in relation to said detected tree parameters and/or growing conditions. This saved information may be used at a later point in time to predict tree parameters. Growing conditions may be the same for several years but may dramatically change if a major part of a forest is cut. Information about growing conditions may be saved in a data base and may be used later by one or a plurality of systems as a base for one or a plurality of harvesting decisions.

tree parameters and/or growing conditions may last or evolve over time. A tree having a tree parameter A year X may be predicted to have a tree parameter B year Y. Future tree parameters may be predicted with a certain probability. Environment, such as terrain and climate may change slowly whereas ecosystem and tree(s) evolve over time. trees may disappear. A system may perform a first moment which is dependent on a second moment having been performed by a second system.

A system may be a system of several system dependent or independent of each other. One or a plurality of sub-systems may go active or inactive while another system is performing a particular event. One system may be a master to the other system members (servants). One system may direct another system. One system may be a reserve system to another system. A detection by a first system may be a confirmation of a previous detection by a second system. A system may be a system of systems. A system may perform sub-elements in a chain of events. A first system may detect growing conditions and/or tree parameters, a second system may detect the tree to be harvested, and a third system may direct the means for cutting to a particular tree. A system may act on lack of information from another system. A system may change the number of sub-system members over time due to various labour intensive process steps. It may be advantageous to use only relevant subsystems for a particular task, i.e., one or a plurality of subsystems may be inactive. This may save battery time and/or process speed.

Holding may include any form of gripping, resting, loading and/or carrying at least a portion of a tree trunk. Harvesting may be one or a plurality of sub-elements in a process of extracting at least a portion of a tree from a particular land area or the full process chain of extracting at least a portion of a tree from a particular area. Sub-elements may be delimbing, debarking, cutting, holding, detecting, transporting, reloading, storing, etc. Said sub-elements may take place at different points in time. A tree trunk may be directly held by a means for holding by holding directly at said tree trunk. A tree trunk may be in-directly held by a means for holding by holding a twig and/or a branch of said tree trunk. At least a portion of a tree trunk may indirectly or directly be held by a UAV at least once before, during and/or after harvesting.

The tree harvesting tool 110 may have a weight of at least 20 kg but less than 50 kg. In various example embodiments said tree harvesting tool 110 may have a weight of at least 30 kg but less than 40 kg.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

In various example embodiments it is provided a system 10 for remote and/or autonomous harvesting at least a portion of a tree, said system 10 comprising:
a first remotely and/or autonomously controlled Unmanned Aerial Vehicle 100, UAV, comprising, at least one means for holding 105 said harvested portion of said tree and being configured for transporting said harvested portion of said tree away from the original location of the tree, and
a second remotely and/or autonomously controlled Unmanned Aerial Vehicle 100, UAV, comprising, at least one means for harvesting at least a portion of a tree,
at least one means for detecting said tree to be harvested, a base station 120 for communication with said first and/or second UAV.
Said means for detecting said tree to be harvested may be arranged on said first UAV, said second UAV and/or a third UAV and/or a remotely and/or autonomously controlled land-based vehicle. Said third UAV and/or said autonomously controlled land-based vehicle may be in direct communication with said base station and/or indirect communication with said base station. Indirect communication may be via said first and/or said second UAV.

In various example embodiments it is provided a system 10 for remote and/or autonomous selecting at least a portion of a tree to be cut, said system 10 comprising: a remotely and/or autonomously controlled Unmanned Aerial Vehicle 100, UAV, comprising, at least one means for cutting said at least a portion of a tree, means for detecting said at least a portion of a tree to be cut, means for detecting at least one tree parameter of at least a portion of a tree and/or at least one growing condition of at least a portion of a tree, a base station 120 for communication with said UAV, and means configured for selecting at least a portion of a tree to be cut depending on at least one detected tree parameter and/or at least one detected growing condition of said cut tree and/or of a remaining portion of a tree and/or of at least one tree grown within a predetermined distance from said cut tree.

Harvesting may mean felling of tree and preparing them for transport away from its original location. It includes both thinning and clearfelling operations. Harvesting may be made depending on current demand for a particular tree parameter. Harvesting may be made depending on current available storage capacity. Harvesting may be made depending on season/temperature for maximizing a particular tree parameter. Harvesting may be made for maximizing the quality/growth potential of the remaining tree in a particular area. Harvesting may also be made for maintaining a forest having a diverse age. Harvesting may also be made for maintaining a forest of a particular species, age and/or composition. Harvesting may be made for maintaining cultural and/or aesthetic values.

For instance, the disclosed system may also transport already harvested trees or portions of trees laying on ground. A plurality of UAV may be used for removing a plurality of tree laying on ground to a final destination. A plurality of UAV working together in synchronism may take one or a plurality of tree or portions of tree at the same time. The selection of tree to be transported may be made depending on the total weight of the tree or portions of tree to be transported. The plurality of UAV may have a maximum load capacity and maximum range capacity. tree or portions of tree may be selected depending on their location, weight, time and the current state of the UAV, i.e., remaining charge and/or fuel.

In various example embodiments of the present invention at least a portion of a tree is removed and left on ground. Said portion can be anything from a branch, a top section to a full tree. Full tree may be removed without being taken care of, a so-called scrap tree. A scrap tree may have a relatively low value in comparison with other surrounding trees and/or for letting the remaining tree in a particular area to obtain the best possible growing conditions.

In various example embodiment it is provided a system 10 for remote and/or autonomous transporting at least a portion of a tree, said system 10 comprising:
a. a remotely and/or autonomously controlled Unmanned Aerial Vehicle 100, UAV, comprising at least one means for holding 105 at least a portion of a tree trunk and being configured for transporting at least a portion of a tree trunk away from the original location of said at least a portion of a tree trunk,
b. means for detecting said at least a portion of a tree to be transported,
c. means for detecting at least one tree parameter of at least a portion of a tree and/or at least one growing condition of at least a portion of a tree,
d. a base station 120 for communication with said UAV, and
e. means configured for directing said remotely and/or autonomously controlled UAV with said at least a portion of a tree trunk to a final destination a certain point in time where said final destination and/or said certain point in time is depending on at least one detected tree parameter and/or at least one detected growing condition of said transported portion of a tree and/or of a remaining portion of a tree and/or of at least one tree grown within a predetermined distance from said transported portion of a tree.

In various example embodiments said system may further comprising a remotely and/or autonomously means 110 configured for harvesting said at least a portion of a tree, wherein said system comprising at least one means for detecting a tree to be harvested.

In various example embodiments said means for detecting said at least one tree parameter and/or at least one growing condition comprising a camera and/or using a database with digital information about tree.

In various example embodiments said UAV and said means configured for harvesting at least a portion of the tree is communicating with each other via one or more of Wifi, Bluetooth, radio communication, optical fibre and/or electrical wire.

In various example embodiments said system further comprising means configured for automatically locating a tree in a predetermined area.

In various example embodiments said means configured for automatically locating a tree in a predetermined area comprising at least a Global Navigation Satellite System, GNSS or a digital transmitter configured to be attached to a tree and to communicate with the UAV.

In various example embodiments said system further comprising a synchronization unit for synchronizing the movement of at least two UAV for transportation of said at least a portion of a tree.

In various example embodiments said system further comprising means for determining the number of UAV to be used together for transporting depending on at least one tree parameter and/or the distance between an original location of said at least a portion of a tree to and said final destination.

In various example embodiments said system further comprising means configured for selecting at least a portion of a tree to be harvested and/or transported depending on at least one detected tree parameter and/or at least one detected growing condition of said harvested and/or transported portion of a tree and/or of a remaining portion of a tree and/or of at least one tree grown within a predetermined distance from said transported and/or harvested portion of a tree.

In various example embodiments it is provided a method for remotely and/or autonomously transporting at least a portion of a tree, said method comprising the steps of:
f. remotely and/or autonomously controlling Unmanned Aerial Vehicle, UAV,
g. identifying said at least a portion of a tree trunk to be transported,
h. remotely and/or autonomously operating at least one means for holding said at least a portion of a tree trunk, where said at least one means for holding said at least a portion of a tree trunk is attached to said UAV,
i. detecting at least one tree parameter of said at least a portion of a tree and/or at least one growing condition of said at least a portion of a tree and/or detecting at least one tree parameter and/or at least one growing condition of at least one tree grown within a predetermined distance from said at least a portion of a tree and/or detecting at least one tree parameter and/or at least a growing condition of a remaining portion of a tree,
j. transporting said at least a portion of a tree trunk, by said UAV, away from the original location of said at least a portion of a tree trunk to a final destination a certain point in time, where said final destination and/or said certain point in time is depending on said at least one detected tree parameter and/or said at least one detected growing condition of said at least a portion of a tree and/or of a remaining portion of a tree and/or of at least one tree grown within a predetermined distance from said at least a portion of a tree.

In various example embodiments said method further comprising the step of remotely and/or autonomously controlling a means configured for harvesting said at least a portion of a tree.

In various example embodiments said method further comprising the step of determining the number of UAV to be used together for transporting said at least a portion of a tree depending on said at least one detected tree parameter and/or said at least one detected growing condition and/or the distance between the original position of said at least a portion of a tree to and said final destination.

In various example embodiments said method further comprising the step of setting up a communication link between said UAV and said means configured for harvesting said at least a portion of a tree via one or more of WiFi, Bluetooth, radio communication, telecommunication, optical fibre and/or electrical wire.

In various example embodiments said method further comprising the step of identifying a first predetermined area within which a tree is to be harvested and/or a tree to be harvested by means of a GNSS-system by means of at least one of a camera and/or at least one optical sensor.

In various example embodiments said method further comprising the step of synchronizing a movement of at least two UAV for transportation of said at least a portion of a tree away from the original location of the tree to the final destination.

In various example embodiments the detection of said at least one tree parameter and/or said at least one growing condition is performed by means of a camera and/or using a database with digital information of tree in a predetermined area.

In various example embodiments said method further comprising the step of selecting said at least a portion of a tree to be harvested and/or transported depending on at least one detected tree parameter and/or at least one detected growing condition of said harvested and/or transported portion of a tree and/or of a remaining portion of a tree and/or of at least one tree grown within a predetermined distance from said transported and/or harvested portion of a tree.

In various example embodiments it is provided a system 10 for remote and/or autonomous holding at least a portion of a harvested tree trunk and/or at least a portion of a tree trunk to be harvested and/or at least a portion of a tree trunk during harvesting and/or at least a portion of a tree trunk before, during and/or after transporting said at least a portion of a tree trunk, said system 10 comprising:
a. at least one remotely and/or autonomously controlled Unmanned Aerial Vehicle 100, UAV,
b. at least one means for holding 105 directly and/or indirectly onto at least a portion of a tree trunk attachable to or integrated with said UAV,
c. at least one means for detecting at least a portion of a tree,
d. at least one means for detecting at least one tree parameter of at least a portion of a tree and/or at least one growing condition of at least a portion of a tree,
e. at least one base station 120 for communication with said UAV,
f. at least one means configured for directing said at least one means for holding onto at least a portion of a tree trunk, where said holding is directly or indirectly onto at least a portion of a tree trunk, to a particular position of at least a portion of a tree trunk depending on said at least one detected tree parameter and/or said at least one detected growing condition of a tree and/or
g. at least one means configured for directing at least a portion of a tree trunk to a particular position, where said particular position is directly or indirectly onto said at least one means for holding, depending on said at least one detected tree parameter and/or said at least one detected growing condition of a tree, wherein said at least one means for holding is configured to be transported by said at least one UAV to said at least a portion of a tree trunk to be held by said at least one means for holding and/or is transported by said at least one UAV away from said at least a portion of a tree trunk held by said means for holding and/or where said at least one means for holding is attached to said at least one UAV at least once when holding during transporting and/or harvesting said tree trunk.

In various example embodiments said means for holding at least one means configured for directing said at least one means for holding and/or at least one means configured for directing at least a portion of a tree trunk is remotely and/or autonomously controlled.

In various example embodiments said system further comprising at least one means for delimbing, at least one means for debarking, at least one means for cutting and/or at least one means for harvesting.

In various example embodiments said at least one remotely and/or autonomously controlled means for holding 105 indirectly and/or directly at least a portion of tree trunk is configured to move directly or indirectly on ground and/or move directly or indirectly up and/or down on a tree trunk and/or configured to move directly or indirectly from one tree to another tree.

In various example embodiments said means for detecting said at least one tree parameter and/or at least one growing condition comprising a camera and/or using a database with digital information about said at least a portion of a tree and/or a tree within a predetermined distance from said at least a portion of a tree.

In various example embodiments said UAV and said means configured for holding directly and/or indirectly at least a portion of a tree trunk is communicating with each other via one or more of Wifi, Bluetooth, radio communication, optical fibre and/or electrical wire.

In various example embodiments said system further comprising means configured for automatically detecting a final destination and/or locating a tree in a predetermined area and/or locating a tree at a final destination.

In various example embodiments said means configured for automatically locating a tree in a predetermined area comprising at least a Global Navigation Satellite System, GNSS or a digital transmitter configured to be attached to a tree and to communicate with the UAV.

In various example embodiments said system further comprising a synchronization unit for synchronizing the movement of at least two UAV for cutting, holding, delimbing, harvesting and/or debarking said at least a portion of a tree trunk.

In various example embodiments said system further comprising means for determining the number of UAV to be used together for transporting, cutting, delimbing, harvesting, debarking and/or holding said at least a portion of a tree trunk depending on at least one tree parameter and/or the distance between an original location of said at least a portion of a tree trunk to a final destination.

In various example embodiments said system further comprising means configured for selecting at least a portion of a tree trunk to be transported, cut, held, delimbed, harvested and/or debarked depending on at least one detected tree parameter and/or at least one detected growing condition of said tree trunk to be transported and/or of another portion of a tree from which said tree trunk originates and/or of at least one tree grown within a predetermined distance from said tree trunk to be transported and/or a tree at said final destination.

In various example embodiments said system further comprising means configured for selecting at least one cutting position on at least a portion of a tree trunk depending on the at least one detected tree parameter and/or the at least one detected growing condition of at least a portion of a tree.

In various example embodiments said system further comprising means configured for directing said at least one remotely and/or autonomously controlled UAV with at least a portion of a tree trunk to a final destination a certain point in time where said final destination and/or said certain point in time is depending on at least one detected tree parameter and/or at least one detected growing condition of said transported portion of a tree and/or of a remaining portion of a tree and/or of at least one tree grown within a predetermined distance from said transported portion of a tree.

In various example embodiments said system further comprising means configured for selecting at least a portion of a tree trunk to be harvested and/or transported depending on at least one detected tree parameter and/or at least one detected growing condition of said harvested and/or transported portion of a tree trunk and/or of a remaining portion of a tree trunk and/or of at least one tree grown within a predetermined distance from said transported and/or harvested portion of a tree trunk.

In various example embodiments it is provided a method for remotely and/or autonomously holding during, before and/or after harvesting at least a portion of a tree trunk or holding at least a portion of a tree trunk during, before and/or after transporting said at least a portion of a tree trunk, said method comprising the steps of:
h. controlling remotely and/or autonomously at least one Unmanned Aerial Vehicle, UAV,
i. identifying said at least a portion of a tree trunk to be held,
j. operating at least one means for directly and/or indirectly holding said at least a portion of a tree trunk, where said at least one means for directly and/or indirectly holding said at least a portion of a tree trunk is integrated with or attachable to said at least one UAV,
k. detecting at least one tree parameter of said at least a portion of a tree trunk and/or at least one growing condition of said at least a portion of a tree trunk and/or detecting at least one tree parameter and/or at least one growing condition of at least one tree grown within a predetermined distance from said at least a portion of a tree trunk and/or detecting at least one tree parameter and/or at least a growing condition of a another portion of a tree from which said tree trunk originates, wherein a direct or indirect holding position of said at least a portion of a tree trunk is depending on at least one tree parameter of said at least a portion of a tree trunk and/or at least one growing condition of said at least a portion of a tree trunk and/or depending on at least one tree parameter and/or at least one growing condition of at least one tree grown within a predetermined distance from said at least a portion of a tree trunk and/or depending on at least one tree parameter and/or at least a growing condition of a another portion of a tree from which said tree trunk originates, wherein said means for holding is attached to said at least one UAV at least once when holding during transporting and/or harvesting said tree trunk.

In various example embodiments said method further comprising the step of determining the number of UAV to be used together for transporting said at least a portion of a tree trunk depending on said at least one detected tree parameter and/or said at least one detected growing condition and/or the distance between the original position of said at least a portion of a tree trunk and a final destination of said at least a portion of a tree trunk.

In various example embodiments said method further comprising the step of setting up a communication link between said UAV and said means for holding said at least a portion of a tree trunk via one or more of WiFi, Bluetooth, radio communication, telecommunication, optical fibre and/or electrical wire.

In various example embodiments said method further comprising the step of identifying a first predetermined area within which a tree trunk is to be held by means of a GNSS-system by means of at least one of a camera and/or at least one optical sensor.

In various example embodiments said method further comprising the step of synchronizing a movement of at least two UAV for transportation of said at least a portion of a tree trunk away from the original location of the tree trunk to a final destination.

In various example embodiments the detection of said at least one tree parameter and/or said at least one growing condition is performed by means of a camera and/or using a database with digital information of the tree in a predetermined area.

In various example embodiments said method further comprising the step of selecting said at least a portion of a tree to be harvested and/or transported depending on at least one detected tree parameter and/or at least one detected growing condition of said harvested and/or transported portion of a tree and/or of a remaining portion of a tree and/or of at least one tree grown within a predetermined distance from said transported and/or harvested portion of a tree and/or at least one tree at a final destination for said harvested and/or transported tree.

In various example embodiments said method further comprising the step of selecting a cutting position of a tree trunk of said at least a portion of a harvested tree trunk, at least a portion of a tree trunk to be harvested, at least a portion of a tree trunk during harvesting or at least a portion of a tree trunk during transporting depending on at least one detected tree parameter and/or at least one detected growing condition of said harvested portion of a tree trunk and/or of a remaining portion of a tree trunk and/or of at least one tree grown within a predetermined distance from said harvested portion of a tree and/or at least one tree at a final destination for said harvested and/or transported tree.

In various example embodiments said method further comprising the step of transporting said at least a portion of a tree trunk, by said at least one UAV, away from the original location of said at least a portion of a tree trunk to a final destination a certain point in time, where said final destination and/or said certain point in time is depending on said at least one detected tree parameter and/or said at least one detected growing condition of said at least a portion of a tree trunk and/or of a remaining portion of a tree trunk and/or of at least one tree grown within a predetermined distance from said at least a portion of a tree trunk and/or at least one tree at a final destination for said harvested and/or transported tree.

In various example embodiments said at least one means for holding and/or said means for detecting at least a portion of a tree and/or at least one means for detecting at least one tree parameter of at least a portion of a tree and/or at least one growing condition of at least a portion of a tree is remotely and/or autonomously controlled.

In various example embodiments it is provided a system 10 for remote and/or autonomous selecting at least a portion of a tree to be harvested and/or transported, said system 10 comprising:
a. a remotely and/or autonomously controlled Unmanned Aerial Vehicle 100, UAV, comprising, at least one means for holding 105 and/or harvesting at least a portion of a tree trunk,
b. means for detecting said at least a portion of a tree to be transported and/or harvested,
c. means for detecting at least one tree parameter of at least a portion of a tree and/or at least one growing condition of at least a portion of a tree,
d. a base station 120 for communication with said UAV, and
e. means configured for selecting at least a portion of a tree trunk to be harvested and/or transported depending on at least one detected tree parameter and/or at least one detected growing condition of said harvested and/or transported portion of a tree trunk and/or of a remaining portion of a tree and/or of at least one tree grown within a predetermined distance from said transported and/or harvested portion of a tree trunk.

In various example embodiments, said system further comprising means configured for determining a certain point in time said at least a portion of a tree trunk should be harvested and/or transported.

In various example embodiments, said means for detecting said at least one tree parameter and/or at least one growing condition comprising a camera and/or using a database with digital information about tree.

In various example embodiments, said UAV and said means configured for harvesting at least a portion of the tree trunk is communicating with each other via one or more of Wifi, Bluetooth, radio communication, optical fibre and/or electrical wire.

In various example embodiments, said system further comprising means configured for automatically locating a tree in a predetermined area.

In various example embodiments, said means configured for automatically locating a tree in a predetermined area comprising at least a Global Navigation Satellite System, GNSS or a digital transmitter configured to be attached to a tree and to communicate with the UAV.

In various example embodiments, said system further comprising a synchronization unit for synchronizing the movement of at least two UAV for transportation and/or harvesting of said at least a portion of a tree.

In various example embodiments, said system further comprising means for determining the number of UAV to be used together for transporting and/or harvesting depending on said at least one tree parameter and/or the distance between an original location of said at least a portion of a tree to and said final destination.

In various example embodiments, said means configured for selecting at least a portion of a tree trunk is further configured to select at least two portions of tree trunks to be transported having a total weight within a predetermined weight range.

In various example embodiments said system further comprising means configured for directing said remotely and/or autonomously controlled UAV with said at least a portion of a tree trunk to a final destination a certain point in time where said final destination and/or said certain point in time is depending on at least one detected tree parameter and/or at least one detected growing condition of said transported portion of a tree trunk and/or of a remaining portion of a tree and/or of at least one tree grown within a predetermined distance from said transported portion of a tree trunk.

In various example embodiments it is provided a method for remotely and/or autonomously selecting at least a portion of a tree to be harvested and/or transported, said method comprising the steps of:
f. remotely and/or autonomously controlling Unmanned Aerial Vehicle, UAV,
g. remotely and/or autonomously operating at least one means for holding at least a portion of a tree trunk and/or harvesting at least a portion of a tree trunk, where said at least one means for holding and/or harvesting said at least a portion of a tree is attached to said UAV,
h. detecting at least a portion of a tree,
i. detecting at least one tree parameter of said at least a portion of a tree and/or at least one growing condition of said at least a portion of a tree and/or detecting at least one tree parameter and/or at least one growing condition of at least one tree grown within a predetermined distance from said at least a portion of a tree,
j. selecting said at least a portion of a tree trunk to be harvested and/or transported depending on at least one detected tree parameter and/or at least one detected growing condition of said harvested and/or transported portion of a tree trunk and/or of a remaining portion of a tree and/or of at least one tree grown within a predetermined distance from said transported and/or harvested portion of a tree trunk.

In various example embodiments said method further comprising the step of determining a certain point in time said at least a portion of a tree trunk should be harvested and/or transported.

In various example embodiments said method further comprising the step of determining the number of UAV to be used together for transporting and/or harvesting said at least a portion of a tree trunk depending on said at least one detected tree parameter and/or said at least one detected growing condition and/or a distance between an original position of said at least a portion of a tree and a final destination.

In various example embodiments said method further comprising the step of setting up a communication link between said UAV and said means configured for harvesting and/or holding said at least a portion of a tree via one or more of WiFi, Bluetooth, radio communication, telecommunication, optical fibre and/or electrical wire.

In various example embodiments said method further comprising the step of identifying a first predetermined area within which a tree is to be harvested and/or a tree to be transported by means of a GNSS-system by means of at least one of a camera and/or at least one optical sensor. In various example embodiments said method further comprising the step of synchronizing a movement of at least two UAV for transportation of said at least a portion of a tree trunk away from the original location of the tree to the final destination.

In various example embodiments the detection of said at least one tree parameter and/or said at least one growing condition is performed by means of a camera and/or using a database with digital information of the tree in a predetermined area.

In various example embodiments said method further comprising the step of transporting said at least a portion of a tree trunk, by said UAV, away from the original location of said at least a portion of a tree trunk to a final destination a certain point in time, where said final destination and/or said certain point in time is depending on said at least one detected tree parameter and/or said at least one detected growing condition of said at least a portion of a tree trunk and/or of a remaining portion of a tree and/or of at least one tree grown within a predetermined distance from said at least a portion of a tree trunk.

In various example embodiments it is provided a system 10 for remote and/or autonomous cutting at least a portion of a harvested tree trunk, at least a portion of a tree trunk to be harvested, at least a portion of a tree trunk during harvesting or at least a portion of a tree trunk before, during or after transporting said at least a portion of a tree trunk, said system 10 comprising:
a. at least one remotely and/or autonomously controlled Unmanned Aerial Vehicle 100, UAV,
b. at least one means for cutting at least a portion of a tree trunk attachable to or integrated with said at least one UAV,
c. at least one means for detecting at least a portion of a tree,
d. at least one means for detecting at least one tree parameter of at least a portion of a tree and/or at least one growing condition of at least a portion of a tree,
e. at least one base station 120 for communication with said at least one UAV, and
f. at least one means configured for selecting at least one cutting position on at least a portion of a tree trunk depending on the at least one detected tree parameter and/or the at least one detected growing condition of at least a portion of a tree, wherein said at least one means for cutting is configured to be transported by said at least one UAV to at least a portion of a tree trunk to be cut by said at least one means for cutting and/or is transported by said at least one UAV away from a cut of at least a portion of a tree trunk by said at least one means for cutting and/or is attached to said at least one UAV at least once during a cut of a at least a portion of a tree trunk by said at least one means for cutting, wherein said cut is at least one of said selected cutting positions.

In various example embodiments said at least one means for cutting is remotely and/or autonomously controlled.

In various example embodiments said at least one means for cutting is transported by said at least one UAV to a predetermined distance to and/or from a tree trunk to be cut and/or away from a cut tree trunk, wherein said cut tree trunk is provided within a predetermined distance from said at least one means for cutting.

In various example embodiments said at least one means for cutting is transported by said UAV into contact with a tree trunk to be cut and/or away from an attached position of a tree trunk.

In various example embodiments said system further comprising at least one means for autonomously and/or remotely controlled debarking and/or delimbing at least a portion of a tree trunk.

In various example embodiments said at least one means for detecting at least a portion of a tree is detecting at least a portion of a tree trunk before, during and/or after transportation and/or before, during and/or after harvesting.

In various example embodiments said system further comprising at least one means for holding 105 directly and/or indirectly onto at least a portion of a tree trunk attachable to or integrated with said at least one UAV.

In various example embodiments said at least one means for holding 105 directly and/or indirectly onto at least a portion of a tree trunk is autonomously and/or remotely controlled.

In various example embodiments said system further comprising at least one means configured for determining a certain point in time said at least a portion of a tree trunk should be harvested, transported, debarked, held, delimbed and/or cut.

In various example embodiments said at least one means for detecting said at least one tree parameter and/or at least one growing condition comprising a camera and/or using a database with digital information about said at least a portion of a tree and/or a tree within a predetermined distance from said at least a portion of a tree.

In various example embodiments said at least one UAV and said at least one means configured for harvesting, delimbing, holding and/or debarking at least a portion of the tree is communicating with each other via one or more of Wifi, Bluetooth, radio communication, optical fibre and/or electrical wire.

In various example embodiments said system further comprising means configured for automatically locating a tree in a predetermined area and/or at a final destination and/or locating a final destination.

In various example embodiments said means configured for automatically locating a tree in a predetermined area and/or a final destination comprising at least a Global Navigation Satellite System, GNSS or a digital transmitter configured to be attached to a tree and to communicate with the UAV.

In various example embodiments said system further comprising a synchronization unit for synchronizing the movement of at least two UAV for transportation and/or harvesting and/or cutting and/or holding and/or debarking and/or delimbing of said at least a portion of a tree.

In various example embodiments said system further comprising means for determining the number of UAV to be used together for transporting and/or harvesting and/or cutting and/or holding and/or debarking and/or delimbing depending on said at least one tree parameter and/or the distance between an original location of said at least a portion of a tree to a final destination.

In various example embodiments said system further comprising means configured for directing said at least one remotely and/or autonomously controlled UAV with at least a portion of a tree trunk to a final destination a certain point in time where said final destination and/or said certain point in time is depending on at least one detected tree parameter and/or at least one detected growing condition of said transported portion of a tree and/or of a remaining portion of a tree and/or of at least one tree grown within a predetermined distance from said transported portion of a tree and/or at least one portion of a tree at a final destination.

In various example embodiments said system further comprising means configured for selecting at least a portion of a tree trunk to be harvested and/or transported depending on at least one detected tree parameter and/or at least one detected growing condition of said harvested and/or transported portion of a tree trunk and/or of a remaining portion of a tree trunk and/or of at least one tree grown within a predetermined distance from said transported and/or harvested portion of a tree trunk.

In various example embodiments said system further comprising at least one means configured for directing at least one means for holding onto at least a portion of a tree trunk, wherein said holding of said tree trunk is directly and/or indirectly, to a particular position of said tree trunk depending on said at least one detected tree parameter and/or said at least one detected growing condition.

In various example embodiments said system further comprising:
a first means for cutting for providing a first cut at a first cutting position,
a second means for cutting for providing a second cut at a second cutting position, wherein a first portion of a tree trunk is configured to be removed from a second portion of a tree trunk by said first and/or second cut and/or in synchronization with said means for holding.

In various example embodiments said first and second cut are provided simultaneously or at different point in time.

In various example embodiments said first and/or second cut are partial cuts.

In various example embodiments said first and said second partial cut are configured to jointly separating a tree trunk at a single position.

In various example embodiments said first partial cut and said second partial cut are configured together with an external force to jointly separating a tree trunk at a single position.

In various example embodiments said means for cutting is configured to move on ground and/or move up and/or down on a tree trunk.

In various example embodiments said means for cutting is configured to move directly from one tree to another tree.

In various example embodiments it is provided a method for remotely and/or autonomously cutting at least a portion of a harvested tree trunk, at least a portion of a tree trunk to be harvested, at least a portion of a tree trunk during harvesting or at least a portion of a tree trunk before, during and/or after transporting, said method comprising the steps of:
g. controlling remotely and/or autonomously at least one Unmanned Aerial Vehicle, UAV,
h. operating remotely and/or autonomously at least one means for cutting at least a portion of a tree trunk,
i. detecting at least a portion of a tree of which said at least a portion of a tree trunk is to be cut,
j. detecting at least one tree parameter of said at least a portion of a tree and/or at least one growing condition of said at least a portion of a tree and/or detecting at least one tree parameter and/or at least one growing condition of at least one tree grown within a predetermined distance from said at least a portion of a tree,
k. selecting a cutting position of said at least a portion of a tree trunk depending on at least one detected tree parameter and/or at least one detected growing condition of said cut portion of a tree trunk and/or of a remaining portion of a tree trunk and/or of at least one tree grown within a predetermined distance from said cut portion of a tree,
l. transporting said means for cutting by said at last one UAV to said tree trunk to be cut by said means for cutting and/or away from said cut tree trunk by said means for cutting and/or attaching said means for cutting to said at least one UAV at least once during a cut of said tree trunk by said means for cutting, wherein said cut is one of said selected cutting positions.

In various example embodiments said means for cutting is remotely and/or autonomously controlled.

In various example embodiments said at least one means for cutting said at least a portion of a tree trunk is attachable to or integrated with said UAV.

In various example embodiments said method further comprising at least one means for holding 105 directly and/or indirectly onto at least a portion of a tree trunk attachable to or integrated with said UAV.

In various example embodiments said at least one means for holding (105) directly and/or indirectly onto at least a portion of a tree trunk is autonomously and/or remotely controlled.

In various example embodiments said method further comprising the step of determining a certain point in time said at least a portion of a tree should be harvested, transported, cut, delimed and/or debarked.

In various example embodiments said method further comprising the step of determining the number of UAV to be used together for transporting and/or harvesting said at least a portion of a tree trunk depending on said at least one detected tree parameter and/or said at least one detected growing condition and/or a distance between an original position of said at least a portion of a tree and a final destination.

In various example embodiments said method further comprising the step of setting up a communication link between said UAV and said means configured for cutting said at least a portion of a tree trunk via one or more of WiFi, Bluetooth, radio communication, telecommunication, optical fibre and/or electrical wire.

In various example embodiments said method further comprising the step of identifying a first predetermined area within which a tree trunk is to be cut by means of a GNSS-system by means of at least one of a camera and/or at least one optical sensor.

In various example embodiments said method further comprising the step of synchronizing a movement of at least two UAV for transportation of said at least a portion of a tree trunk away from the original location of the tree to the final destination.

In various example embodiments the detection of said at least one tree parameter and/or said at least one growing condition is performed by means of a camera and/or using a database with digital information of tree in a predetermined area or a tree at a final destination.

In various example embodiments said method further comprising the step of transporting said at least a portion of a tree trunk, by said at least one UAV, away from the original location of said at least a portion of a tree trunk to a final destination a certain point in time, where said final destination and/or said certain point in time is depending on said at least one detected tree parameter and/or said at least one detected growing condition of said at least a portion of a tree trunk and/or of a remaining portion of a tree trunk and/or of at least one tree grown within a predetermined distance from said at least a portion of a tree trunk and/or at least one tree trunk at a final destination.

In various example embodiments a holding position of said at least a portion of a tree trunk is depending on at least one tree parameter of said at least a portion of a tree trunk and/or at least one growing condition of said at least a portion of a tree trunk and/or detecting at least one tree parameter and/or at least one growing condition of at least one tree grown within a predetermined distance from said at least a portion of a tree trunk and/or detecting at least one tree parameter and/or at least a growing condition of a another portion of a tree from which said tree trunk originates and/or at least one tree trunk at a final destination.

In various example embodiments said method further comprising the step of selecting said at least a portion of a tree to be harvested and/or transported depending on at least one detected tree parameter and/or at least one detected growing condition of said harvested and/or transported portion of a tree and/or of a remaining portion of a tree and/or of at least one tree grown within a predetermined distance from said transported and/or harvested portion of a tree.

In various example embodiments said method further comprising the steps of:
providing a first cut at a first cutting position with a first means for cutting,
providing a second cut at a second cutting position with a second means for cutting,
removing a first portion of a tree trunk from a second portion of a tree trunk at said first and/or second cut.

In various example embodiments said first and second cut are provided simultaneously or at different point in time.

In various example embodiments said first and/or second cut are partial cuts.

In various example embodiments said first and said second partial cut are jointly dividing a tree trunk at a single position.

In various example embodiments said first partial cut and said second partial cut together with an external force jointly dividing a tree trunk at a single position.

In various example embodiments said means for cutting is transported by said at last one UAV to a predetermined distance to and/or from said tree trunk to be cut.

In various example embodiments said means for cutting may be transported by said at least one UAV into contact with said tree trunk to be cut.

In various example embodiments said means for cutting may be transported by said at last one UAV away from an attached position of a tree trunk.

In various example embodiments wherein said means for cutting may be transported by said at last one UAV away from a cut tree trunk, where said cut tree trunks is provided within a predetermined distance from said means for cutting.

In various example embodiments it is provided a system 10 for remote and/or autonomous cutting at least a portion of a tree trunk, said system 10 comprising:
a. at least one remotely and/or autonomously controlled Unmanned Aerial Vehicle 100, UAV,
b. at least one means for cutting at least a portion of a tree trunk attachable to or integrated with said at least one UAV,
c. at least one means for detecting at least a portion of a tree,
d. at least one means for detecting at least one tree parameter of at least a portion of a tree and/or at least one growing condition of at least a portion of a tree,
e. at least one base station 120 for communication with said at least one UAV,
f. at least one means configured for directing said at least one means for cutting at least a portion of a tree trunk through a selected cutting position and/or a certain point in time and/or with a certain speed through said tree trunk depending on the at least one detected tree parameter and/or the at least one detected growing condition of at least a portion of a tree, wherein said at least one means for cutting is configured to be transported by said at least one UAV at least once to at least a portion of a tree trunk to be cut by said at least one means for cutting and/or is configured to be transported by said at least one UAV at least once away from a cut at least a portion of a tree trunk by said at least one means for cutting and/or is configured to be attached to said at least one UAV at least once during a cut of at least a portion of a tree trunk by said at least one means for cutting, wherein said cut is at least one selected cutting position.

In various example embodiments said at least one means for cutting at least a portion of a tree trunk is providing at least one cut on said tree trunk for directly/indirectly separating a first portion of at least o portion of a tree trunk from a second portion of a tree trunk, at least said first portion of a tree trunk is configured to fall in a predetermined direction due to at least said at least one cut.

In various example embodiments said cutting position is selected for minimizing a time for indirectly/directly separating a first portion of a tree trunk from a second portion for one or a plurality of trees and/or for minimizing the time for transporting said at least one means for cutting to and/or from at least a plurality of trees to be cut.

In various example embodiments said tree trunk is configured due to said at least one cut to fall a certain point in time.

In various example embodiments said at least one UAV is configured to force said first portion of said tree trunk to fall in said predetermined direction.

In various example embodiments said means for cutting and/or said means for detecting at least a portion of a tree and/or at least one means for detecting at least one tree parameter of at least a portion of a tree and/or at least one growing condition of at least a portion of a tree and/or at least one means configured for selecting at least one cutting position is remotely and/or autonomously controlled.

In various example embodiments said means for cutting may be transported by said UAV to a predetermined distance from a tree trunk to be cut.

In various example embodiments said means for cutting may be transported by said UAV into contact with a tree trunk to be cut.

In various example embodiments said means for cutting may be transported by said UAV away from an attached position of a tree trunk.

In various example embodiments said means for cutting may be transported by said UAV away from a cut tree trunk, wherein said cut tree trunk is provided within a predetermined distance from said means for cutting.

In various example embodiments said system may further comprise at least one means for autonomously and/or remotely controlled debarking and/or delimbing at least a portion of a tree trunk.

In various example embodiments said means for detecting at least a portion of a tree may detect at least a portion of a tree trunk before, during and/or after transportation and/or before, during and/or after harvesting.

In various example embodiments said system further comprising at least one means for holding (105) directly and/or indirectly onto at least a portion of a tree trunk attachable to or integrated with said UAV.

In various example embodiments said at least one means for holding (105) directly and/or indirectly onto at least a portion of a tree trunk is autonomously and/or remotely controlled.

In various example embodiments said system further comprising means configured for determining a certain point in time said at least a portion of a tree trunk should be harvested, transported, debarked, held, delimbed and/or cut.

In various example embodiments said means for detecting said at least one tree parameter and/or at least one growing condition comprising a camera and/or using a database with digital information about said at least a portion of a tree and/or a tree within a predetermined distance from said at least a portion of a tree.

In various example embodiments said UAV and said means configured for harvesting at least a portion of the tree is communicating with each other via one or more of Wifi, Bluetooth, radio communication, optical fibre and/or electrical wire.

In various example embodiments said system further comprising means configured for automatically locating a tree in a predetermined area and/or at a final destination and/or locating a final destination.

In various example embodiments said means configured for automatically locating a tree in a predetermined area and/or a final destination comprising at least a Global Navigation Satellite System, GNSS or a digital transmitter configured to be attached to a tree and to communicate with the UAV.

In various example embodiments said system further comprising a synchronization unit for synchronizing the movement of at least two UAV for transportation and/or harvesting and/or cutting and/or holding and/or debarking and/or delimbing of said at least a portion of a tree.

In various example embodiments said system further comprising means for determining the number of UAV to be used together for transporting and/or harvesting and/or cutting and/or holding and/or debarking and/or delimbing depending on said at least one tree parameter and/or the distance between an original location of said at least a portion of a tree to and said final destination.

In various example embodiments said system further comprising means configured for directing said at least one remotely and/or autonomously controlled UAV with at least a portion of a tree trunk to a final destination a certain point in time where said final destination and/or said certain point in time is depending on at least one detected tree parameter and/or at least one detected growing condition of said transported portion of a tree and/or of a remaining portion of a tree and/or of at least one tree grown within a predetermined distance from said transported portion of a tree and/or at least one portion of a tree at said final destination.

In various example embodiments said system further comprising means configured for selecting at least a portion of a tree trunk to be harvested and/or transported depending on at least one detected tree parameter and/or at least one detected growing condition of said harvested and/or transported portion of a tree trunk and/or of a remaining portion of a tree trunk and/or of at least one tree grown within a predetermined distance from said transported and/or harvested portion of a tree trunk.

In various example embodiments said system further comprising means configured for directing means for holding onto at least a portion of a tree trunk, wherein said holding of said tree trunk is directly and/or indirectly, to a particular position of said tree trunk depending on said at least one detected tree parameter and/or said at least one detected growing condition.

In various example embodiments said system further comprising:
a first means for cutting for providing a first cut at a first cutting position,
a second means for cutting for providing a second cut at a second cutting position, wherein a first portion of a tree trunk is configured to be removed from a second portion of a tree trunk by said first and/or second cut.

In various example embodiments said first and second cut are provided simultaneously or at different points in time.

In various example embodiments said first and/or second cut are partial cuts.

In various example embodiments said first and said second partial cut are configured to jointly separating a tree trunk at a single position.

In various example embodiments said first partial cut and said second partial cut are configured together with an external force to jointly separating a tree trunk at a single position.

In various example embodiments said means for cutting is configured to move by itself on ground and/or move by itself up and/or down on a tree trunk.

In various example embodiments said means for cutting is configured to move directly from one tree to another tree.

In various example embodiments it is provided a method for remotely and/or autonomously cutting at least a portion of a tree trunk, said method comprising the steps of:
g. controlling remotely and/or autonomously at least one Unmanned Aerial Vehicle, UAV,
h. operating remotely and/or autonomously at least one means for cutting at least a portion of a tree trunk,
i. detecting at least a portion of a tree of which the trunk is to be cut,
j. detecting at least one tree parameter of said at least a portion of a tree and/or at least one growing condition of said at least a portion of a tree and/or detecting at least one tree parameter and/or at least one growing condition of at least one tree grown within a predetermined distance from said at least a portion of a tree,
k. directing said at least one means for cutting at least a portion of a tree trunk through a selected cutting position and/or a certain point in time and/or with a certain speed through said tree trunk depending on at least one detected tree parameter and/or at least one detected growing condition of said cut portion of a tree trunk and/or of a remaining portion of a tree trunk and/or of at least one tree grown within a predetermined distance from said cut portion of a tree, tree to be cut
l. transporting said means for cutting by said at last one UAV to said at least a portion of a tree trunk to be cut and/or away from said cut at least a portion of a tree trunk and/or attaching said means for cutting to said at least one UAV at least once during a cut of said at least a portion of a tree trunk, wherein said cut is one of said selected cutting positions.

In various example embodiments said means for cutting is remotely and/or autonomously controlled.

In various example embodiments said at least one means for cutting said at least a portion of a tree trunk is attachable to or integrated with said UAV.

In various example embodiments said method further comprising at least one means for holding 105 directly and/or indirectly onto at least a portion of a tree trunk attachable to or integrated with said UAV.

In various example embodiments said at least one means for holding 105 directly and/or indirectly onto at least a portion of a tree trunk is autonomously and/or remotely controlled.

In various example embodiments said method further comprising the step of determining a certain point in time when said at least a portion of a tree should be harvested, transported, cut, delimed and/or debarked.

In various example embodiments said method further comprising the step of determining the number of UAV to be used together for transporting and/or harvesting said at least a portion of a tree trunk depending on said at least one detected tree parameter and/or said at least one detected growing condition and/or a distance between an original position of said at least a portion of a tree and a final destination.

In various example embodiments said method further comprising the step of setting up a communication link between said UAV and said means configured for cutting said at least a portion of a tree trunk via one or more of WiFi, Bluetooth, radio communication, telecommunication, optical fibre and/or electrical wire.

In various example embodiments said method further comprising the step of identifying a first predetermined area within which a tree trunk is to be cut by means of a GNSS-system by means of at least one of a camera and/or at least one optical sensor.

In various example embodiments said method further comprising the step of synchronizing a movement of at least two UAV for transportation of said at least a portion of a tree trunk away from the original location of the tree to the final destination.

In various example embodiments the detection of said at least one tree parameter and/or said at least one growing condition is performed by means of a camera and/or using a database with digital information of tree in a predetermined area or a tree at a final destination.

In various example embodiments said method further comprising the step of transporting said at least a portion of a tree trunk, by said at least one UAV, away from the original location of said at least a portion of a tree trunk to a final destination a certain point in time, where said final destination and/or said certain point in time is depending on said at least one detected tree parameter and/or said at least one detected growing condition of said at least a portion of a tree trunk and/or of a remaining portion of a tree trunk and/or of at least one tree grown within a predetermined distance from said at least a portion of a tree trunk and/or at least one tree trunk at a final destination.

In various example embodiments a holding position of said at least a portion of a tree trunk is depending on at least one tree parameter of said at least a portion of a tree trunk and/or at least one growing condition of said at least a portion of a tree trunk and/or detecting at least one tree parameter and/or at least one growing condition of at least one tree grown within a predetermined distance from said at least a portion of a tree trunk and/or detecting at least one tree parameter and/or at least a growing condition of a another portion of a tree from which said tree trunk originates and/or at least one tree trunk at a final destination.

In various example embodiments said method further comprising the step of selecting said at least a portion of a tree to be harvested and/or transported depending on at least one detected tree parameter and/or at least one detected growing condition of said harvested and/or transported portion of a tree and/or of a remaining portion of a tree and/or of at least one tree grown within a predetermined distance from said transported and/or harvested portion of a tree.

In various example embodiments said method further comprising the steps of:
providing a first cut at a first cutting position with a first means for cutting,
providing a second cut at a second cutting position with a second means for cutting,
removing a first portion of a tree trunk from a second portion of a tree trunk at said first and/or second cut.

In various example embodiments said first and second cut are provided simultaneously or at different point in time.

In various example embodiments said first and/or second cut are partial cuts.

In various example embodiments said first and said second partial cut are jointly dividing a tree trunk at a single position.

In various example embodiments said first partial cut and said second partial cut together with an external force jointly dividing a tree trunk at a single position.

In various example embodiments said means for cutting is transported by said at last one UAV to a predetermined distance from said tree trunk to be cut.

In various example embodiments said means for cutting is transported by said at last one UAV into contact with said tree trunk to be cut.

In various example embodiments said means for cutting is transported by said at last one UAV away from an attached position of a tree trunk.

In various example embodiments said means for cutting is transported by said at last one UAV away from a cut tree trunk, where said cut tree trunks is provided within a predetermined distance from said means for cutting.

In various example embodiments said method further comprising the step of providing by said at least one means for cutting at least a portion of a tree trunk at least one cut on said tree trunk for separating a first portion of a tree trunk from a second portion of a tree trunk, at least said first portion of a tree trunk is configured to fall in a predetermined direction due to at least said at least one cut.

In various example embodiments said cutting position is selected for minimizing a time for separating a first portion of a tree trunk from a second portion for one or a plurality of trees and/or for minimizing the time for transporting said at least one means for cutting to and/or from at least a plurality of trees to be cut.

In various example embodiments said first portion of said tree trunk is configured due to said at least one cut to fall a certain point in time.

In various example embodiments said UAV is configured to force said first portion of said tree trunk to fall in said predetermined direction.

In various example embodiments it is provided a system 10 for remote and/or autonomous harvesting at least a portion of a tree, said system 10 comprising:
a. a remotely and/or autonomously controlled means 110 configured for harvesting said at least a portion of a tree,
b. a remotely and/or autonomously controlled Unmanned Aerial Vehicle 100, UAV, comprising, at least one means for holding 105 said harvested portion of said tree and being configured for transporting said harvested portion of said tree away from the original location of the tree, wherein said system comprising at least one means for detecting said tree to be harvested, and
c. a base station 120 for communication with said means configured for harvesting at least a portion of a tree and/or said UAV, wherein said at least a portion of a tree is at least a portion of a tree trunk.

In various example embodiments said means configured for harvesting at least a portion of the tree is configured for moving up and down along a trunk of the tree.

In various example embodiments said means configured for harvesting at least a portion of the tree is also configured for moving on ground.

In various example embodiments said UAV and said means configured for harvesting at least a portion of the tree is communicating with each other via one or more of Wifi, Bluetooth, radio communication, optical fibre and/or electrical wire.

In various example embodiments said means configured for harvesting at least a portion of the tree is connectable to an underside of said UAV.

In various example embodiments said means configured for harvesting at least apportion of the tree is transported on ground to the tree to be harvested.

In various example embodiments said UAV comprises a power unit for powering said UAV and said means configured for harvesting at a portion of said tree.

In various example embodiments the power from said power unit in said UAV is delivered to said means configured for harvesting at least a portion of said tree via at least one power cable.

In various example embodiments said UAV comprising a first power unit for powering said UAV and said means configured for harvesting at least a portion of the tree comprising a second power unit for powering said means configured for harvesting at least a portion of the tree.

In various example embodiments said means configured for harvesting at least a portion of the tree is also configured for delimbing at least a portion of said tree.

In various example embodiments said means configured for harvesting at least a portion of the tree is configured to be in direct communication with a remote operator and/or a remote base station 120 or indirect communication via said UAV with a remote operator and/or a base station 120.

In various example embodiments said system further comprising means configured for automatically locating a tree in a predetermined area to be harvested.

In various example embodiments said means configured for automatically locating a tree in a predetermined area to be harvested comprising at least a Global Navigation Satellite System, GNSS or a digital transmitter configured to be attached to a tree and to communicate with the UAV.

In various example embodiments said system further comprising a synchronization unit for synchronizing the movement of at least two UAV for transportation of at least a portion of a harvested tree.

In various example embodiments it is provided a method for remotely and/or autonomously harvesting a tree, said method comprising the steps of:
a. remotely and/or autonomously controlling a means configured for harvesting at least a portion of a tree,
b. a remotely and/or autonomously controlling Unmanned Aerial Vehicle, UAV,
c. identifying a tree to be harvested,
d. remotely and/or autonomously operating said means configured for harvesting said at least a portion of said tree,
e. remotely and/or autonomously operating at least one means for holding said at least a portion of said tree, where said at least one means for holding said at least a portion of said tree is attached to said UAV,
f. transporting said at least a portion of said tree, by said UAV, away from the original location of the tree, wherein said at least a portion of a tree is at least a portion of a tree trunk.

In various example embodiments said method further comprising the step of:
g. moving said means configured for harvesting said at least a portion of said tree up and/or down along a trunk of said tree.

In various example embodiments said method further comprising the step of:
h. moving said means configured for harvesting said at least a portion of said tree on ground in a direction to and/or from said tree to be harvested.

In various example embodiments said method further comprising the step of:
i. powering said means configured for harvesting said at least a portion of said tree from a power unit arranged in said UAV.

In various example embodiments said method further comprising the step of:
j. powering said means configured for harvesting said at least a portion of said tree from a power unit arranged in said means configured for harvesting said at least a portion of said tree.

In various example embodiments said method further comprising the step of:
k. setting up a communication link between said UAV and said means for harvesting said at least a portion of said tree via one or more of WiFi, Bluetooth, radio communication, tele communication, optical fibre and/or electrical wire.

In various example embodiments said method further comprising the step of:
l. delimbing at least a portion of said tree to be harvested with said means for harvesting said at least a portion of said tree.

In various example embodiments said method further comprising the step of:
m. separating said UAV from said means configured for harvesting said at least a portion of said tree or reconnecting said UAV to said means configured for harvesting at least a portion of said tree.

In various example embodiments said method further comprising the step of:
n. carrying said at least a portion of said tree away from the original location of the tree by said UAV while said means configured for harvesting at least a portion of said tree is attached to said portion of said tree being carried.

In various example embodiments said method further comprising the step of:
o. carrying said at least a portion of said tree away from the original location of the tree by said UAV while said means configured for harvesting at least a portion of said tree is secured to the tree yet to be harvested.

In various example embodiments said method further comprising the step of:
p. setting up a direct remote communication between at least one operator and said means configured for harvesting at least a portion of the tree or an indirect remote communication via said UAV with said at least one operator and said means configured for harvesting at least a portion of the tree.

In various example embodiments said method further comprising the step of:
q. setting up a direct autonomous communication between at least one base station and said means configured for harvesting at least apportion of the tree or an indirect autonomous communication via said UAV with said at least one base station and said means configured for harvesting at least a portion of the tree.

In various example embodiments said method further comprising the steps of:
r. identifying a first predetermined area within which a tree is to be harvested and/or a tree to be harvested by means of a GNSS-system by means of at least one of a camera and/or at least one optical sensor.

In various example embodiments said method further comprising the step of:
s. synchronizing a movement of at least two UAV for transportation of at least a portion of a harvested tree away from the original location of the tree.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1. A device (4200) for an Unmanned Aerial Vehicle, UAV (100), said device (4200) comprising a first pivot point (4212) and a second pivot point (4214) being spaced apart from each other, said first pivot point (4212) is connectable a UAV (100) and said second pivot point (4214) is connectable the UAV (100), said device (4200) is configured to be tilted/rotated around said first pivot point (4212) by adjusting a length of a second cord (4204) and/or tilted/rotated around said second pivot point (4214) by adjusting a length of a first cord (4202), wherein said device (4200) has a first winch motor (4292) and a second winch motor (4294), said first and second winch motors (4292, 4294) are configured for adjusting the length of said first and second cords (4202, 4204) respectively.

2. The device according to claim 1 wherein the first winch motor (4292) is provided at the first pivot point (4212) and the second winch motor (4292) is provided at the second pivot point (4214), and wherein said first pivot point (4212) is connectable a UAV (100) via at least one first cord (4202) and said second pivot point (4214) is connectable the UAV (100) via at least one second cord (4204).

3. The device according to claim 1 wherein the first winch motor (4929) and the second winch motor (4212) are provided at the device (4200), and wherein the first pivot point (4212) is provided at a distance from the first winch motor (4292) and the second pivot point (4214) is provided at a distance from the second winch motor (4294), wherein the first cord (4202) connects the first winch motor (4292) to the UAV (100) via the first pivot point (4212), and wherein the second cord (4204) connects the second winch motor (4294) to the UAV via the second pivot point (4214).

4. The device according to claim 1, further comprising a third pivot point spaced apart from said first and second pivot points, where said third pivot point is spaced apart from a straight line between said first and second pivot points, said third pivot point is connectable to said UAV via at least one third cord, said device is configured to be tilted/rotated around at least said third pivot point by adjusting a length of said first cord and/or said second cord, said device is configured to be tilted/rotated around at least said first pivot point by adjusting a length of said second cord and/or said third cord, said device is configured to be tilted/rotated around at least said second pivot point by adjusting a length of said first cord and/or said third cord, wherein said device has a third winch motor provided at said third pivot point, said third winch motor is configured for adjusting the length of said third cord.

5. The device according to claim 1, further comprising a tilt structure (4210), said tilt structure (4210) has at least one anchor point (4251, 4253) connectable to said UAV (100), said tilt structure (4210) and said device (4200) are connectable to each other via said at least a first and second cords (4252, 4254, 4256), wherein at least one winch motor (4291, 4293, 4295) is provided on said tilt structure (4210) instead of on said device (4200), the tilt structure (4210) is configured to communicate with said UAV (100) and/or said device (4200).

6. The device (4200) according to claim 5, wherein said tilt structure (4210) comprising at least one power source (4280) for powering at least one winch motor (4291, 4293, 4295) provided on said tilt structure (4210).

7. The device (4200) according to claim 1, wherein said device (4200) is a harvesting tool (105, 110) configured for holding and/or cutting at least a portion of a tree or a payload carrying device for carrying timber or goods.

8. The device (4200) according to claim 7, wherein said harvesting tool (105, 110) comprising a base structure (650), said base structure having attached to it at least one cutting means for delimbing a tree (114a, 114b), at least one means for communicating with said UAV and/or a remote base station, at least one cutting means for cutting a tree trunk (116), at least one attaching means to be attachable to at least one UAV (660), at least one holding means for holding a tree trunk (105, 107a, 107b, 114a, 114b).

9. The device (4200) according to claim 8, wherein said cutting means for cutting a tree trunk (116) is foldable/rotatable with respect to said base structure (650) in at least a resting position, a delimbing position and a tree trunk cutting position.

10. The device (4200) according to claim 8, wherein said cutting means for cutting a tree trunk (116) is arranged below said holding means (105, 107a, 107b) on said base structure (650) with respect to a direction of use of said tree harvesting tool (110).

11. The device (4200) according to claim 8, further comprising at least one means for detecting at least a portion of a tree to be harvested.

12. The device (4200) according to claim 8, wherein said at least one cutting means for delimbing a tree (114a, 114b) is at least one knife configured to delimb the tree by the weight and gravitation speed of the tree harvesting tool when dropped from said UAV.

13. An Unmanned Aerial System UAS (42) comprising an Unmanned Aerial Vehicle UAV (100) and a device (4200) according to claim 1 connected to said UAV (100).

14. The UAS (42) according to claim 13, wherein the first, second or third winch motors (4291, 4292, 4293, 4294, 4295) are remotely and/or autonomously operated via said UAV and/or said tilting structure.

15. The UAS (42) according to claim 13, wherein at least one winch motor (4291, 4292, 4293, 4294, 4295) is provided on said UAV (100) instead of on said device (4200) or on said tilting structure (4210).

16. The UAS (42) according to claim 13, wherein said cord (4202, 4204, 4242, 4244, 4252, 4254, 4256) is at least one metal wire, kevlar fibre rope, carbon fibre rope or any combination thereof.

17. The UAS (42) according to claim 13, wherein said UAV (100) is configured for communicating with said at least two winch motors (4291, 4292, 4293, 4294, 4295) via Bluetooth, WiFi, radio communication, optical fibre and/or electrical wire and/or via a cellular mobile network.

18. A tilt structure (4210) for connecting a UAV (100) with a payload, said tilt structure (4210) comprising at least one connection means connectable to said UAV, said tilt structure (4210) and said payload are connectable to each other via at least one first and second cords (4252, 4254, 4256), at least a first and second winch motor (4291, 4293, 4295) are provided on said tilt structure (4210), said at least a first and second winch motor (4291, 4293, 4295) are configured for adjusting the length of said at least a first and second cord (4252, 4254, 4256) respectively, wherein the tilt structure (4210) is configured to communicate with said UAV (100) and/or said device (4200).

19. The tilt structure (4210) according to claim 18, wherein said communication between said tilt structure (4210) and said UAV 100 and/or payload is autonomously and/or remotely controlled.

20. Use of a tilt structure (4210) according to claim 18 for connecting a UAV (100) with a payload and for remotely and/or autonomously controlling a tilt position of said payload.

21. The device according to claim 8, further comprising a plurality of wheels, which wheels are mounted on said base structure spaced apart from each other, said wheels are configured to be positionable into contact with a tree trunk for moving the base structure in motion along the tree trunk, and tension means configured to cause traction of said plurality of wheels against the tree trunk.

22. A method for controlling the relative rotation between a UAV and a device, where the device is attached to said UAV via at least two cords, said method comprising the steps of:
a. determining a reference rotational position of said device relative to said UAV,
b. detecting an angular rotation R in a horizontal plane of said device relative to said reference position,
c. compensating said angular rotation in said horizontal plane of said device by rotating said UAV in said horizontal plane in the same direction and by the same angular rotation R as said device for prohibiting twisting of said cords.

23. The method according to claim 22, wherein said device is a device comprises a first pivot point (4212) and a second pivot point (4214) being spaced apart from each other, said first pivot point (4212) is connectable a UAV (100) and said second pivot point (4214) is connectable the UAV (100), said device (4200) is configured to be tilted/rotated around said first pivot point (4212) by adjusting a length of a second cord (4204) and/or tilted/rotated around said second pivot point (4214) by adjusting a length of a first cord (4202), wherein said device (4200) has a first winch motor (4292) and a second winch motor (4294), said first and second winch motors (4292, 4294) are configured for adjusting the length of said first and second cords (4202, 4204) respectively.

24. The method according to claim 22, wherein said compensation of said angular rotation R of said device by said UAV is performed autonomously.

25. An Unmanned Aerial System (UAS) comprising an Unmanned Aerial Vehicle UAV (100) and a device (4200) where said device is attached to said UAV via at least two cords, said UAS further comprising at least one sensor for detecting angular rotation in a horizontal plane of said device relative to said UAV.

26. The UAS according to claim 25, wherein said device (4200) is a harvesting tool (105, 110) configured for holding and/or cutting at least a portion of a tree or a payload carrying device for carrying timber or goods.

27. The UAS according to claim 25, wherein said harvesting tool (105, 110) comprising a base structure (650), said base structure having attached to it at least one cutting means for delimbing a tree (114a, 114b), at least one means for communicating with said UAV and/or a remote base station, at least one cutting means for cutting a tree trunk (116) and at least one holding means for holding a tree trunk (105, 107a, 107b, 114a, 114b).

28. The UAS according to claim 25, wherein said sensor for detecting angular rotation of said device relative to said UAV is provided on said device and/or said UAV.

29. The UAS according to claim 25, wherein said sensor for detecting angular rotation is at least one of the group of accelerometer, gyro and/or optical sensor.

30. The UAS according to claim 25, wherein said at least two cords are retractable/extendable by at least one winch motor per cord, wherein said winch motors are provided on said UAV and/or said device.

31. A kit comprising a base structure (650), at least one cutting means for delimbing a tree (114a, 114b) configured to be attached to said base structure, electronics configured for communicating with a UAV and/or a remote base station, at least one cutting means for cutting a tree trunk (116) configured to be attached to said base structure, at least one attaching means (660) to be attachable to at least one UAV, at least one holding means for holding a tree trunk (105, 107a, 107b, 114a, 114b) configured to be attached to said base structure.

32. At least one non-transitory machine-readable medium including instructions, for a UAV with a device attached to said UAV via at least two cords, to avoid said cords to twist using real-time relative rotational information of said UAV and said device in a horizontal plane, the instructions, when executed by a machine, cause the machine to perform operations comprising:
a. determining a reference rotational position of said device relative to said UAV,
b. detecting an angular rotation R in a horizontal plane of said device relative to said reference rotational position,
c. compensating said angular rotation R in said horizontal plane of said device by rotating said UAV in said horizontal plane in the same direction and with essentially the same angular rotation R as said device for prohibiting twisting of said cords.

33. An arrangement for a UAV with a device attached to said UAV via at least two cords to avoid said cords to twist using real-time relative rotational information of said UAV and said device in a horizontal plane, the arrangement comprising:
a. at least one processing circuitry; and
b. at least one non-transitory machine readable media including instructions that, when executed by the at least one processing circuitry, cause the at least one processing circuitry to:
i. determine a reference rotational position of said device relative to said UAV,
ii. detect an angular rotation R in a horizontal plane of said device relative to said reference rotational position,
iii. compensate said angular rotation R in said horizontal plane of said device by rotating said UAV in said horizontal plane in the same direction and with essentially the same angular rotation R as said device for prohibiting twisting of said cords.
